(19) United States
(12) Patent Application Publication
(10) Pub. No.: US 2015/0228363 A1
(43) Pub. Date: Aug. 13, 2015

(54) NUCLEAR REACTORS AND RELATED METHODS AND APPARATUS

(71) Applicant: Transatomic Power Corporation, Cambridge, MA (US)

(72) Inventors: Leslie C. Dewan, Cambridge, MA (US); Mark Massie, Cambridge, MA (US); Russell Wilcox, Natick, MA (US); Michael Short, Cambridge, MA (US)

(21) Appl. No.: 14/426,204

(22) PCT Filed: Sep. 5, 2013
(86) PCT No.: PCT/US2013/058209

§ 371 Date: Mar. 5, 2015

Related U.S. Application Data
(60) Provisional application No. 61/697,008, filed on Sep. 5, 2012.
(60) Provisional application No. 61/702,943, filed on Sep. 19, 2012.
(60) Provisional application No. 61/702,938, filed on Sep. 19, 2012.
(60) Provisional application No. 61/703,484, filed on Sep. 20, 2012.
(60) Provisional application No. 61/803,745, filed on Mar. 20, 2013.
(60) Provisional application No. 61/831,835, filed on Jun. 6, 2013.

(51) Int. Cl. G21C 5/02; G21C 3/06

(52) U.S. Cl. CPC G21C 5/02; G21C 3/06

(57) ABSTRACT

Among other things, an apparatus includes a combination of a fissionable material, a molten salt, a moderator material, and ceramic cladding.

### CROSS-REFERENCE TO RELATED APPLICATIONS

This application claims priority to U.S. Provisional Application Ser. No. 61/697,008, filed on Sep. 5, 2012; U.S. Provisional Application Ser. No. 61/703,484, filed on Sep. 20, 2012; U.S. Provisional Application Ser. No. 61/803,745, filed on Mar. 20, 2013; U.S. Provisional Application Ser. No. 61/702,943, filed on Sep. 19, 2012; U.S. Provisional Application Ser. No. 61/702,938, filed on Sep. 19, 2012; and U.S. Provisional Application Ser. No. 61/831,835, filed on Jun. 6, 2013, all of which are incorporated by reference in their entirety.

### BACKGROUND

This description relates to nuclear reactors and related methods and apparatus.

A self-sustaining nuclear reaction in nuclear fuel within a reactor core can be used to generate heat and in turn electrical power. In typical molten salt reactors (sometimes called MSRs), the nuclear fuel is dissolved in a molten salt. In some proposed MSRs, the nuclear fuel would include actinides recovered from spent nuclear fuel (sometimes called SNF or simply spent fuel) of other reactors.

### SUMMARY

Broadly, what we describe here is a nuclear reactor method and apparatus that uses molten salt and fissionable material that is typically at least partly spent fuel from another reactor, and a moderator chosen and structured to cause a critical reaction. All of the references mentioned in this disclosure are incorporated by reference in their entirety.

Reactors may have an integral design, in which the reactor core, heat exchangers, pumps, and other components are contained within the reactor vessel. Here, we describe an integral design for a molten salt fueled reactor.

Molten salt nuclear reactors may incorporate heat exchangers that are used to transfer heat from the primary loop, which contains the molten fuel salt, to an intermediate loop, power-production loop, or other equipment. An effective heat exchanger has a high thermal conductivity—this allows for effective heat transfer from one fluid to the other.

In a molten salt reactor, it is possible from tritium present in fuel salt to migrate across the heat exchanger. This migration is highly undesirable, because it may lead to tritium contamination of the intermediate loop, power-production loop, or other equipment present in the plant. Some existing heat exchanger designs, commonly termed “double-walled” heat exchanger, include an air gap between the two sides of the heat exchanger that can be used to trap tritium, impeding its migration. This air gap, however, is highly insulating and greatly reduces the effectiveness of the heat exchanger.

Here, we describe alternative ways of filling the gap in a double-walled heat exchanger that can both trap tritium and enable high heat exchanger effectiveness.

We describe apparatuses that include: a heat exchanger with a gap between its primary and secondary sides, and a filling material suitable for reducing tritium transport across the heat exchanger.

In some embodiments, the filling material has a high thermal conductivity.

In some embodiments, the walls surrounding the heat exchanger gap or other parts of the heat exchanger are composed of, lined with, or coated with a barrier material that has a low tritium permeability. In some cases, the barrier material is a ceramic particularly a ceramic comprising Al2O3, Cr2O3, SiO2, TiN, and/or TiC. In some cases, the surface of the heat exchanger is aluminized to generate a surface layer of either aluminide or iron-aluminum alloy, or a combination of these two. In some cases, a barrier coating on the walls surrounding the heat exchanger gap or other parts of the heat exchanger is formed via a chemical reaction between the heat exchanger base material and a fluid flowing through the heat exchanger. The base material can form an oxide with a spinel structure (XY2O4), such as FeCr2O4 or MnCr2O4 or an oxide with a non-spinel structure.

In some embodiments, the apparatus includes a permeation window. In some cases, the permeation window comprises a metallic materials, in particular, Pd, Ta, V, Zr, or Nb. In some cases, the permeation window comprises polymeric membranes, ceramic membranes, or electronic membranes.

In some embodiments, systems include a capture system, particularly wherein the capture system comprises as a getter bed or a chemical separation unit.

In some embodiments, the filler material within the gap serves as a getter bed. In some cases, the filler material has a high thermal conductivity. In some cases, the filler material is a metal that can form hydrides and/or have hydrogen dissolve into it. In some cases, the filler material is zirconium, tungsten, palladium, nickel, platinum, titanium, or an alloy or laminate of these materials. In some cases, the apparatus includes a mechanism for applying heat to the getter material to induce it to release absorbed and/or adsorbed hydrogen. In some cases, the filler material is configured to trap other products migrating from the primary side of the heat exchanger, particularly gaseous fission products xenon and krypton.

In some embodiments, the filling material is formed into conductor plates that cross the gap. In some cases, the conductor plates are designed to resist stresses induced by thermal cycling. In some cases, the conductor plates are straight. In some cases, the conductor plates are angled, bent, corrugated, and/or attached to the heat exchanger walls using grooves and/or welding. In some cases, the conductor plates are designed to vary the pressure they induce on the heat exchanger walls as a result of temperature or stress. In some cases, the conductor plates are bimetallic.

In some embodiments, apparatuses include a gas in circulated through the portions of the gap that do not contain solid material. In some cases, apparatuses include a conduit connecting the portions of the gap that do not contain solid material with a detector particularly wherein the detector is a Geiger counter or neutron activation analysis equipment, which could be used to detect elements (such as fuel salt components) that would indicate a leak in the heat exchanger.

In some embodiments, apparatuses include a mechanism operable to introduce hydrogen into the system downstream of the heat exchanger.

In some embodiments, apparatuses include a system operable to monitor integrity of the heat exchanger and its plates by evaluating changes in material properties of the components. In some cases, the conductor plates comprise a metal that becomes brittle and changes its electrical resistance when it absorbs tritium. Some apparatuses include a system operable to monitor plates' resistance is monitored so that the plates may be removed and replaced when their electrical resistance (and corresponding brittleness) rises above a certain value.

In one class of nuclear reactors (sometimes called fluid-fueled reactors), the nuclear fuel is dissolved in a liquid. In some proposed liquid-fueled reactors, the fuel is dissolved in water or a molten salt.

Some integral molten salt fueled reactors include: a reactor vessel at least partially filled with fuel salt and containing inner structures that provides a continuous flow pattern; a moderator; a moderated region in which the fuel salt is in a critical configuration; and at least one heat exchanger.

In some embodiments, the moderator is a metal hydride (e.g., zirconium hydride, etc.). Reactors can include at least one component selected from the group consisting of: control rods; a control rod drive mechanism; a pump; and a reflector.

The flow pattern can be annular, with upflow occurring in the central region of the reactor vessel, and downflow occurring in the outer portion of the annulus. The heat exchangers can be located in an upflow region or in a downflow region. The flow can be driven by natural circulation. The flow can be driven by pumps (e.g., pumps positioned upstream of the heat exchangers, downstream of the heat exchangers, or between multiple sets of heat exchangers).

Some embodiments also include a sealing flange comprising penetrations for electrical connections, cooling for motor windings, bearing, or other components, heating traces, hydraulic connections, and/or pneumatic connections. Some embodiments also include a lower plenum; flow shaping structures; and/or an upper plenum.

Some embodiments also include a comb or grid element to direct the flow of material contained within the fuel salt, gas bubbles, slag, and/or precipitates. In some cases, gaps in the comb and/or grid elements are spaced more narrowly than the distance between the moderator elements.

Some embodiments also include a cover gas region and/or a demister. In some cases, the cover gas region is operable to modify reduction-oxidation potential in the salt, to provide monitoring of reduction-oxidation potential in the salt, to provide a fluid connection to a rupture valve, to provide a salt overflow region, and/or to provide a fluid connection to salt processing, particularly to fission product processing.

Some embodiments also include a catch basin and/or an auxiliary containment system and/or one or more backflow valves in the center region or outer region of the vessel.

In some embodiments, the reactor is operable to load follow. In some cases, the reactor includes a control system operable to implement load following by varying the speed of the circulating pumps.

In some embodiments, multiple integral reactor units are installed together, either in one containment structure or in multiple separate containment structures, and are operated either independently or as a unit.

A liquid-fueled nuclear reactor such as an MSR makes it possible to change the volume of nuclear material contained in the core more readily than would be feasible in a solid-fueled reactor. The amount of heat generated in a nuclear reactor core is, in many cases, proportional to the amount of nuclear material in the core. A liquid-fueled nuclear reactor that includes a core capable of varying in volume is therefore able to vary the amount of heat produced in the reactor core and, subsequently, the amount of electricity produced by the reactor.

Composite cladding materials may be used in conjunction with a moderator in a nuclear reactor. This cladding may consist of a silicon carbide composite, or other ceramic material, that surrounds a moderator in a molten salt nuclear reactor.

Among other things, implementations of what we describe here hold promise for allowing the use of innovative neutron moderator materials in corrosive, high-temperature, high-stress, and high radiation environments.

In general, we describe apparatuses comprising: a neutron moderator, and a cladding material. The moderator and cladding can be part of a molten salt nuclear reactor. The the cladding material can have a gas permeability less than 10̂-6 square meters per second. The cladding can comprise a ceramic material, a metal, a composite material comprising metal and ceramic, silicon carbide (e.g., a silicon carbide composite material, a silicon carbide composite material comprised of beta-phase silicon carbide and silicon carbide fibers, etc.), etc.

In some embodiments, the cladding is filled with gas. The apparatus can a pressure sensor or indicator (e.g., a pressure sensor or indicator is used to signal damage to the moderator or cladding, etc.).

The cladding can be capable of resisting a pressure differential. The cladding can be a composite cladding includes a fiber layer to resist a pressure differential. The cladding can comprises reinforcing fibers (e.g., ceramic reinforcing fibers).

The cladding can comprise a metal. The metal can comprise rolls of thin foil wrapped around the moderator material. The metal material can be sealed using end caps, plugs, melted or crimped foil ends. The metal can comprises a sputtered metal.

The cladding can comprise multiple sections of cladding joined together. For example, the cladding can comprise sections of ceramic cladding produced via chemical vapor deposition joined together using microwave joining.

Methods of assembling an apparatus with a neutron moderator, and a cladding material can include producing the moderator and the cladding separately and subsequently assembling the moderator and the cladding. Each layer of the moderator can be produced as a tube of varying diameters and thicknesses. The tubes can be cut to length and assembled with the moderator in the center and inserted into progressively wider tubes. The tubes can be sealed using end caps, plugs, or lids that may be wider, narrower, or the same inner or outer width as the tube to be sealed. The assembly process can comprise a pre- or post-annealing step, an inter-layer adhesive, a crimp step, and/or a gas-filling or pressurization step.

The cladding or moderator can be colored, marked, bar-coded, or labeled. A permanent bar code can be applied to the cladding or moderator via subtractive means.

The moderator-cladding assembly or subassemblies can comprise narrowed, threaded, grooved, and/or slotted regions meant to guide or arrange the internal layers, and/or aid assembly, physically stabilize the layers, and/or provide stabilization against thermal shock.

The moderator-cladding assembly or subassembly can comprise a sacrificial tube with a plug at one end of the sacrificial tube, and one or more inner layer tubes disposed within the sacrificial tube. There can be mechanical guiding means on the plug. The regions can be angled, notched, serrated or otherwise varied to provide varying levels of mechanical resistance. The plug can include means to facilitate insertion or impede extraction. The plug can be inflatable, elastomeric, or mechanically expandable. The plug can comprise a slot or handle which expands the plug diameter when turned. The expander can be ratcheted so that it cannot later collapse. The tube receiving the plug can be grooved or has a raised portion on its inner or outer surface to receive or reinforce a portion of the cap or plug. The plug can comprise a hook, ring, inner grooved post or other means suitable to allow an overhead crane to raise and lower the moderator assembly, facilitating insertion, removal and inspection. The plug and/or tubes can have mechanical features designed to allow installation into the reactor and/or to bracing or brackets provided within the reactor or as part of the reactor wall. The plug can comprise a valve to facilitate gas-filling or pressurization of the moderator assembly. The plug can comprise a material with a higher coefficient of thermal expansion than the tube.

The plug can be inserted to a specified depth into a tube and the depth of the plug in the tube can be inspected via visual inspection, or via a light, ultrasonic, and/or electromagnetic source. The depth of the plug can be inspected during operation.

An outer tube can extend past the plug and the moderator assemblies can be seated on pegs that position the tubes within the reactor. In some cases, the tube sits loosely on the peg and the plug is seated on or above the peg.

In some embodiments, the assembly comprises a plug that moves in response to the expansion of the moderator, the release of gas by the moderator, or the expansion of a filler liquid, gas or solid material which is not a moderator but which is provided within the moderator assembly and moves responsive to the condition of the reactor or moderator.

In some embodiments, a plug is formed at least in part from materials that yield or melt at temperatures higher than the operating temperature of the reactor, but lower than the upper temperature limit of the reactor or the plug comprises a sacrificial material designed to break or melt above a certain temperature.

In some embodiments, a material is provided between the plug and end of at least one layer of cladding and/or the end of the moderator such that the moderator assembly is calibrated so that an out-of-condition temperature which is high enough will push the plug out of the tube.

In some embodiments, the apparatus comprises a spring-based pop-up indicator system, or a metal or other material with a high coefficient of thermal expansion, responsive to heat or pressure.

In some embodiments, the cladding is sealed using canning methods.

In some embodiments, the cladding is sealed using a double-seaming operation, flanging, curling, counter-sinking and/or die-cutting.

In some embodiments, a rubber or elastomeric material is used to enhance gas impermeability at higher temperatures and pressures.

In some embodiments, a post-sealing sealant is used to enhance gas impermeability at higher temperatures and pressures.

In some embodiments, the materials are packaged such that they are protected from corrosive environments or extremes of temperature or pressure.

In some embodiments, the cladding and/or moderator material is doped with other isotopes that may be used to trace potentially diverted materials.

In some embodiments, the cladding and/or moderator material is doped with burnable poisons such as boron, or other materials.

In some embodiments, the cladding incorporates sacrificial regions that fail when the internal pressure in the cladding rises above a certain value.

In some embodiments, the moderator comprises zirconium hydride, and the cladding material is silicon carbide.

In some embodiments, the molten salt, cladding, moderator and reactor geometry may be selected and arranged so that an accident condition will accelerate the destruction or failure of the cladding and the impairment or decomposition of the moderator. In some cases, the cladding, moderator and/or reactor are designed so that a physical collapse of the reactor would tend to break the cladding. In some cases, the apparatus includes a safety mechanism that causes destruction of the cladding by operator action. In some cases, the reactor comprises ports through which a laser could strike the cladding and accelerate its failure. In some cases, the sacrificial region comprises regions with a lower density of wrapping fibers than is present in the non-sacrificial regions, and/or a weaker type of ceramic fiber than is present in the non-sacrificial regions, and/or being thinner than the non-sacrificial regions. In some cases, the cladding is designed to fail by rupture radially, axially, and/or in a spiral pattern.

In some embodiments, the moderator material is tuned to promote or discourage the release of gasses at high temperatures. In some cases, a zirconium hydride moderator is manufactures with a specific hydrogen-to-zirconium ratio tuned to promote or discourage the release of gasses at high temperatures.

In some embodiments, the moderating material varies within the reactor core and/or within a given moderator pin. In some cases, a zirconium hydride moderator has differing levels of hydration depending in its position within the reactor core or moderating pin.

In some embodiments, the moderating material is movablethroughout the reactor core.

In some embodiments, the cladding and/or moderator is replaceable.

In some embodiments, the apparatus includes sensors measuring the resistivity of the cladding and/or moderator or monitoring the salt for significant traces of cladding and/or moderator materials.

In some embodiments, a section of the cladding is held in place, and moderator can flow through the cladding tube.

In some embodiments, sections of moderator encased in cladding are moveable within the reactor.

In some embodiments, the cladding and/or moderator materials are stored or transported in any receptacle suitable for intermediate-level or high-level nuclear waste following removal from the reactor.

In some embodiments, the used cladding and/or moderator are packaged so as to minimize thermal and/or mechanical stress on the components.

In some embodiments, the materials used in the moderators and cladding are reclaimed by a variety of pyrochemical, aqueous, or electrorefining processes.

In some embodiments, the used moderating material is removed from the cladding, reprocessed, and put back into the previously-used cladding or new cladding.

In some embodiments, suitable tooling (comprising some combination of: radiation-hardened, controllable, and able to manipulate the pins without damaging them) is used to insert and remove the cladding and moderator to and from the reactor.

In some embodiments, the ceramic consists of a ceramic other than silicon carbide, such as titanium carbide, zirconium carbide, ternary titanium silicon carbide, or graphite, applied either singly, as a mixture, or in layers. In some cases, the cladding comprises an inner layer of beta-phase silicon carbide, an inner layer of silicon carbide fibers, and an outer layer of beta-phase silicon carbide. In some cases, the inner layer is applied using the chemical vapor deposition method (CVD), or any other suitable technique (potentially including sintering, sputtering, electrolysis/electroplating, physical and physical-chemical vapor deposition, thermal decomposition or pyrolysis, or formed in situ during the silicon carbide production process). In some cases, the fiber-matrix layer is pre-stressed. In some cases, the fiber-matrix layer is coated with a layer of a material such as pyrolytic carbon to facilitate pre-stressing the system by allowing the fibers to slip against one another during pre-loading. In some cases, an additional layer of silicon carbon is be applied to the layer. In some cases, a layer of silicon carbide is applied to the fiber-matrix layer using chemical vapor infiltration, polymer infiltration and pyrolysis, or a combination of these methods. In some cases, an outer layer is applied using the chemical vapor deposition method (CVD), sintering, sputtering, electrolysis/electroplating, physical and physical-chemical vapor deposition, thermal decomposition or pyrolysis, or formed in situ during the silicon carbide production process).

In some embodiments, an article of manufacture includes a moderating material and a cladding material wherein the cladding material extends the life of the moderator after exposure of the article to molten salt.

In some embodiments, a method of doing business comprising the steps of (1) providing solid moderator assemblies comprising a moderator and cladding prior to first commissioning of a nuclear reactor; and (2) providing additional solid moderator assemblies for replacement.

In some embodiments, a container for shipping the assembly is airtight, watertight or both.

In some embodiments, a method includes marking a moderator assembly to indicate its identity, intended orientation, or other property prior to its use in a nuclear reactor.

In some embodiments, an article of manufacture or racking system includes mechanisms for holding multiple moderator assemblies, wherein said article or system does not remain in the nuclear reactor during normal use. In some cases, the article or system remains in the nuclear reactor during normal use.

In some embodiments, an assembly for a molten salt nuclear reactor comprises a moderator and a safety feature.

In some embodiments, the moderator and cladding are used in conjunction with pebble fuel. In some cases, the fuel kernels are embedded in a zirconium hydride matrix. In some cases, the fuel kernels and zirconium hydride kernels are embedded in another matrix material. In some cases, the relative densities of any of the fuel, moderator, matrix, and cladding are varied. In some cases, the kernels are coated with a cladding material. In some cases, the pebbles are coated with a cladding material.

In some embodiments, the moderator and cladding are used in conjunction with plate fuel. In some cases, the fuel kernels are embedded in a zirconium hydride matrix. In some cases, the fuel kernels and zirconium hydride kernels are embedded in another matrix material. In some cases, the relative densities of any of the fuel, moderator, matrix, and cladding are varied. In some cases, the kernels are coated with a cladding material. In some cases, the plates are coated with a cladding material.

In some embodiments, the moderator and cladding are used in conjunction with prismatic fuel. In some cases, the fuel kernels are embedded in a zirconium hydride matrix in fuel cylinders. In some cases, the fuel kernels and zirconium hydride kernels are embedded in another matrix material in fuel cylinders. In some cases, the relative densities of any of the fuel, moderator, matrix, and cladding are varied in the fuel cylinders. In some cases, the relative densities of any of the fuel, moderator, matrix, and cladding are varied in the prisms. In some cases, the kernels are coated with a cladding material. In some cases, the cylinders are coated with a cladding material. In some cases, the prisms are coated with a cladding material. In some cases, the prism consists of zirconium hydride. In some cases, the prism consists of zirconium hydride kernels in a matrix made of another material.

In some embodiments, a surface treatment was applied to the cladding to promote a particular flow regime in any fluid interacting with the cladding.

In some embodiments, a surface treatment was applied to the moderator to remove potential undesirable surface effects.

In some embodiments, the moderator, cladding, and/or fuel form an involute shape.

In some embodiments, mechanism for varying the relative densities of any of the fuel, moderator, matrix, and cladding uses a multi-stage heating and sintering process.

As a safety mechanism, molten salt nuclear reactors can contain valves that permit rapid draining of the fuel salt into auxiliary containment units. Draining the fuel salt into auxiliary containment puts the fuel salt in a “subcritical” orientation (in which its nuclear reactions are no longer self-sustaining) and thereby significantly slows the heat-producing nuclear reactions in the salt, allowing for safe shutdown of the reactor.

We also describe a molten salt nuclear reactor whose salt-containing loops have multiple freeze valves, which contain a plug of salt cooled so that it is in a solid form. The degree of cooling applied to each freeze valve can be adjusted such that the salt plug melts (thus opening the valve) when the fuel salt in the salt-containing loop reaches a predefined temperature. When the valve opens, fuel salt can flow from the primary loop into an auxiliary containment unit whose volume is a fraction of the volume of the salt containing loop. The salt-containing loop can then be refilled with additional salt at a lower temperature from a holding tank, thereby lowering the overall temperature of the fuel salt in the primary loop. Alternatively, the fuel salt drained into the auxiliary containment can be allowed to cool, then be reintroduced into the primary loop.

In general, an apparatus includes a liquid-fueled nuclear reactor with a variable active core volume. A load following nuclear reactor can be implemented using a liquid-fueled nuclear reactor with a variable active core volume. Such variable active volume reactors can be used to implement medium-term and/or long-term reactivity control and enable mass-producing reactors that can have their power levels adjusted at the plant site. Embodiments can include one or more of the following features.

The nuclear reactor is a molten salt reactor. The nuclear reactor is a molten salt cooled reactor. The nuclear reactor is a liquid-metal cooled reactor.

The apparatus can include a molten salt and dissolved fissile material. The apparatus can include heavy and/or light water with dissolved fissile material.

In some embodiments, the reactor core comprises an active and passive region. In some cases, the active and passive regions are separated from one another using a movable separator plate. In some cases, the range of motion of the separator plate is limited by the length of an extender pipe. The passive region can contain a filling material. The filling material can be transported via pump and/or gravity feed from an auxiliary tank. Moving material from the auxiliary tank to the passive region while simultaneously moving material from the primary loop into the holding tank can increase the volume of the passive region and decreases the volume of the active region, or vice-versa. In some cases, the separator plate is moved by adjusting the relative pressure on either side of the separator plate.

In some embodiments, the separator plate is held stationary using the following, either singly or in any combination: pumps used to induce pressure on the separator plate, and/or static pressure used to induce pressure on the separator plate, and/or gravitational forces of the liquid fuel or filler material used to induce pressure on the separator plate, and/or systems of mechanical, electric, or magnetic bearings or clamps to hold the separator plate in place.

In some embodiments, the apparatus also includes additional safety mechanisms, either singly or in any combination: inclusion of a valve to transfer additional clean salt from an auxiliary reservoir, and/or removal of excess heat through heat exchangers, and/or use of freeze valves and/or staged freeze valves to drain fuel salt from the primary loop. The freeze valves are connected to the primary loop of a nuclear reactor. The freeze valves are connected to an intermediate loop of a nuclear reactor. One or more of the freeze valves is cooled in such a manner that it melts at a pre-defined temperature.

The freeze valves are cooled in such a manner that a first freeze valve melts at a first temperature and a second freeze valve melts at a second temperature that is different than the first temperature. The multiple freeze valves have different cross-sectional areas. A freeze valve designed to melt at a higher pre-defined temperature has a larger cross-sectional area than a freeze valve designed to melt at a lower pre-defined temperature.

One or more auxiliary tanks connected to one or more of the freeze valves are sized such that the volume of the one or more auxiliary tanks is large enough to contain the entire volume of liquid in the reactor loop connected to the one or more freeze valves. One or more auxiliary tanks connected to one or more of the freeze valves are sized such that the volume of the one or more auxiliary tanks is not large enough to contain the entire volume of liquid in the reactor loop connected to the one or more freeze valves.

An auxiliary tank is connected to a reactor loop to refill the reactor loop after the reactor loop has had liquid material drained from it via a freeze valve. The auxiliary tank is filled with a non-radioactive salt, and the reactor loop is filled with a radioactive salt. The auxiliary tank is filled with a liquid at a lower temperature than the temperature in the reactor loop. The auxiliary tank introduces salt into the loop using a pump. The auxiliary tank introduces salt into the loop using gravity feeding.

In general, in an aspect, an apparatus includes a fissionable material, a molten salt, and a moderator material including one or more hydrides, one or more deuterides, or a combination of them.

Implementations may include one or more of the following features. The moderator material includes a metal hydride. The moderator material includes a form of zirconium hydride. The moderator material includes ZrH_{1.6}. The moderator material includes a form of lithium hydride. The moderator material includes a form of yttrium hydride, for example, yttrium(II) hydride (YH₂), or yttrium(III) hydride (YH₃), or a combination of them. The moderator material includes a form of zirconium deuteride.

The fissionable material includes at least portions of spent nuclear fuel of a reactor. The fissionable material includes an entire spent nuclear fuel actinide vector. The fissionable material comprises unprocessed spent nuclear fuel. The fissionable material includes materials other than spent nuclear fuel. The fissionable material includes plutonium or uranium from decommissioned weapons. The fissionable material includes naturally occurring uranium. The fissionable material includes fresh fuel. The fissionable material includes depleted uranium. The fissionable material includes natural uranium, enriched uranium, depleted uranium, plutonium from spent nuclear fuel, plutonium down-blended from excess nuclear weapons materials, thorium and a fissile material, transuranic material, or a combination of any two or more of them. The fissionable material includes a fissile-to-fertile ratio in the range of 0.01-0.25. The fissionable material includes at least one of U-233, U-235, Pu-239, or Pu-241. The fissionable material also includes U-238. The fissionable material also includes thorium.

The molten salt includes a fluoride salt. The molten salt includes a chloride salt. The molten salt includes an iodide salt. The molten salt includes lithium fluoride. The lithium fluoride is enriched in its concentration of Li-7 (which has a lower thermal neutron capture cross section than Li-6). The solubility of actinides in the molten salt is sufficient to permit the fissionable material to become critical. The solubility of actinides in the molten salt is at least 0.3%. The solubility of actinides in the molten salt is at least 12%. The solubility of actinides in the molten salt is at least 20%. The molten salt includes essentially no beryllium. The molten salt includes an amount of beryllium. The fissionable material is combined with the molten salt. The fissionable material and the molten salt are distinct from the moderator. The salt provides moderation.

In general, in an aspect, an apparatus includes a fissionable material including spent nuclear fuel of a reactor combined with a molten lithium fluoride salt that is essentially free of beryllium, and a zirconium hydride moderator that is distinct from the combined fissionable material and salt.

In general, in an aspect, a nuclear reaction moderator structure includes a hydride or deuteride and one or more passages for molten salt fuel to flow through or around the structure or both, the structure being configured so that the molten salt fuel is in a critical state while in the structure.

Implementations may include one or more of the following features. The moderator material includes a metal hydride. The moderator material includes a form of zirconium hydride. The moderator material includes ZrH_{1.6}. The moderator material includes a form of lithium hydride. The moderator material includes a form of yttrium hydride, for example, yttrium(II) hydride (YH₂), or yttrium(III) hydride (YH₃), or a combination of them. The moderator material comprises a form of zirconium deuteride.

There are at least two such passages. The plates are separated by the passages. There are at least two such passages in parallel. One or more of the passages are tubular. The structure includes three-dimensional discrete structural elements each of which has an extent in each of the three dimensions that is smaller than the extent of the structure. The discrete structural elements are arranged in the structure with the passage or passages between the discrete structures or within the discrete structures or both. The structure includes balls, or spheres, or pebbles, or a combination of any two or more of them, arranged in three dimensions. The structure includes an integral block of moderator material in which the passages are formed. The structure includes a set of discrete elements. The discrete elements are identical.

The structure has an entry end and an exit end, and the passage or passages extend from the entry end to the exit end. The structure includes rods. The rods include at least one of cylinders, annular rods, finned rods, helical rods, twisted helical rods, annular helical rods, annular twisted helical rod, rods with wire wrapped spacers, or annular rods with wire wrapped spacers, or a combination of two or more of them. The structure includes reactivity control elements that are movable relative to the structure.

In general, in an aspect, in a nuclear reactor, fissionable material and a molten salt flow past a moderator material that includes one or more hydrides, deuterides, or a combination of two or more of them.

Implementations may include one or more of the following features. The flowing of the fissionable material and the molten salt past the moderator material includes flowing the fissionable material and the molten salt as a mixture. The mixture flows through a fission product removal system. The fuel-salt mixture flows through a heat exchanger. The fissionable material includes an entire spent nuclear fuel actinide vector. The fissionable material comprises portions but not all of the actinides of spent nuclear fuel. The fissionable material comprises unprocessed spent nuclear fuel.

In general, in an aspect, a nuclear reactor moderator structure is formed of a moderator material that includes one or more hydrides, deuterides, or a combination of them, and one or more passages for fissionable fuel to flow through the structure.

In general, in an aspect, a nuclear reactor includes a primary loop having a reactor core. The reactor core includes a moderator structure having a moderator material that includes one or more hydrides, deuterides, or a combination of them, and a pathway along which a fissionable material and molten salt can flow from an exit end of the moderator structure in a loop to an entrance end of the moderator structure.

Implementations may include one or more of the following features. The reactor includes a secondary loop and a heat exchanger to exchange heat between the primary loop and the secondary loop. The reactor includes an intermediate loop, a secondary loop, a heat exchanger to exchange heat between the primary loop and the intermediate loop, and an additional heat exchanger to exchange heat between the intermediate loop and the secondary loop. The reactor includes a freeze valve.

In general, in an aspect, a nuclear reactor is constructed by connecting a moderator structure, including a moderator material that includes one or more hydrides, deuterides, or a combination of them, to a pathway along which a fissionable material and molten salt can flow from an exit end of the moderator structure to an entrance end of the moderator structure, to form a primary loop.

In general, in an aspect, a nuclear reactor fuel includes spent fuel of a light water reactor in a molten salt in which solubility of actinides of the spent fuel, in the molten salt, is sufficient to permit the fissionable material to become critical.

Implementations may include one or more of the following features. The spent fuel includes an entire spent nuclear fuel actinide vector. The spent fuel comprises unprocessed spent nuclear fuel. The molten salt includes essentially no beryllium.

In general, in an aspect, a nuclear reaction fuel is formed by mixing spent fuel of a light water reactor with a molten salt; the solubility of actinides of the spent fuel, in the molten salt, is sufficient to permit the fissionable material to become critical. In some implementations, the spent fuel includes an entire spent nuclear fuel actinide vector; and the spent fuel comprises unprocessed spent nuclear fuel. The fissionable material comprises portions but not all of the actinides of spent nuclear fuel.

In general, in an aspect, a light water reactor is operated, spent nuclear fuel is recovered from the light water reactor, the recovered spent nuclear fuel is combined with molten salt, and a molten salt reactor is operated using the recovered spent nuclear fuel with molten salt.

Implementations may include one or more of the following features. The spent nuclear fuel comprises an entire spent nuclear fuel actinide vector. The spent nuclear fuel comprises unprocessed spent nuclear fuel. The fissionable material comprises portions but not all of the actinides of spent nuclear fuel.

In general, in an aspect, supplies of existing spent nuclear fuel are reduced by operating a molten salt nuclear reactor using, as fuel, spent nuclear fuel, without processing, from another reactor.

In general, in an aspect, electricity is generated using existing spent nuclear fuel by operating a molten salt nuclear reactor using, as fuel, spent nuclear fuel, without processing, from another reactor.

In general, in an aspect, supplies of nuclear weapons material are reduced by operating a molten salt nuclear reactor using, as fuel, spent nuclear fuel, without processing, from another reactor.

In general, in an aspect, supplies of existing spent nuclear fuel are reduced by operating a molten salt nuclear reactor using, as fuel, spent nuclear fuel, without processing, from another reactor.

Implementations may include one or more of the following features. The fluid includes a molten salt mixture.

In general, in an aspect, a combination of a reactor that includes nuclear fuel and a molten salt coolant that is distinct from the fuel, and moderator elements including one or more hydrides or deuterides.

Implementations may include one or more of the following features. At least one of the hydrides comprises a metal hydride. The moderator elements comprise graphite in combination with the one or more hydrides.

In general, in an aspect, a combination of a reactor that includes a nuclear fuel in a subcritical state and an accelerator driven source of neutrons in proximity to the nuclear fuel, and moderator elements comprising one or more hydrides or deuterides.

Implementations may include one or more of the following features. The accelerator driven source comprises a heavy metal target. The moderator elements are in proximity to the heavy metal target. The moderator elements are in proximity to the nuclear fuel. The fuel comprises thorium. The fuel comprises spent nuclear fuel. The fuel comprises transuranic materials from spent nuclear fuel. The fuel comprises minor actinides from spent nuclear fuel.

These and other aspects, features, and implementations, can be expressed as apparatus, methods, compositions, methods of doing business, means or steps for performing functions, and in other ways.

Other aspects, features, implementations, and advantages will become apparent from the following description, and from the claims.

### DESCRIPTION

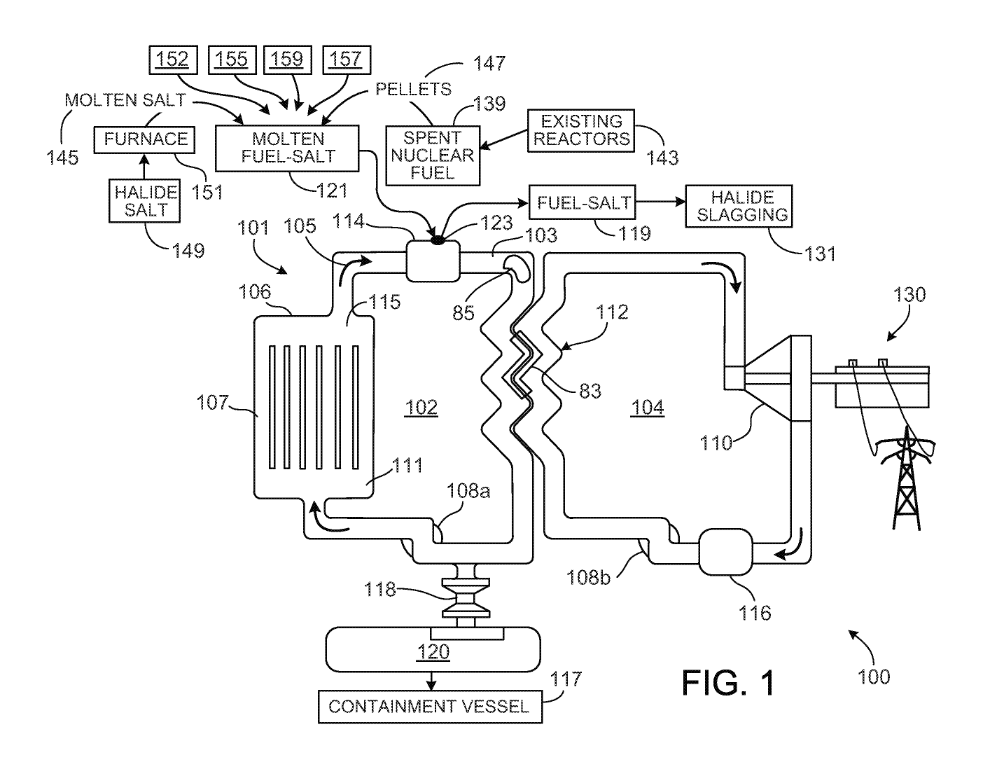

FIG. 1 is schematic diagram.

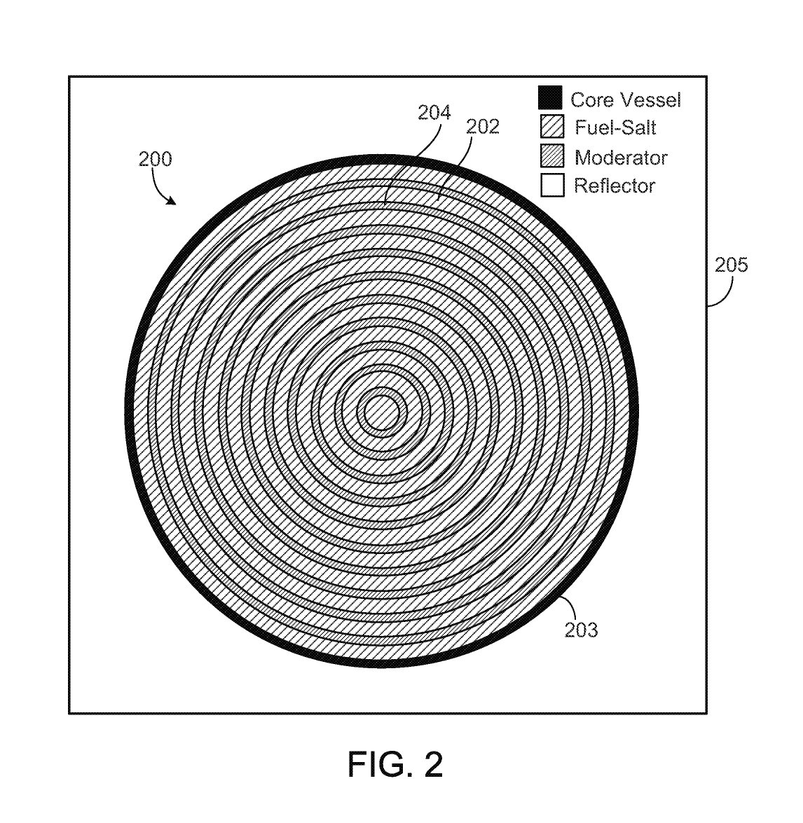

FIGS. 2, 5, 6, 7, 8, and 9 are sectional views of reactor cores.

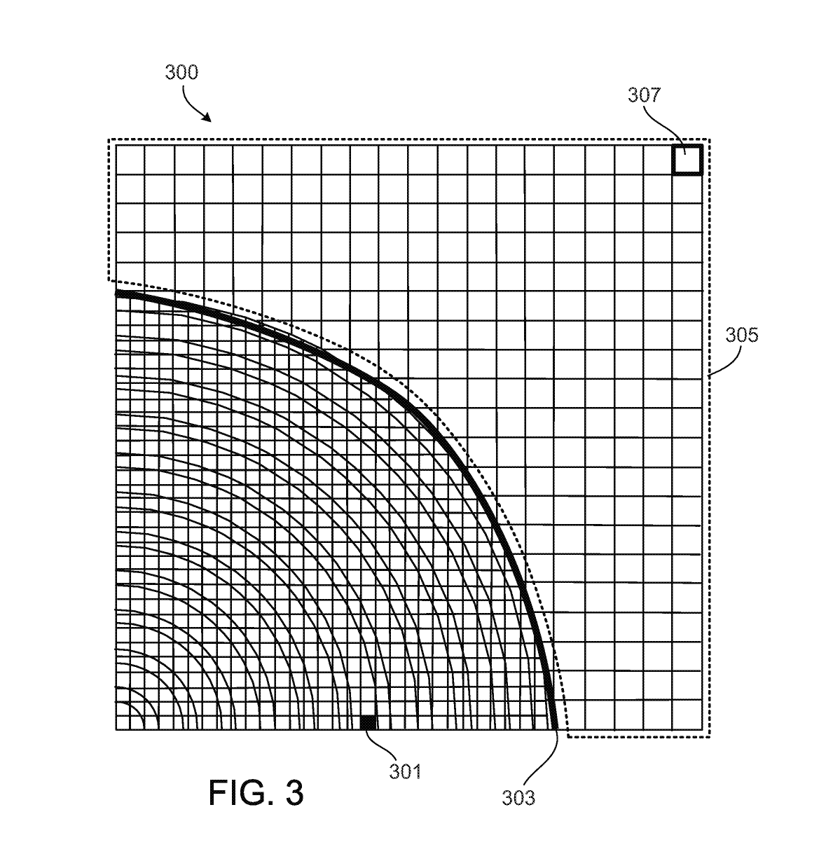

FIG. 3 is a schematic diagram associate with a simulation.

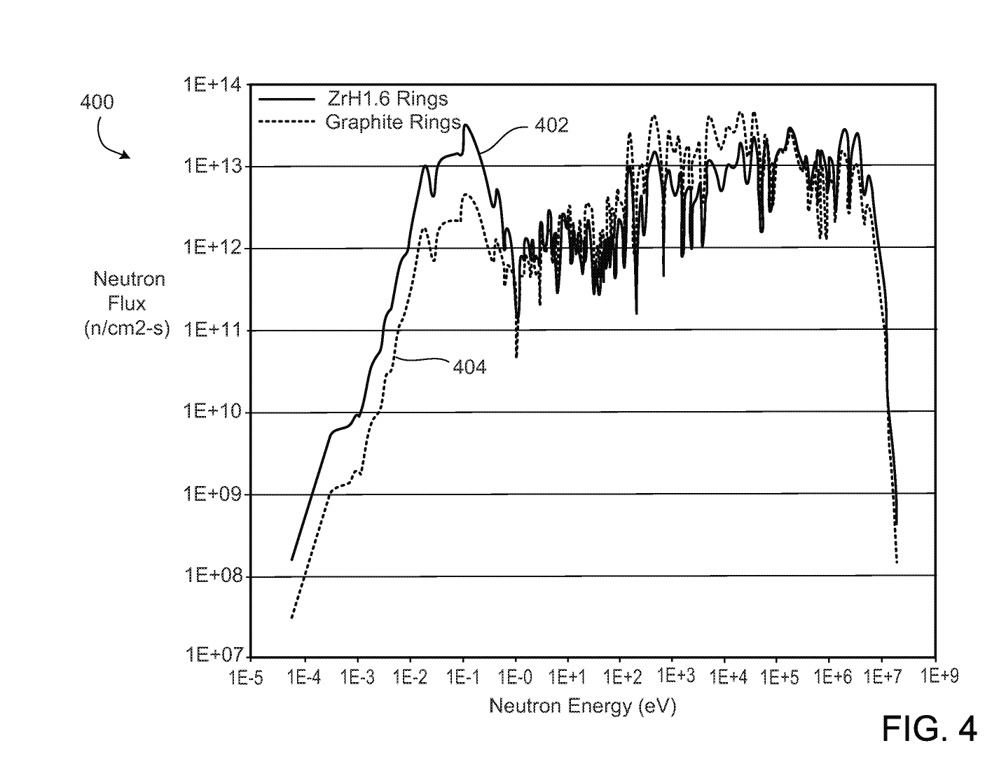

FIG. 4 is a graph of neutron flux.

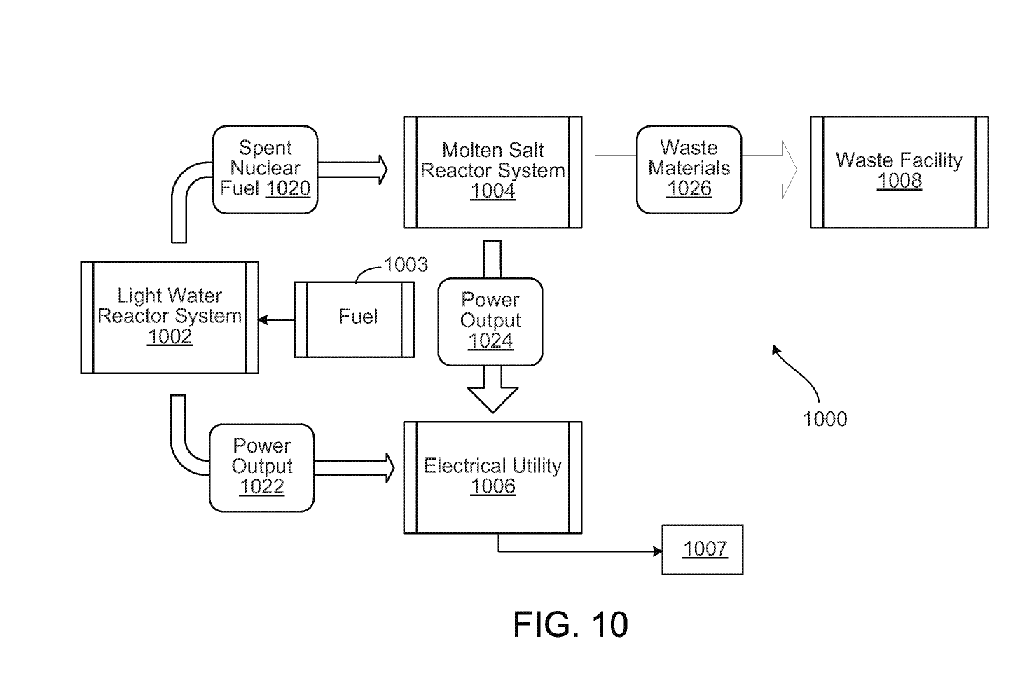

FIG. 10 is a flow chart.

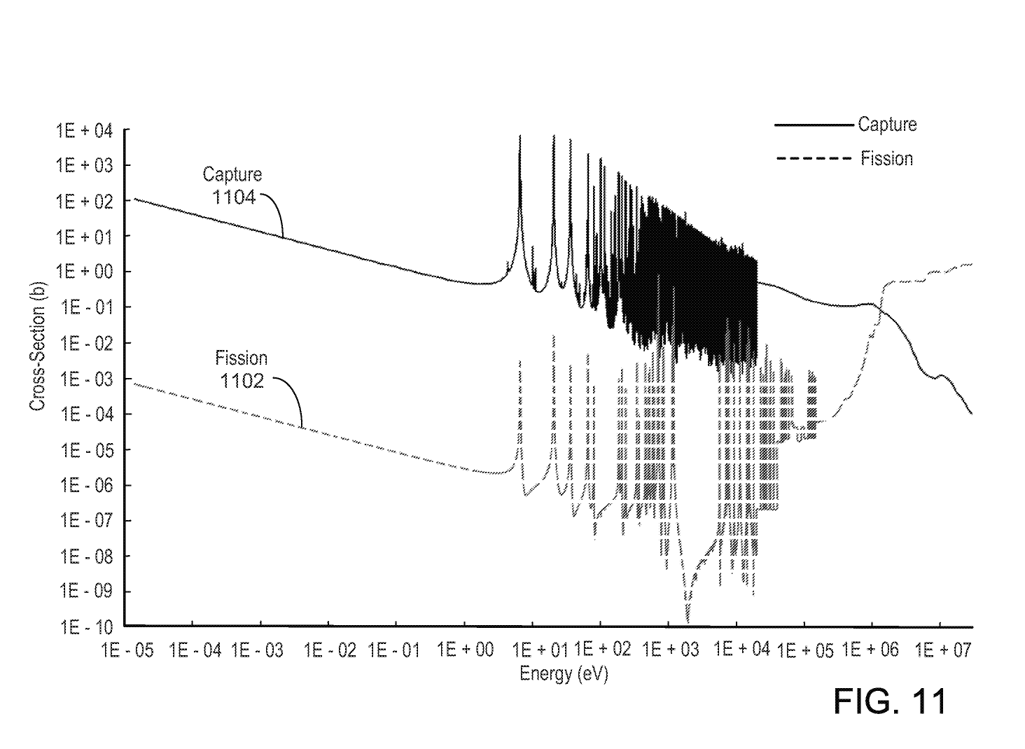

FIG. 11 is a graph of cross sections.

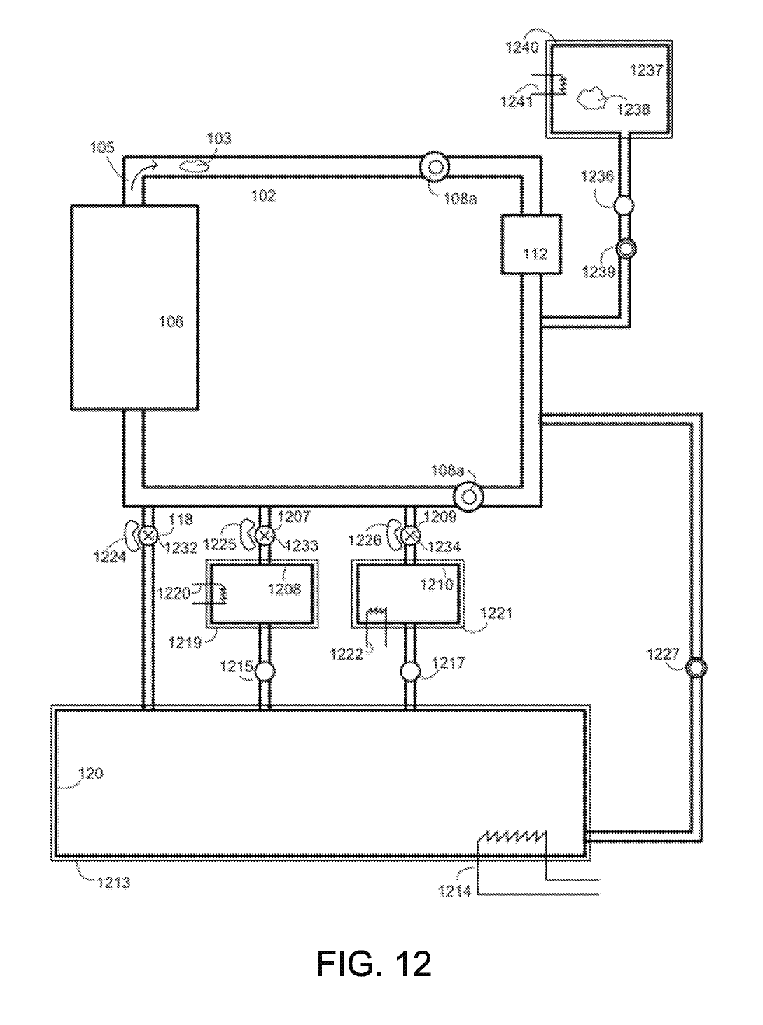

FIG. 12 is a schematic diagram of an example nuclear reactor primary loop that includes a nuclear reactor core, a heat exchanger, and multiple stages of temperature-regulated freeze vales.

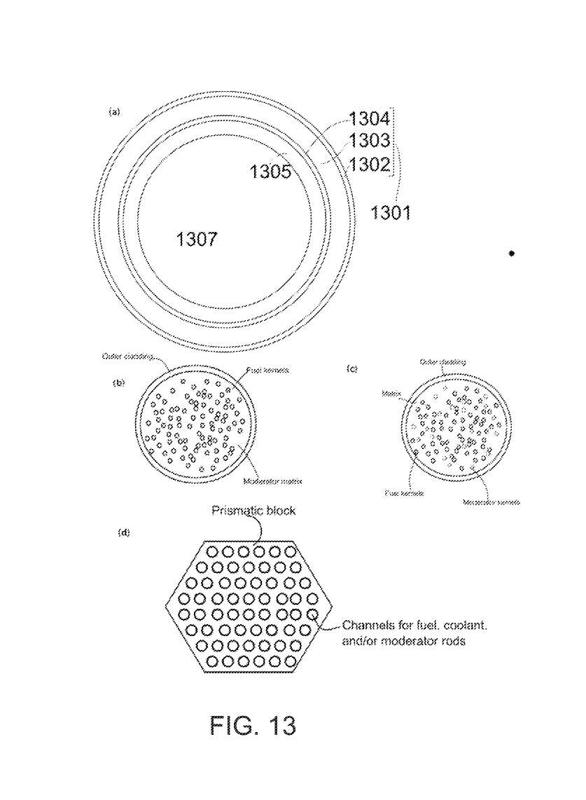

FIG. 13 is a cross-sectional schematic showing the cladding and moderator.

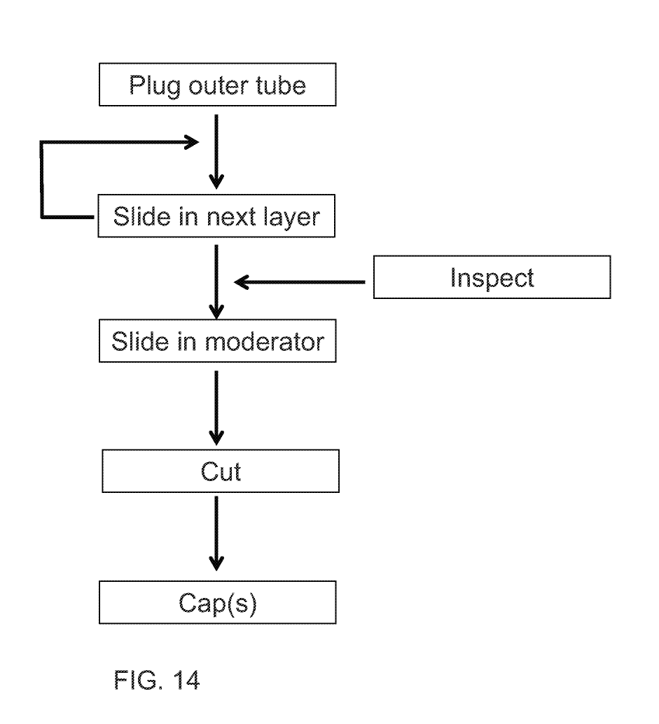

FIG. 14 is a flow chart.

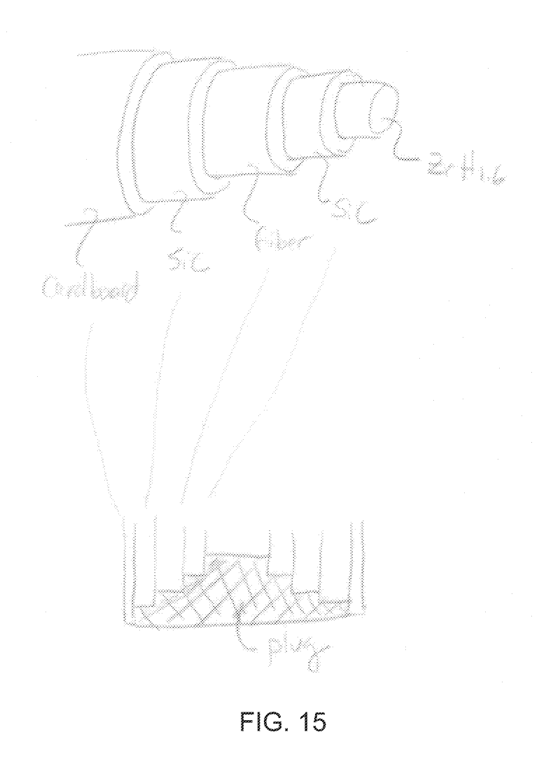

FIG. 15 is a schematic showing the moderator-cladding assembly.

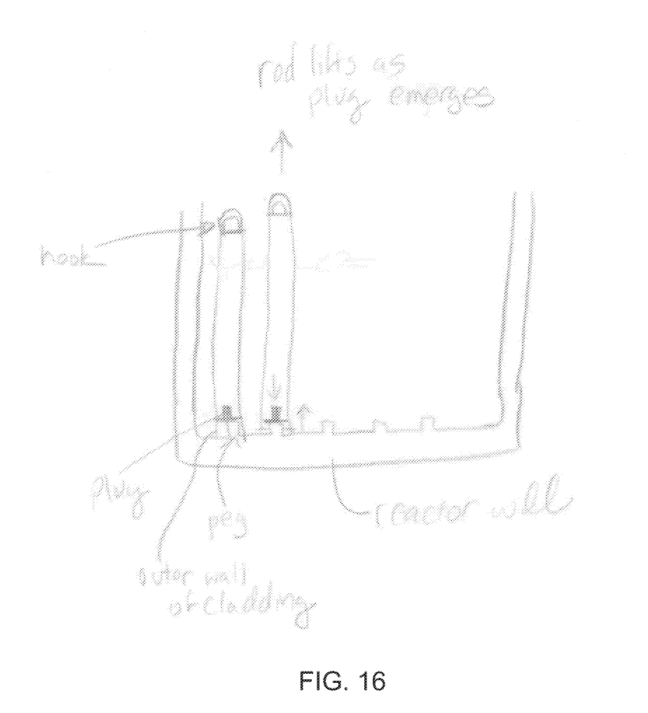

FIG. 16 is a cross-sectional schematic showing the moderator, cladding, and reactor.

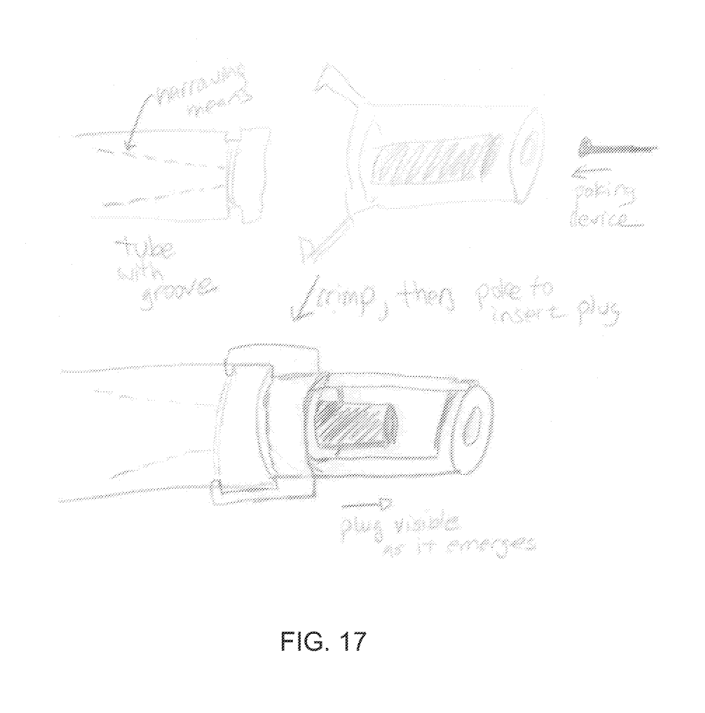

FIG. 17 is a schematic showing the moderator-cladding assembly.

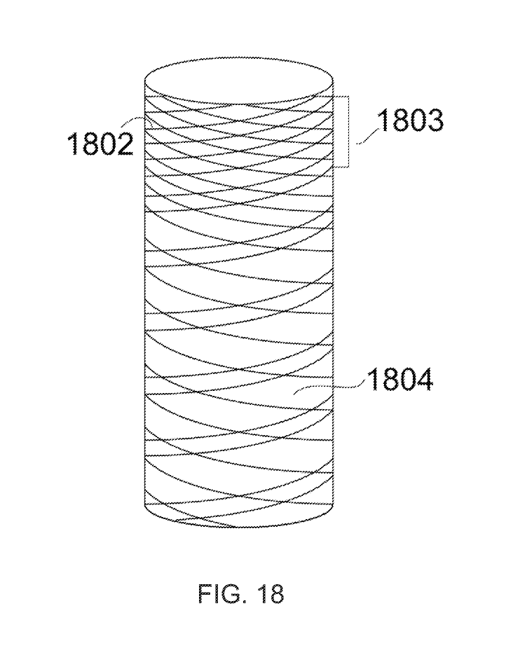

FIG. 18 is a schematic showing a fiber wrapping pattern in the cladding.

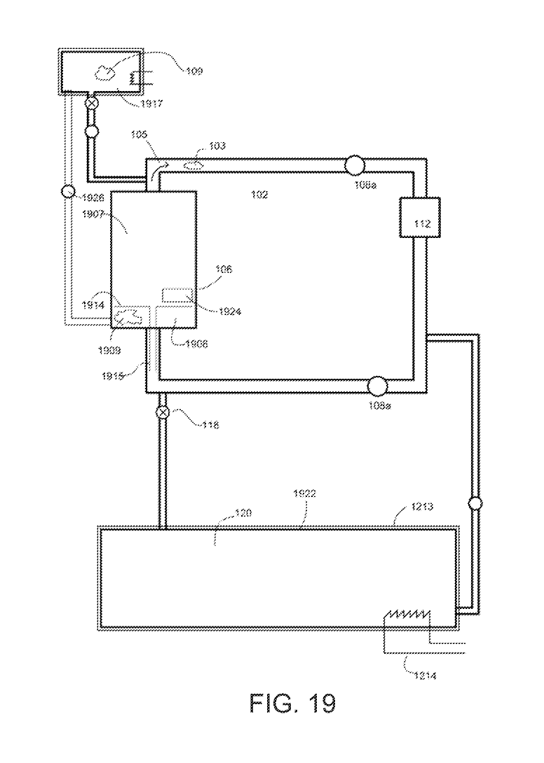

FIG. 19 is a schematic diagram of a nuclear reactor with variable core volume.

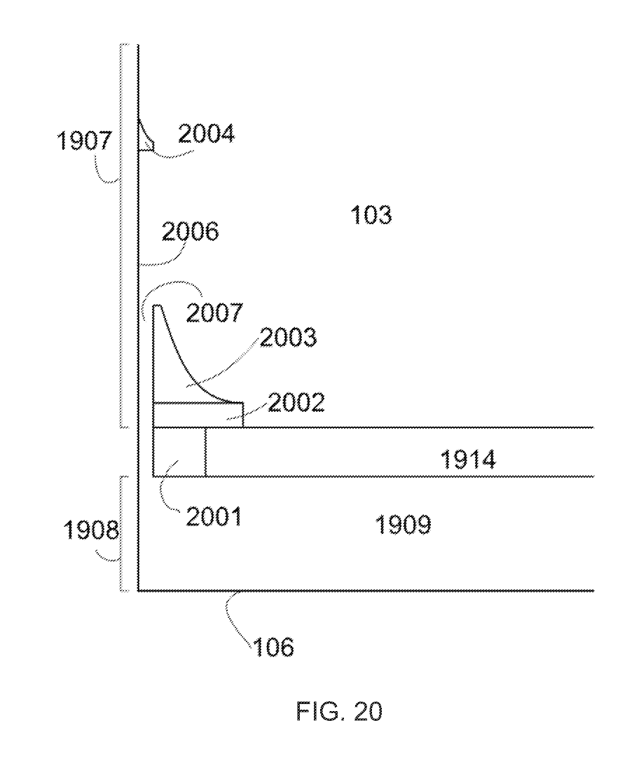

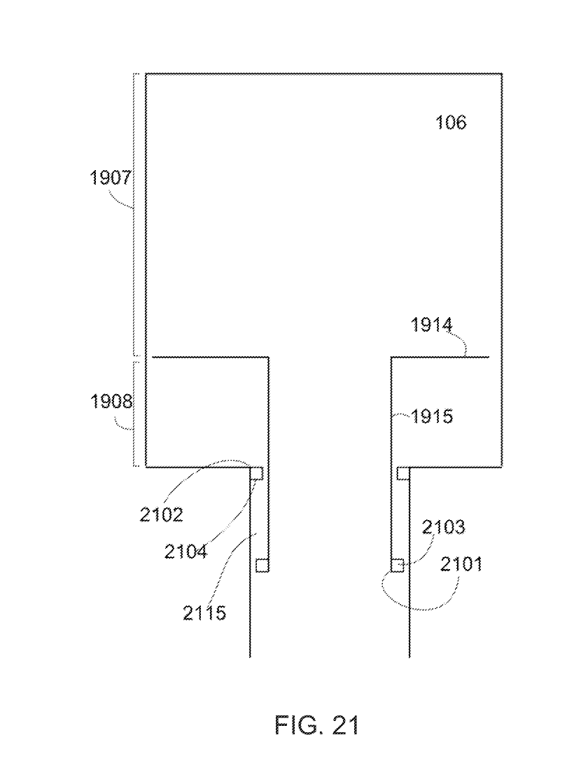

FIGS. 20 and 21 are sectional views of the reactor core.

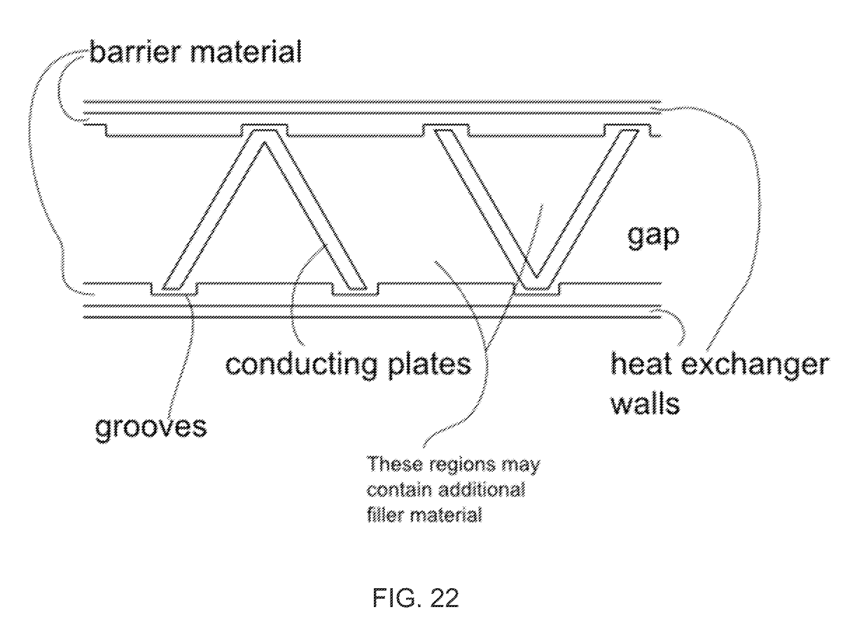

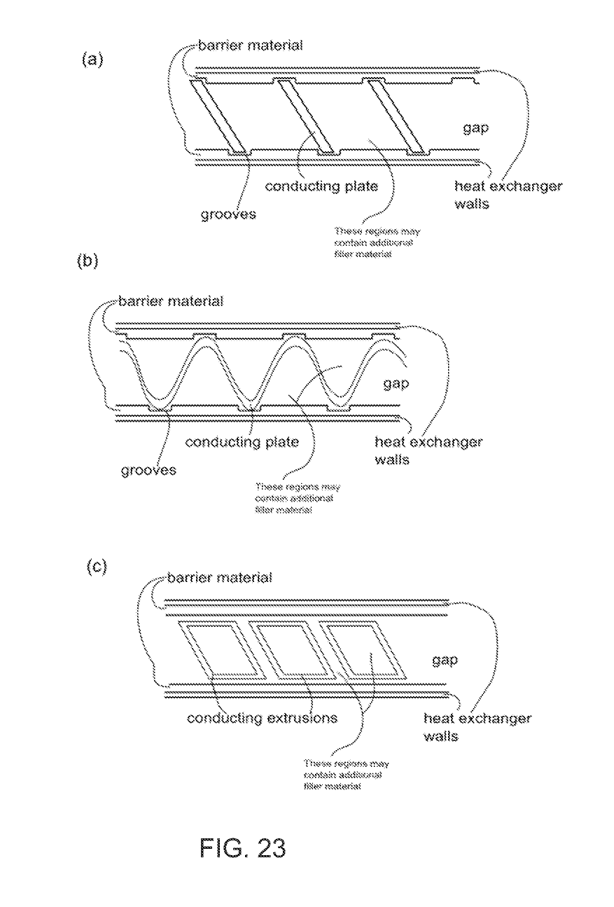

FIGS. 22 and 23 are cross-sectional schematics of a double-walled heat exchanger.

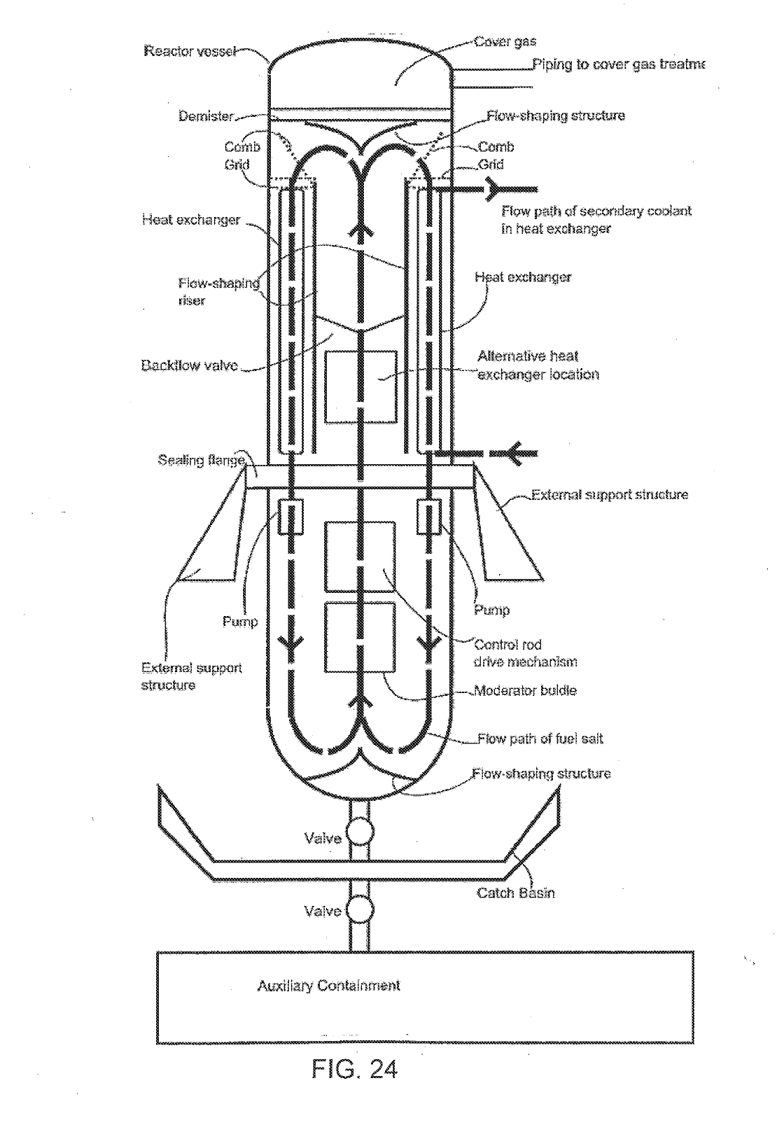

FIG. 24 is a cross-sectional schematic of the reactor vessel, catch basin, and auxiliary containment.

Among other things, implementations of what we describe here hold promise for producing electricity safely at relatively low cost using the spent nuclear fuel (in some cases without further processing) from existing nuclear reactors and using elements of nuclear reactor technology that have been tried or are considered feasible. The nuclear reactor that we propose to use to generate the electricity renders the spent fuel into a state that is much less problematic from an environmental and disposal perspective—the nuclear reactions that occur in the reactor induce fission in the majority of the actinides comprising the spent fuel, reducing their radioactive half-lives. At least some implementations of what we describe here modify previously developed molten salt reactor technology to enable the use of spent fuel from other reactors.

In at least some of the implementations, an important feature of the modified molten salt reactor is that the molten fuel-salt mixture includes all of the material that is contained in the spent nuclear fuel. When we refer to spent fuel, SNF, or spent nuclear fuel, we mean all of the fuel material that is in a spent fuel assembly except for the cladding material, which is not technically part of the spent fuel. In effect, at least in some of the implementations, the reactor core uses all of the spent fuel without requiring any separation or other manipulation.

Also, in at least some of the implementations, an important feature is that a form of zirconium hydride (ZrHₓ, where x may range from 1 to 4) is used as a moderator. In some cases, the zirconium hydride moderator is used as part of the elements that form a stationary reactor core. In some cases, the zirconium hydride moderator is used in movable moderator elements that can be inserted into and removed from the reactor core. In some cases, the zirconium hydride moderator is used in both the stationary reactor core and the moderator elements. The zirconium hydride can be more effective than other moderators in producing neutrons having appropriate energy levels to enable the spent fuel, which otherwise might be unable to do so, to become critical within the reactor core. In some cases, the fixed or moveable or both moderator elements can be one or more hydrides. In some cases, the elements can be one or more deuterides. In some cases, the elements can be a combination of hydrides or deuterides.

Although some of the implementations that we describe here contemplate combinations of molten salt reactors that use the spent fuel and highly effective moderators such as zirconium hydride, in some implementations, it may not be necessary to include all of these features together in a single facility.

FIG. 1 is a schematic diagram of an example nuclear reactor power plant 100 that includes a nuclear reactor core 106 in a primary loop 102. A molten (liquid) fuel-salt mixture 103 is circulated 105 continuously within the primary loop 102, including through the reactor core 106. The primary loop is charged with enough fuel-salt mixture to fill the loop, including the reactor core. The portion of the fuel-salt mixture that is in the reactor core at a given time is in a critical configuration, generating heat. (Fuel that has passed out of the reactor core and is in the rest of the loop is not in a critical configuration.) While the fuel-salt mixture is in this critical configuration in the reactor core, neutrons induce fission in the actinides, generating heat, and turning the actinides into fission products.

The salt (we sometimes use the simple word salt interchangeably with fuel-salt mixture or fuel) travels through the primary loop at a fast mass flow rate—in some implementations; this rate is approximately 800 kilograms per second. In some implementations, the rate could be higher than 800 kilograms per second or lower than 800 kilograms per second. The salt is moved quickly, because a large amount of heat is generated in the salt by the fissioning actinides in the reactor core 106, and the heat carried in this hot salt must be moved rapidly to the heat exchanger 112.

Tritium, a radioactive isotope of hydrogen, is produced in the primary loop of a molten salt nuclear reactor. It is highly desirable to prevent this tritium from migrating across the heat exchanger and thereby contaminating other parts of the plant. We have therefore designed a heat exchanger that is both highly effective (i.e., there is a high thermal conductivity between the two sides of the heat exchanger) and capable of trapping tritium.

As shown in FIGS. 22 and 23, this double-walled heat exchanger has a gap between the primary and secondary sides. This gap provides safety benefits, because it provides an additional degree of separation between the primary and secondary sides: both walls would have to break for there to be mixing between the primary and secondary fluids. This gap may also be used to trap tritium. For example, tritium may diffuse from the primary side into the air-filled gap. The air filling the gap could be circulated using a pump through a filter, such as a getter bed or other appropriate mechanism, capable of removing tritium.

This gap may be filled with additional material that may serve to either aid tritium trapping, increase the effectiveness of the heat exchanger, or both. A filling material's ability to trap tritium depends on its temperature, surface area, and material characteristics. Desirable properties also include: elastic, resistant to radiation damage, and resistant to corrosion be the primary and secondary fluids. In a molten salt reactor, there fluids could include molten salt (both with and without radioactive isotopes), water, air, helium, carbon dioxide, or other working fluids. The filler material should also have high thermal conductivity, to permit more effective heat transfer.

The three main methods for tritium movement in these systems are: diffusion, permeation, and bulk transport. We incorporate methods that block these transport mechanisms both singly and in combination. An ideal implementation includes, for example, both a barrier and a tritium separation and removal system to adequately control tritium transport across the heat exchanger.

The walls surrounding the heat exchanger gap or other parts of the heat exchanger, such as conduction plates and/or fins, may be composed of, lined with, or coated with a barrier material that may have a lower tritium permeability than the base material used in the heat exchanger. These materials could include ceramics such as Al₂O₃, Cr₂O₃, SiO₂, TiN, and TiC, either singly or in combination (for example, as a laminate consisting multiple layers of these materials). One implementation may use layered TiN/TiC with SiO₂. This barrier could be, in some implementations, between a fraction of a millimeter and several centimeters in thickness. In another implementation, the surface of the heat exchanger may be aluminized, to generate a surface layer of either aluminide or iron-aluminum alloy, or a combination of these two. One process used to generate this surface layer is termed “pack-aluminizing.” This surface layer may then be oxidized by air to form alumina. Alumina, aluminide, and iron-aluminum alloy may all serve to inhibit the transport of tritium and/or hydrogen.

In another implementation, a barrier coating on the walls surrounding the heat exchanger gap or other parts of the heat exchanger, such as conduction plates and/or fins, may be formed via a chemical reaction such as oxidation between the heat exchanger base material and a fluid flowing through the heat exchanger. In one implementation, the base material may form an oxide with a spinel structure (XY₂O₄), such as FeCr₂O₄ or MnCr₂O₄. Other surface layers could include Fe₃O₄ or Cr₂O₃.

In another implementation, the heat exchanger itself could be made out of a materials that have low tritium permeability, such as silicon carbide, Al2O3, and/or KT SiC, either singly or in any combination.

In one implementation, the system may include a permeation window: an area of the heat exchanger with a comparatively high tritium permeability. This window may be comprised of Pd, Ta, V, Zr, Nb, polymeric membranes, ceramic membranes, electronic membranes, or other materials. Tritium may be removed from the system via such a permeation window and, for example, trapped a capture system. Several methods may be used for this capture system. They include: purge streams, flushing or evacuating the tritium after it passes through the permeation window, getter beds, and chemical transformation.

Chemical transformation processes may include converting the tritium into tritiated water (in either liquid or vapor form), which reduces its ability to diffuse across barriers. Some process that may be used are described in U.S. Pat. No. 3,937,649, U.S. Pat. No. 4,178,350, U.S. Pat. No. 4,673,547, and U.S. Pat. No. 4,082,834.

Filler material that bridges the gap between the sides of the heat exchanger could serve a getter beds. Suitable materials for this application include metals that can form hydrides and/or have hydrogen dissolve into them. Once these materials have absorbed hydrogen, it is often necessary to apply heat to get them to release the hydrogen. A system may include a method for applying heat to the getter material to induce it to release absorbed and/or adsorbed hydrogen. Some suitable materials include: zirconium, tungsten, palladium, nickel, platinum, titanium, or other alloys or laminates of these or other materials. Zirconium has a high thermal conductivity and tritium solubility, so it is well suited for these applications.

The filler material may also be used to trap other products migrating from the primary side, such as the gaseous fission products xenon and krypton.

One implementation for filling the gap is by using conductor plates made of a suitable material that reach across the gap. Some potential conductor plate configurations are shown in FIGS. 22 and 23. In one implementation, angled plates may be used. These plates could wither by fixed directly to the heat exchanger walls (via welding or some other appropriate procedure) or they could be held in place by troughs or grooves made in the surface of the heat exchanger walls or made in the surface of an additional barrier material used to line the heat exchanger walls. Holding the plates in place using troughs would allow them to slide during thermal expansion or other stress placed on the heat exchanger.

Alternative plate configurations include straight plates (shown in FIG. 23a), wavy plates (shown in FIG. 23b), shaped extrusions (shown in FIG. 23c), and any other geometric configuration that would permit the transfer of heat across the gap.

These plates may be bimetallic, and consist of a laminate of two metals. This configuration may enable better control over thermal expansion, because bimetallic materials may be designed to bend in a particular direction when heated, depending on the relative coefficients of thermal expansion of their component materials. For example, the bimetallic plates could be chosen so that, when heated, they bend in a direction so as to become more perpendicular to the walls of the heat exchanger gap. They may therefore push harder on the walls, thereby increasing their contact with the walls and increasing the thermal conductivity, making it possible to transfer more heat. The contact area depends on the profile and elasticity of the materials used. This flexible interface makes the heat exchanger better able to adapt to thermal stresses, such as those caused by startup, shutdown, or changing the power level of the reactor. Furthermore, this flexible interface may be incorporated into many different types of heat exchangers, such as shell-and-tube, plate, plate-and-shell, adiabatic wheel, plate fin, pillow plate, and printed board heat exchangers.

Instead of or in addition to the conductor plates, the heat exchanger gap may be filled with solid, powder, or granule material that could serve as a getter bed, such as zirconium, as shown in FIGS. 22 and 23. Zirconium has a high thermal conductivity and tritium solubility, so it is well suited for these applications. The gap could also be filled with a liquid such as water or gas such as air, hydrogen, or helium.

In one implementation, a gas circulates through the portions of the gap that do not contain solid material. All or a portion of this gas could be circulated through a detector, such as a Geiger counter or neutron activation analysis equipment, which could be used to detect elements (such as fuel salt components) that would indicate a leak in the heat exchanger. Alternative or in addition to this, the gas could be pumped through a conventional tritium trapping system, enabling further removal of tritium from the system. This gas may be kept at a pressure higher than the pressure in the primary loop, to provide a pressure gradient that would discourage tritium diffusion.

In one implementation, hydrogen may be introduced into the system downstream of the heat exchanger, which may create a concentration gradient of hydrogen which may serve to reduce the flow of tritium.

The integrity of the heat exchanger and its plates may also be monitored by evaluating the changing material properties of the components. In one implementation, zirconium metal is used for the conducting plates. This metal becomes brittle and changes its electrical resistance when it absorbs tritium. The plates' resistance may be monitored so that the plates may be removed and replaced when their electrical resistance (and corresponding brittleness) rises above a certain value.

Collected tritium may be captured and/or disposed of in the form of a metal hydride, or by any other method known to the art.

Because the salt is traveling so quickly, only a small fraction of the actinides are fissioned in the reactor core during each pass through the loop. The actinides, however, pass many times through the reactor core. In some cases, after 10 years' worth of passes through the reactor core, for example, approximately 30% of a given initial amount of actinides may be turned into fission products.

The actinides dissolved in the fuel-salt mixture 103 can be a wide variety of actinides and combinations of actinides and can originate from a wide variety of sources and combinations of sources. In some implementations, for example, the actinides can be from spent nuclear fuel 139 generated by existing nuclear reactors 143. In some implementations, the actinides originate from decommissioned weapons 152 and include plutonium and/or uranium. In some examples, the sources can include natural uranium 155. In some examples, the sources can include depleted uranium 159 (left over from an enrichment process). In some examples, the sources can include fresh fuel 157 (which may encompass uranium enriched in U-235, or a mixture of fertile thorium and a fissile matter such as U-233, U-235, Pu-239, or Pu-241). In some examples, the sources can include a combination of any two or more of fresh fuel 157, decommissioned weapons plutonium or uranium 152, natural uranium 155, depleted uranium 159, or spent nuclear fuel 139.

The distribution of energy levels of neutrons in the reactor core affects the efficiency with which actinide fissioning occurs in the fuel-salt mixture in the core.

A cross section is a measure of the probability of a certain reaction occurring when a neutron interacts (e.g., collides) with a nucleus. For example, an absorption cross section measures the probability that a neutron will be absorbed by a nucleus of a particular isotope if it is incident upon that nucleus. Every isotope has a unique set of cross sections, which vary as a function of an incident neutron's kinetic energy.

The distribution of kinetic energies in a system's neutron population is represented, for example, by a neutron energy spectrum. Neutrons produced during a fission reaction have, on average, initial kinetic energies in the “fast” region of the neutron energy spectrum. Fast neutrons have kinetic energies greater than, for example, 10 keV. Epithermal neutrons have kinetic energies between, for example, 1 eV and 10 keV. Thermal neutrons have kinetic energies of, for example, approximately 0.025 eV. In the context of nuclear reactors, thermal neutrons more broadly refer to those with kinetic energies below, for example, 1 eV.

In some implementations, it is desirable for the reactor core (including the fuel-salt mixture in the core) to have a neutron energy spectrum comprising a large thermal neutron population, because in many cases thermal neutrons induce fission in actinides more readily than do fast neutrons. Decreasing the population of thermal neutrons in the reactor core reduces the rate of actinide fission in the reactor core.

The choice of salts to be used for the fuel-salt mixture depends, among other things, on the effect that the salt may have on the energy levels of neutrons within the mixture.

Several different factors should be taken into consideration when choosing a salt composition for a molten salt reactor. Important considerations are: the solubility of the heavy nuclei in the salt (generally, higher solubilities are better), neutron capture cross-section of the isotopes comprising the salt (generally, a lower capture cross-section is better), and moderating ability of the isotopes comprising the salt (generally, a higher moderating ability is better).

Heavy nuclide solubility depends on the chemical composition of the salt (e.g., lithium fluoride has a higher heavy nuclide solubility than potassium fluoride). In some implementations, preferred salt compositions are ones with higher heavy nuclide solubilities. According to our analysis, several salt compositions (detailed in the following section) have heavy nuclide solubilities sufficiently high to allow the fuel-salt mixture in the reactor core to remain critical. How high the solubility needs to be depends on the fuel that is being used. In simulations based on a model with ten ZrH_{1.6} rings (discussed in more detail later) and using fresh fuel enriched to 20% U-235, 0.35% heavy nuclide solubility was sufficient. A previously proposed molten salt breeder reactor design had planned to use a salt with 12% heavy nuclides. Using the entire spent fuel actinide vector in systems described here, we estimate a need for at least 20% solubility. All percentages are expressed in mol %.

The neutron capture cross section depends on the isotopic composition of the particular one or more species in the salt. Li-7 has a lower neutron capture cross section than Li-6, and is therefore likely to be a better lithium isotope for the lithium fluoride salt, when a lithium fluoride salt is being used). Chloride salts are, in general, expected to be less useful than fluoride salts because chlorine is comprised primarily of Cl-35, which has a high neutron capture cross section. As explained in subsequent sections, in the salts that are considered for use, the other component could advantageously include lighter elements such as lithium, which have a greater moderating ability than heavier elements such as chlorine.

In some implementations, the fuel-salt mixture 103 comprises a molten halide salt (e.g., LiF-(Heavy Nuclide)Fₓ). In the preceding and subsequent chemical formulas, a heavy nuclide may be, for example, a lanthanide, or may be an actinide, or may be some combination of the two. There are at least three general classes of halide salts that can be used in molten salt reactors: chloride salts can be used, fluoride salts can be used, and iodide salts can be used, or a combination of any two or more of them can be used. In some implementations, there may be advantages to using fluoride salts in the nuclear reactor system 100. (As mentioned earlier, for example, the isotope Cl-35, which has a natural abundance of 75.55% in naturally occurring chloride salts, has a high thermal neutron absorption cross section. A chloride salt, by contrast, therefore reduces the number of thermal neutrons in the reactor core's neutron energy spectrum.)

Suitable salt compositions may include each of the following taken individually, and combinations of any two or more of them: LiF-(Heavy Nuclide)Fₓ, NaF—BeF₂-(Heavy Nuclide)Fₓ, LiF—NaF-(Heavy Nuclide)Fₓ, NaF—KF-(Heavy Nuclide)Fₓ, and NaF—RbF-(Heavy Nuclide)Fₓ. Example compositions using these species may include each of the following or combinations of any two or more of them: 8.5 mol %(Heavy Nuclide)Fₓ-34 mol % NaF-57.5 mol % BeF₂, 12 mol %(Heavy Nuclide)Fₓ-76 mol % NaF-12 mol % BeF₂, 15 mol %(Heavy Nuclide)Fₓ-25 mol % NaF-60 mol % BeF₂, 22 mol % (Heavy Nuclide)Fₓ-33 mol % LiF-45 mol % NaF, 22 mol % (Heavy Nuclide)Fₓ-78 mol % LiF, 25 mol % (Heavy Nuclide)Fₓ-48.2 mol % NaF-26.8 mol % KF, 27 mol % (Heavy Nuclide)Fₓ-53 mol % NaF-20 mol % RbF, 27.5 mol %(Heavy Nuclide)Fₓ-46.5 mol % NaF-26 mol % KF, and 30 mol %(Heavy Nuclide)Fₓ-50 mol % NaF-20 mol % KF.

Although a salt with a high heavy nuclide solubility is useful, considerations other than the heavy nuclide solubility should also be taken into account. The composition with the highest molar percentage of (Heavy Nuclide)Fₓ is not necessarily the most desirable. For example, 30 mol %(Heavy Nuclide)Fₓ-50 mol % NaF-20 mol % KF has a higher heavy nuclide concentration than 22 mol % (Heavy Nuclide)Fₓ-78 mol % LiF, but the 22 mol % (Heavy Nuclide)Fₓ-78 mol % LiF may be better because the lithium in the second salt has a greater moderating ability than the sodium or potassium in the first salt. Lighter elements such as lithium have a greater moderating ability than heavier elements such as sodium.

In some implementations, the fuel-salt mixture 103 comprises a lithium fluoride salt containing dissolved heavy nuclides (LiF-(Heavy Nuclide)Fₓ). In some implementations, a LiF-(Heavy Nuclide)Fₓ mixture can contain up to, for example, 22 mol % (Heavy Nuclide)Fₓ. Lithium is a very light element and its moderating capability can make it neutronically advantageous for a thermal spectrum reactor. Li-7, in particular, has desirable neutronic properties. Li-6 has a significantly higher thermal neutron absorption cross section (941 barns) than Li-7 (0.045 barns). Neutron absorption by lithium decreases the reactor's reactivity because the neutrons absorbed by lithium are unavailable to split actinides. As such, in some implementations, the lithium in the salt can be enriched so that it has a high fraction of Li-7, which reduces the tendency of the fuel-salt mixture to absorb thermal neutrons.

In some implementations, beryllium can be added to molten halide salts to lower the salts' melting temperatures. In some implementations, the fuel-salt mixture 103 comprises a beryllium lithium fluoride salt containing dissolved heavy nuclei (LiF—BeF₂-(Heavy Nuclide)Fₓ). The presence of beryllium in the fuel-salt mixture can, however, reduce the effectiveness of Li-7 enrichment, because Li-6 is produced in (n,α) reactions with Be-9. Therefore, in some implementations, no beryllium is added to the molten salt. In some implementations, a reduced amount of beryllium is added.

In addition, adding beryllium can decrease the solubility of actinides in the salt. Because there is less fissile material per kilogram of spent nuclear fuel than of fresh fuel, a higher actinide concentration may be required to make the nuclear reactor system 101 become critical. Removing BeF₂ entirely from the salt can increase the actinide solubility of the salt from 12.3% to 22%, enough to enable the fuel-salt mixture to reach criticality without first processing spent nuclear fuel to increase the fissile-to-fertile ratio (e.g., by removing uranium). In some implementations, the resulting increase in actinide solubility allows the nuclear reactor power plant 100 to use the entire spent nuclear fuel vector as fuel. In some implementations, a mixture of spent nuclear fuel, or portions of it, combined with other elements of fuel can also be used.

During operation, the fuel-salt mixture 103 fills the reactor core 106. Some of the free neutrons from fission reactions in the reactor core 106 can induce fission in other fuel atoms in the reactor core 106, and other neutrons from the fission reaction can be absorbed by non-fuel atoms or leak out of the reactor core 106. The fuel-salt mixture in the reactor core can be in a critical or self-sustaining state when the number of neutrons being produced in the reactor core 106 is equal to or substantially equal to the number of neutrons being lost (e.g., through fission, absorption, or transport out of the system (e.g., “leakage”)). When in a critical state, the nuclear reaction is self-sustaining.

In some instances, whether the fuel-salt mixture in the reactor core is in a critical state is primarily determined by three factors: the nuclear properties of the fuel-salt mixture, the properties of the materials used to fabricate the reactor core 106, and the geometric arrangement of the fuel-salt mixture and the other materials in the reactor core. The combination of these three factors primarily determines the distribution of neutrons in space and energy throughout the reactor core 106 and, thereby, the rate of the reactions occurring in the reactor core 106. The reactor core 106 can be designed to keep the fuel-salt mixture in the reactor core in a critical state by arranging the mixture, the geometric arrangement, and the materials so that the rate of neutron production exactly or approximately equals the rate of neutron loss.

Generally, U-235 and Pu-239 have a larger fission cross section in the thermal neutron energy region than they do in the fast neutron energy region, that is, these nuclei are more easily fissioned by thermal neutrons than by fast neutrons.

Neutron capture is another possible nuclear reaction and may occur between U-238 and a neutron. In a neutron capture reaction, the nucleus absorbs a neutron that is incident upon it, but does not reemit that neutron or undergo fission.

In some instances, the most effective neutron energies for transmuting U-238 into Pu-239 are in the epithermal region. Pu-239, a fissile isotope, is produced when U-238 captures a neutron to become U-239, which beta decays into Np-239, which beta decays into Pu-239. The optimal energy range for converting U-238 into U-239 (and eventually into Pu-239) is determined by U-238's cross sections. In FIG. 11, the fission cross section of U-238 1102 is lower than the capture cross section 1104 for all energies below about 1 MeV, meaning that a neutron with a kinetic energy below 1 MeV has a greater probability of being captured by U-238 than causing U-238 to fission. The probability of capturing a neutron relative to the probability of fissioning (the vertical distance between the two plots) is greatest in the range from approximately 5 eV to 10 KeV. This is a good range for converting U-238 into Pu-239.

The thermal and epithermal neutron spectra needed by some implementations can be achieved by introducing moderating materials. In some implementations, the moderating materials can, for example, be introduced in the reactor core elements. In some implementations, the moderating materials can be inserted into and removed from the reactor core 106. In some implementations, a combination of the two can be used. In some implementations, the moderating elements shift the neutron spectra to more have more useful characteristics, by, for example, reducing the energies of neutrons in the fuel-salt mixture.

The moderating efficiency, η_{mod}, of a material is defined as the mean logarithmic reduction of neutron energy per collision, ξ, multiplied by the macroscopic scattering cross section Σₛ divided by the macroscopic absorption cross section Σₐ, as presented in equations 1.1 and 1.2.

$$\begin{matrix}ξ = ln \frac{{E}_{0}}{E} = 1 + \frac{{( A - 1 )}^{2}}{2 A} ln ( \frac{A - 1}{A + 1} ) & [ 1.1 ] \\ {η}_{mod} = \frac{ξ {Σ}_{s}}{{Σ}_{a}} & [ 1.2 ]\end{matrix}$$

In equation 1.1, E₀ is the kinetic energy of the neutron before the collision with the nucleus, E is the kinetic energy of the neutron after the collision with the nucleus, and A is the atomic mass of the nucleus.

As indicated by equation 1.1, neutrons typically lose a smaller fraction of their kinetic energy when they scatter off nuclei with a larger atomic mass. Conversely, neutrons typically lose a larger fraction of their kinetic energy when they scatter off nuclei with a smaller atomic mass (e.g., carbon, hydrogen, lithium). A low atomic mass of the nuclei means that a neutron needs to undergo fewer collisions with the moderator to slow down to a particular energy.

Every time a neutron collides with a nucleus, there is a finite probability that the neutron will be captured by that nucleus. Typically, neutron capture in a non-fuel material like a moderator should be reduced or minimized because it cannot result in fission. To reduce neutron capture, a moderator with a higher moderating efficiency should be one that has a low capture cross section and a low atomic mass. A low capture cross section means that, for every collision with the moderator, there is a low probability the neutron will be captured.

The reactor cores of some nuclear reactor systems use graphite as a moderator. In some implementations, the reactor core 106 uses a moderator material that has a higher moderating effectiveness than does graphite alone.

In some implementations, a form of zirconium hydride (e.g., ZrH_{1.6}) can be used as a moderator in the reactor core 106 instead of, or in some implementations in addition to, graphite. ZrH_{1.6} is a crystalline form of zirconium hydride, with face-centered cubic symmetry. There are other phases of zirconium hydride (ZrHₓ, where x can range from 1 to 4) and the physical properties of zirconium hydride vary among the other phases. In some implementations, the zirconium hydride moderator could be in the form of a solid single crystal. In some implementations, a powdered form of zirconium hydride, comprising smaller crystals could be used. In some implementations, smaller crystals could be formed into solid shapes (using, for example, one or any combination of the following processes: sintering the crystals, binding the crystals together using a binder such as coal tar, or any other suitable process).

Zirconium hydride has a greater moderating ability than graphite because it has a high density of hydrogen nuclei. The hydrogen nuclei in zirconium hydride are approximately 12 times lighter than the carbon nuclei in graphite. Following equation 1.1, a neutron typically requires fewer collisions with zirconium hydride to reach thermal energies than it does with graphite. In some implementations, using zirconium hydride rather than graphite alone in the reactor core 106 can increase the number of neutrons in the epithermal and thermal energy ranges.

The use of zirconium hydride as a moderator can also provide the benefit of increasing the rate at which U-238 is transmuted into Pu-239. This increase can allow the nuclear reactor system 101 to operate as a so-called converter reactor by producing fissile Pu-239 at the same or substantially the same rate as fissile and fissionable actinides are consumed. Although minor actinides—e.g., actinide elements other than uranium or plutonium—are more easily fissioned with fast neutrons, they can still be fissioned in such implementations using the neutron spectrum that would be present in reactor core 106.

Other types of moderators individually and in combination can be used as a moderator in the stationary reactor core 106, or in the movable moderating elements, or in both of them. For example, any suitable combinations of any two or more of graphite, zirconium hydride, zirconium deuteride, or other moderator materials can be used.

In some implementations, the moderator material has a high density of light atomic nuclei (e.g., hydrogen, deuterium, lithium, etc., individually or in any combinations of any two or more of them). The concentration of hydrogen in ZrH is 1.6 hydrogen atoms per zirconium atom. Additional or other materials, or combinations of them, with similar or higher densities of hydrogen can be used as a moderator material. Other moderator materials may include any of the following individually or in any combination: other metal hydrides, metal deuterides, and low atomic mass materials in solid form (e.g. solid lithium). In some implementations, zirconium deuteride may be more effective than zirconium hydride because deuterium has a much smaller neutron absorption cross section than hydrogen. Specifically, our computer simulations show the following materials to be effective moderators in our reactor core design: zirconium hydride (ZrH_{1.6} and ZrH₂), yttrium(II) hydride (YH₂), yttrium(III) hydride (YH₃), and lithium hydride (LiH). Those materials could be used individually or in any combination of two or more of them.

In some implementations, the level of reactivity in the reactor core 106 can be controlled using one or more movable moderating elements, for example moderator rods. The moderating elements can alter the thermal and epithermal neutron spectra by being inserted into and removed from the reactor core 106. In some implementations, these moderating materials may be in the form of rods, blocks, plates, or other configurations, used individually or in any combination.

The moderating rods can be made of zirconium hydride, zirconium deuteride, graphite, used individually, or any other suitable material or combination of materials. The rods may be of a wide variety of shapes, sizes, and configurations, and can have a wide variety of approaches for their insertion into and removal from the reactor core.

In the context of reactivity control, in some implementations, a moderating rod can mean an element made of moderating material that can be inserted or withdrawn from the reactor core. In some implementations, the moderator rods can be movable relative to the reactor core vessel 106 so that the moderator rods can be fully or partially withdrawn from the reactor core 106. In some examples, the nuclear reactor system 101 is subcritical when the moderator rods are partially or fully withdrawn from the reactor core 106. Reactivity is increased by partially or fully inserting moderator rods until the reactor becomes critical. The reactor can be shut down by withdrawing the moderator rods.

In some implementations, the use of zirconium hydride (and possibly other hydrides and deuterides) as a moderator material can allow the nuclear reactor system 101 to operate entirely on spent nuclear fuel. In some implementations, the use of such materials can allow the nuclear reactor system 101 to operate partially on spent nuclear fuel. In some implementations, zirconium hydride could be used to make, for example, a more efficient thorium molten salt reactor. In some implementations, the use of zirconium hydride could make a thorium molten salt reactor more neutronically efficient because the moderating effectiveness of zirconium hydride is greater than that of graphite. The use of zirconium hydride in a thorium reactor—a reactor that transmutes thorium into fissile U-233—could reduce the required amount of fuel, could improve fuel utilization, could reduce the required size of the reactor core, or could achieve a combination of them.

In some implementations, it is desirable to surround the moderating material with a material that is more resistant to chemical corrosion than the moderating material is, e.g., using either a graphite or a silicon carbide composite (or a combination of them) cladding on a zirconium hydride moderator rod. Including such a cladding reduces the likelihood of corrosion-induced degradation of the moderating material. In various implementations, the cladding material can have a low neutron absorption cross section, can be a neutron moderator, or can have a combination of these and other properties. In some examples, the cladding can be provided on parts of the reactor core. In some examples, the cladding can be provided on parts of the moderator rods. In some examples, the cladding can be provided on both.

In some implementations, differential swelling or shrinkage of materials comprising the reactor core 106 can occur. For example, zirconium hydride, graphite, or other moderator materials in the reactor core 106 will be subject to large neutron fluxes, which can lead to volumetric swelling or shrinkage. In cases in which both graphite and zirconium hydride are used in the reactor core 106, the graphite and the zirconium hydride could experience significantly different amounts of volumetric swelling or shrinkage. In some implementations, gaps can be provided at the interfaces of the graphite and zirconium hydride to prevent (or reduce the tendency of) such swelling or shrinkage from cracking the graphite cladding and exposing the zirconium hydride directly to the fuel-salt mixture.

In some implementations, the reactor core 106 can be designed with gaps at the interfaces between different types of materials, for example, to protect against damage caused by differential swelling or shrinkage. In some implementations, the gaps could be filled with an inert gas, e.g., helium, to reduce chemical interactions between the materials.

Alternatively or in addition to movable moderating elements, movable control rods can be used in reactor core 106 in some instances. Control rods can remove neutrons from the system by capturing neutrons that are incident upon them. For example, control rods that are used on solid-fuel reactors, or other types of control rods, or combinations of them, can be used. Reactivity can be increased by withdrawing the control rods from the reactor core 106. Reactivity can be decreased by inserting the control rods in the reactor core 106.

In some implementations, the same or a similar effect can be achieved in some cases using a reflector control system. In some examples, both a reflector system and control rods could be used. In some examples of reflector control systems, movable sheets of either absorbing or of a moderating material (or a combination of them) can reside between an interior region of the reactor core 106 and a reflector about the interior region. The sheets can be manipulated (e.g., raised, lowered, rotated, or otherwise manipulated) to increase or decrease the amount of neutrons reflected into the interior region of the reactor core 106. The reflector 205 may be inside the reactor vessel 203, outside the reactor vessel, or both.

In some implementations, in combination with or in replacement of the techniques described above, reactivity can be controlled by adjusting the rate at which additional fuel is added to the fuel-salt mixture in the primary loop 102. In some cases, reactivity can be controlled by adjusting the rate at which waste materials are removed from the fuel-salt mixture in the primary loop 102. In some implementations a combination of the rate of adding fuel and the rate of removing waste can be used. As fuel is consumed in the reactor core, the reactivity of the fuel-salt mixture decreases. Eventually, without adding fuel or removing waste, or both, the fuel-salt mixture would no longer be critical, and the generation of heat would stop. By adding fuel and removing waste at appropriate rates, the reactivity can be maintained at a suitable level.

In some implementations, the fissile-to-fertile ratio may be too low to remain critical over time. In such instances, in addition to or in replacement of the techniques described above, reactivity may be controlled by partially or fully inserting or removing solid fuel elements. Inserting a solid fuel element that has a higher fissile concentration than the fuel-salt mixture may increase reactivity in the reactor. Conversely, removing such an element would reduce the reactivity of the reactor system. Such solid fuel elements may take the form of one of oxide fuel rods such as those used in conventional reactors, or metallic fuel rods, or plates of metallic fuel, or pebbles containing fissionable material, or a combination of any two or more of those. The fissionable fuel may comprise any one or a combination of any two or more of enriched uranium (up to 20% U-235), or depleted uranium, or natural uranium, or actinide material from spent fuel, or weapons material, or thorium and a fissile material, or any combination of these with any other fissionable material.

In some instances, a solid fuel element may comprise pellets of fissionable material surrounded by a cladding material. In various implementations, the cladding material may comprise a metal or metal alloy similar to or the same as those used in conventional reactors, or a metal or metal alloy such as Hastelloy that is resistant to corrosion in molten salts, or any other suitable metal or metal alloy, or a moderating material such as graphite, or zirconium hydride, or yttrium hydride, or any combination of two or more of those.

In some instances, solid fuel elements may be fully inserted at all times during operation and may be replaced, periodically or otherwise, as they are in conventional reactors. In such implementations, the solid fuel elements may provide more reactivity than the fuel-salt mixture alone. This would allow a reactor to operate with a fuel-salt mixture that has a lower concentration of heavy nuclei, allow a reactor to operate with a fuel-salt mixture with a lower fissile-to-fertile ratio, or allow higher burnup—a measure of how much fuel material has undergone fission—of the fuel in the fuel-salt mixture, or any combination of these.

In some instances, solid fuel elements removed from a molten salt reactor may contain large amounts of long-lived heavy nuclei, similar to those found in spent fuel from conventional reactors. In some implementations, these used fuel elements could then be mixed with a molten salt for use as a fuel-salt in a molten salt reactor. In some cases, these used fuel elements could be put in temporary storage or sent to a permanent disposal facility.

If an important objective of operating molten salt reactors is reducing spent fuel inventories, the use of molten salt reactors that include solid fuel elements may still be advantageous if more actinide waste is destroyed than is produced by such reactors. If the primary objective is electricity production, the amount of actinide waste produced may be of lesser concern.

FIG. 2 is a schematic cross-sectional diagram of an example reactor core configuration 200 used in numerical simulations. The numerical simulations were used to test the ability to reach criticality in a molten salt reactor using only spent nuclear fuel dissolved in a molten lithium fluoride salt as fuel. The numerical simulations used the SCALE code system developed by Oak Ridge National Laboratory. In the implementation shown in FIG. 2, the reactor core was modeled as a series of ten concentric moderator cylinders (which we sometimes refer to as rings) 204 at equal radial spacings, a core vessel 203 made of Hastelloy, and a fuel-salt mixture 202 in the gaps between the moderator rings. (FIG. 2 also shows a reflector 205.) Concentric rings were used in the numerical simulations for ease of computer modeling. A wide variety of other types of reactor core configurations may be advantageous or optimal in various contexts.

The cylinders in the simulations were 3 meters tall.

In the numerical simulations, the Hastelloy core vessel was 5 cm thick and had an inner radius of 1.5 meters. Each of the ten concentric zirconium hydride rings was 5 cm thick. The LiF-(Heavy Nuclide)Fₓ fuel-salt mixture was located in the 9 cm gaps between the zirconium hydride rings and between the outermost moderator ring and the vessel wall. The vessel is surrounded by a neutron reflector 205. In this simulation, the reflector was zirconium hydride (ZrH_{1.6}). Additional or other reflectors (e.g., graphite or zirconium deuteride), individually or in combinations, can be used.

Table 1 shows the material data used in the numerical simulations.

TABLE 1
Fuel-Salt Mixture

| | |
|---|---|
| LiF (mol %) | 78 |
| (Heavy Nuclide)Fₓ (mol %) | 22 |
| Density (g/cm³) | 3.89 |
| Li-7 Enrichment | 99.99% |

Zirconium Hydride

| | |
|---|---|
| Zr-90 (wt %) | 51.79 |
| Zr-91 (wt %) | 11.29 |
| Zr-92 (wt %) | 17.26 |
| Zr-94 (wt %) | 17.49 |
| H-1 (wt %) | 2.16 |
| Density (g/cm³) | 5.66 |

Hastelloy

| | |
|---|---|
| C (wt %) | 0.06 |
| Co (wt %) | 0.25 |
| Cr (wt %) | 7.00 |
| Mo (wt %) | 16.50 |
| W (wt %) | 0.20 |
| Cu (wt %) | 0.10 |
| Fe (wt %) | 3.00 |
| Mn (wt %) | 0.40 |
| Si (wt %) | 0.25 |
| B (wt %) | 0.01 |
| Ni (wt %) | 72.23 |
| Density (g/cm3) | 8.86 |

(In the discussion that follows, the references to simulation tools are to elements of the Oak Ridge National Laboratory, “SCALE: A Modular Code System for Performing Standardized Computer Analyses for Licensing Evaluations,” (2009).) The isotopic composition of spent nuclear fuel from an example light water reactor was calculated with the ORIGEN-ARP graphical user interface, which is a SCALE analytical sequence that solves for time-dependent material concentrations using the ORIGEN-S depletion code and pre-computed cross section sets for common reactor designs. In this case, a Westinghouse 17×17 assembly normalized to 1 metric ton of uranium with an initial enrichment of 4.2% was depleted to 50 GWd/MTHM (gigawatt-days per metric ton of heavy metal) and the isotopic concentrations from the ORIGEN output file were used to calculate the weight percent (wt %) for each actinide isotope (fission products were discarded) in the spent fuel. Table 2 shows the isotopic composition of the spent nuclear fuel used for numerical simulations.

TABLE 2

| Isotope | wt % |
|---|---|
| U-234 | 1.84E−02 |
| U-235 | 7.46E−01 |
| U-236 | 6.05E−01 |
| U-238 | 9.73E+01 |
| Np-237 | 7.59E−02 |
| Pu-236 | 1.00E−10 |
| Pu-238 | 3.50E−02 |
| Pu-239 | 6.33E−01 |
| Pu-240 | 3.10E−01 |
| Pu-241 | 1.41E−01 |
| Pu-242 | 9.61E−02 |
| Am-241 | 4.50E−02 |
| Am-242 | 1.38E−04 |
| Am-243 | 2.61E−02 |
| Cm-242 | 1.41E−06 |
| Cm-243 | 7.40E−05 |
| Cm-244 | 8.80E−03 |
| Cm-245 | 5.23E−04 |
| Cm-246 | 6.76E−05 |
| Cm-247 | 1.07E−06 |
| Cm-248 | 7.74E−08 |
| Bk-249 | 1.00E−10 |
| Cf-249 | 1.08E−09 |
| Cf-250 | 3.51E−10 |
| Cf-251 | 1.85E−10 |
| Cf-252 | 3.41E−11 |

The TRITON-NEWT sequence in SCALE was used to analyze the core model shown in FIG. 2 and described above. Within this sequence, the TRITON control module is used to call, in order, the functional modules BONAMI, WORKER, CENTRM, PMC, and NEWT. BONAMI performs Bondarenko calculations on master library cross sections to account for energy self-shielding effects; WORKER formats and passes data between other modules; CENTRM uses both pointwise and multigroup nuclear data to compute a continuous energy neutron flux by solving the Boltzmann transport equation using discrete ordinates; PMC takes the continuous energy neutron flux from CENTRM and calculates group-averaged cross sections; and NEWT performs a 2D discrete ordinates calculation to determine the multiplication factor for the system. An axial buckling correction is then applied to account for axial neutron leakage.

FIG. 3 is a diagram of a computational mesh 300 used in the numerical simulations. Only one fourth (a quadrant) of the reactor core was modeled to reduce computational time. The resulting multiplication factor is not affected because of the symmetry of the reactor core. As shown in FIG. 3, the circular region bounded by the outer edge 303 of the vessel was divided into a thirty-by-thirty mesh 301; the reflector region 305, which fills the remaining area of the 210 cm by 210 cm system, was divided into a twenty-by-twenty mesh 307. Reflective boundary conditions were used on the bottom and left sides and vacuum boundary conditions were used on the top and right sides. For the axial buckling calculation, the active core height was set to 300 cm with no reflection on either side. The axial buckling correction used here assumes vacuum boundary conditions on the top and bottom of the active core region. An eighth-order quadrature set was used in the NEWT discrete-ordinates transport calculation.

According to the numerical simulations, a multiplication factor (ratio of neutron production to loss) of 1.043 was calculated. This value indicates that there is more than enough reactivity to achieve criticality using the entire spent nuclear fuel actinide vector as fuel, without processing to enhance the actinide vector (e.g., without removing some or all of the uranium).

The numerical simulations used here can be modified to include higher fidelity neutronics calculations, optimized or improved material configurations, a complete three-dimensional model that accounts for reflectivity above and below the reactor core, and other modifications. Such modifications could potentially result in numerical simulations that indicate significantly higher excess reactivity.

It is possible to use these methods to develop a nuclear reactor that uses a liquid fuel contained within a reactor core that is capable of varying its volume or the amount of fissile material that it contains. The liquid fuel may include molten salts with dissolved fissile material, heavy or light water with dissolved fissile material, or other types of liquid fuel.

Among other things, implementations of a nuclear reactor capable of varying its core volume or the amount of fissile material in its core hold promise for making load-following nuclear reactors, which are capable of readily changing their power output in response to short-term fluctuations in electricity demand (e.g., variations over the course of the day).

Varying the core volume may also be used for medium or long-term control of the reactor's reactivity—changing the core's volume changes the reactor's neutron leakage, which in turn affects the reactivity.

Reactor core size could also be varied in response to the fissile and fissionable material concentration in the liquid fuel used in the reactor. In general, fuel with a lower fissile and fissionable material content would require a larger core than would fuel with a higher fissile and fissionable material content. Having a reactor core capable of varying in size would increase flexibility in terms of the types (e.g., enrichment or isotope content) of the fuels used in the reactor.

A variable core size also makes it possible to mass-produce reactors that can have their power levels adjusted at the plant site. Depending on its adjusted core volume, the same reactor could be used to generate, for example, any power level between 100 Megawatts and 1000 Megawatts of electric power. This variation makes it possible to maintain the economic advantages of mass production while allowing for flexibility for utilities at the plant site. Furthermore, the power production levels could be readily increased to keep up with growing electricity demand in the area surrounding the plant site, thereby allowing utilities to increase their electricity production without the significant added expense of building an additional power plant.

FIG. 19 is a schematic diagram of an example nuclear reactor primary loop 102 that includes a nuclear reactor core 106. The reactor core 106 includes an active region 1907 and a passive region 1908. The active region 1907 contains the circulating liquid fuel 103. In one implementation, the liquid fuel is a molten salt containing dissolved fissionable and fissile material. The passive region 1908 does not contain liquid fuel. The liquid fuel is continuously circulated 105 using pumps 108a within the primary loop including the active region 1907 of the reactor core 106. The primary loop is charged with enough liquid fuel 103 to fill the primary loop, including the active region 1907 of the reactor core. The portion of the liquid fuel that is in the active region of the reactor core is in a critical configuration, generating heat. (Liquid fuel 103 that has passed out of the active region 1907 of the reactor core and is in the rest of the primary loop is not in a critical configuration.) The heat generated in the fuel salt is transferred out of the primary loop 102 via the heat exchanger 112. In some implementations, the heat exchanger transfers heat directly to a power production loop or other process heat application. Additional process heat applications may include, for example, hydrogen production or district heating. In other implementations, the heat exchanger 112 transfers the heat to intermediary heat transfer mechanisms, which in turn may transfer the heat to a power production loop or other process heat application.

The active region 1907 and passive region 1908 of the reactor core are separated from one another by a movable separator plate 1914. The range of motion of the separator plate is limited by the length of the extender pipe 1915 that extends from the separator plate 1914 into the primary loop piping. As the separator plate 1914 and extender pipe 1915 extend into the reactor core 106, the active volume 1907 of the reactor core 106 is decreased, which in some instances reduces the amount of heat produced by the core.

The passive region 1908 on the other side of the separator plate 1914 may contain a filling material 1909—any liquid, gas, or solid material either individually or in combination. In one implementation, the material 1909 consists of a liquid or gas that is pumped using pump system 1926 from a filling material reservoir 1917 into the passive region 1908 of the reactor core 106. The pressure induced by the pump system 1926 moves the separator plate 1914 inward into the reactor core 106, thereby increasing the volume of the passive region 1908 and decreasing the volume of the active region 1907. As the volume of active region 1907 is decreased, one can remove a corresponding volume of liquid fuel 103 from the primary loop 102, thereby maintaining a constant total volume of liquid fuel 103 and filling material 1909 in the primary loop 102. In some implementations, the liquid fuel 103 can be removed from the primary loop via valves 118 (used alone or in combination with pumps) into a holding tank 120. The holding tank 120 may contain any combination of insulation 1213, neutron reflectors 1922, or heating units 1214 to either prevent the liquid fuel from solidifying or permit rapid liquefaction of solidified fuel.

The separator plate 1914 can remain stationary when the pressures on both of its faces are equal. The pressure on the side of the separator plate 1914 facing the active region 1907 can depend primarily on the velocity, density, and viscosity of the liquid fuel 103. This pressure from the fluid would also act, in part, as a barrier to diffusion of isotopes from the active region to the passive region.

In one implementation, in which the separator plate is positioned to extend downwards into the reactor core, the density of the filling material 1909 can be chosen such that the weight of the filling material 1909 induces significant pressure on the side of the separator plate 1914 facing the passive region 1908, serving to partially or fully counteract the pressure on the side of the separator plate 1914 facing the active region 1907.

In some implementations, the active volume of the core may be decreased by using the pump system 1926 to pump the filling material 1909 from the passive region 1908 into the filling material reservoir 1917, while simultaneously pumping liquid fuel 103 from the holding tank 120 into the primary loop 102. In another implementation, the pressure induced by the circulating liquid fuel 103 on the separator plate 1914 may induce sufficient pressure on the system to push the filling material 1909 from the passive region 108. In either case, the position of the separator plate 1914 can be controlled by adjusting the relative pressure in the active region 1907 and passive region 1908, whether that pressure be induced by gravity or pumps.

Multiple systems may be used either singly or in combination to prevent sudden unwanted movement of the separator plate. The two most dangerous scenarios that could be cause by a sudden movement of the separator plate are (1) sudden increase in core volume, and (2) sudden increase in the ratio of moderator to fuel salt. These safety systems may include: pumps used to induce pressure on the separator plate; positioning the holding tank above the passive safety system, so that even in the event of pump failure it induces a static pressure on the separator plate; systems of mechanical, electric, or magnetic bearings or clamps to hold the separator plate in place; inclusion of a valve to transfer additional clean salt from an auxiliary reservoir; removal of excess heat through heat exchangers; and use of freeze valves to drain fuel salt from the primary loop. The system may also use staged freeze valves.

In some scenarios, it is desirable to drain only a fraction of the fuel salt from the primary loop. Such scenarios could include a situation in which the temperature of the fuel salt in primary loop is only a small number of degrees above the desired temperature. This method would make it possible to decrease the temperature to the desired value, without having to shut down the reactor. In such an implementation, one may use a freeze valve connected to an auxiliary tank, whose volume is not large enough to contain the entire volume of the fuel salt. The flow into the auxiliary tank therefore stops when the tank is full. One application of such a system would permit finer control of the temperature of the fuel salt in the primary loop. A cooling mechanism could be adjusted to remove heat from the valve at a specific rate, chosen such that a salt plug melts (thereby opening the valve) when the temperature in the region of the primary loop near the valve increases above a certain value. The degree of cooling needed has an approximately linear relationship to the temperature at which the valve will open, and can be determined via simulation or experimental means. When the valve opens, fuel salt from the primary loop drains into the auxiliary tank until the auxiliary tank is filled. The volume of fuel salt lost from the primary loop can be replenished by pumping make-up salt from an auxiliary tank. Make-up salt may be introduced to the primary loop using either a pump, or a gravity-feed mechanism coupled with a valve, or some combination of those methods. In one implementation, the make-up salt may be free of fissile and/or fissionable material, which would serve to dilute the fissile and fissionable material content in primary loop, ultimately decreasing the temperature in the primary loop. Alternatively or in addition to this implementation, the make-up salt may be at a temperature lower than the temperature of the fuel salt in the primary loop, and would therefore decrease the average temperature of the fuel salt in primary loop.

The drained fuel salt could be allowed to solidify in an auxiliary tank, or insulation and heating units could be used to keep the salt at a particular temperature. When the drained fuel salt is in liquid form, it can either be allowed to cool, or be kept molten, or pumped back into the primary loop.

This method could be extended to include multiple temperature-sensitive freeze valves. For example, the primary loop could also include a second temperature-sensitive freeze valve, whose cooling system was calibrated to allow the salt plug to melt at when the temperature of primary loop is at a temperature slightly higher than the temperature that induces salt plug to melt. For example, if the first valve opens when the temperature of primary loop is 5 degrees above the desired primary loop temperature, then the second valve could be set to open when the temperature of the primary loop is 10 degrees above the desired temperature. Having multiple temperature sensitive freeze valves, each set to melt as successively higher temperatures, allows for fine control of the temperature of the fuel salt in the primary loop, without draining all the fuel salt from the reactor.

In some implementations, the second valve could have a larger cross-sectional area than the valve, to permit more rapid flow into the auxiliary tank. It is possible to include more than two stages of temperature-controlled freeze valves, to allow further control of the temperature of the fuel salt in primary loop.

In all of these implementations, it is possible to directly trigger the opening of the by turning off their cooling units or by some other mechanism, regardless of system temperature. Direct opening of the valves could be used, for example, during a reactor shutdown scenario.

Moderator rods may extend through the separator plate, so that movement of the separator plate does not induce large changes in the ratio of fuel salt to moderator. Various materials may be used for these feedthroughs.

In a similar implementation, it is also possible to have multiple separator plates that may extend, for example, from any combination of the top, bottom, or sides of the reactor core 106.

In another implementation, it is possible to change the volume of the active region 1907 of the reactor core 106 by introducing solid material 1924 to the active region 1907 via portals in the reactor vessel 1902. The solid material 1924 would displace liquid fuel 103 from the active region 1907. In some implementation, a volume of liquid fuel 103 equal to the volume of the solid material 1924 could be removed from the primary loop 102 via valves 118 (used alone or in combination with pumps) into a holding tank 120. The holding tank 120 may contain any combination of insulation 1223, neutron reflectors 1922, or heating units 1224 to either prevent the liquid fuel from solidifying or permit rapid liquefaction of solidified fuel.

In one implementation, the solid material 1924 could consist of a corrosion-resistant, radiation-stable material with a melting point well above the melting point of the liquid fuel 103, such as solid or hollow blocks of Hastelloy, which would occupy volume in the active region 1907 without significant corrosion, radiation damage, or melting.

FIG. 20 shows a cross-section of the reactor core 106 including the active region 1907, passive region 1908, liquid fuel 103, filling material 1099, and separator plate 1914. In one implementation, the separator plate 1914 forms a sliding seal directly with the inner wall 2006 of the reactor core 106. In another implementation, a bearing ring 2001 provides an interface between the separator plate 1914 and the inner wall 206. In one implementation, the bearing ring 2001 consists of a sliding bearing comprised of a material with both good radiation resistance and good bearing properties (which may include a low coefficient of sliding friction), which may include any single material in the following list or combination of materials in the following list, or may include different materials: graphite, graphite embedded in a metal matrix (such as, for example, a bronze-copper matrix), CoNiInMoS2, WS2, Ti—TiN, Everlube 860, Vespel SP-1, Vespel Sp-3, Torlon 4301, APC-2/AS4, silicon carbide, AlPO4, Al2O3, or glass bonded mica.

A shielding ring 2002 may be included to reduce radiation damage to the bearing ring 2001. The shielding ring 2002 may be composed of a corrosion resistant material with good radiation shielding properties, such as silicon carbide. A composite material may also be used.

A tolerance gap 2007 may exist between the separator plate 1914 or bearing ring 2001 and the inner wall 2006 of the reactor core 106. A similar tolerance gap may be included between the shielding ring 2002 and the inner wall 2006, and/or the flow shaping unit 2003 and the inner wall 2006. The sizing of the tolerance gap 2007 may depend, in part on the relative tolerances of the reactor core 106, separator plate 1914, and bearing ring 2001, taking into account any volumetric changes that may occur in these components due to, for example, thermal expansion, radiation damage, or corrosion. A larger tolerance gap 2007 would allow for greater variability and uncertainty in component sizes, while a smaller tolerance gap would reduce the amount of material (specifically, in some cases, the liquid fuel 103 or filling material 1909) passing between the active region 1907 and passive region 1908.

Fluid transfer from the active region 1907 to the passive region 1908 can be reduced by lowering the velocity of the liquid fuel 103 normal to the separator plate 1914 in the region of the reactor core 106 close to the inner wall 2006. This velocity reduction may be accomplished by, in one implementation, including plate-mounted flow shaping plates 2003 affixed to the separator plate 1194. In another implementation, wall-mounted flow shaping plates 204 may be attached to the inner wall 2006 of the reactor core 106. The plate-mounted flow shaping plates 2003 and the wall-mounted flow shaping plates 2004 may be used together or separately, or the implementation could use neither.

FIG. 21 shows a cross-section of the reactor core 106 including the primary loop piping and extender pipe 1915.

Liquid fuel 103 may flow from the active region 1907, through the extender pipe 1915, and into the primary loop piping 1916. The outlet end of extender pipe 1915 may contain a pipe rim 2101. A corresponding vessel rim 2102 may also be included near or at the interface of the reactor vessel 106 and the primary loop piping. The pipe rim 2101, in conjunction with the vessel rim 2102, can serve to limits the total length of motion that can be made by extender pipe 1915 and separator plate 1914.

In one implementation, the pipe rim 2101 forms a sliding seal directly with the inner wall of the primary loop piping. In another implementation, a bearing ring 2103 provides an interface between the pipe rim 2101 and the inner wall of the primary loop piping. In one implementation, the bearing ring 2103 consists of a sliding bearing comprised of a material with both good radiation resistance and good bearing properties (which may include a low coefficient of sliding friction), which may include any single material in the following list or combination of materials in the following list, or may include different materials: graphite, graphite embedded in a metal matrix (such as, for example, a bronze-copper matrix), CoNiInMoS2, WS2, Ti—TiN, Everlube 860, Vespel SP-1, Vespel Sp-3, Torlon 4301, APC-2/AS4, silicon carbide, AlPO4, Al2O3, or glass bonded mica.

In one implementation, the vessel rim 2102 forms a sliding seal directly with the outer wall of the extender pipe 1915. In another implementation, a bearing ring 2104 provides an interface between the vessel rim 2102 and the outer wall. In one implementation, the bearing ring 2104 consists of a sliding bearing comprised of a material with both good radiation resistance and good bearing properties (which may include a low coefficient of sliding friction), which may include any single material in the following list or combination of materials in the following list, or may include different materials: graphite, graphite embedded in a metal matrix (such as, for example, a bronze-copper matrix), CoNiInMoS2, WS2, Ti—TiN, Everlube 860, Vespel SP-1, Vespel Sp-3, Torlon 4301, APC-2/AS4, silicon carbide, AlPO4, Al2O3, or glass bonded mica.

A tolerance gap may exist between the pipe rim 2101 or bearing ring 2103 and the inner wall of the primary loop piping 1916. Another tolerance gap may exist between the vessel rim 2102 or bearing ring 2104 and the outer wall of the extender pipe 1915. The sizing of the tolerance gaps may depend, in part, on the relative tolerances of the pipe rim 2101, vessel rim 2102, bearing ring 2103, bearing ring 2104, the inner wall of the primary loop piping, and the outer wall of the extender pipe 1915, taking into account any volumetric changes that may occur in these components due to, for example, thermal expansion, radiation damage, or corrosion. A larger tolerance gap would allow for greater variability and uncertainty in component sizes, while smaller tolerance gaps would reduce the amount of material (specifically, in some cases, the liquid fuel 103 or filling material 1909) passing among the primary loop piping, the inter-pipe cavity 2115, and the passive region 108.

The inter-pipe cavity 315 may be filled with an inter-pipe filling material, which may be the same as of distinct from filling material 1909. The inter-pipe cavity 2115 may be maintained at a pressure distinct from the pressure inside the primary loop piping and passive region 1908. Such a pressure differential may improve the bearing capabilities of the sliding seals. The pressure in the inter-pipe cavity 2115 may be maintained by a valve and pump that lead to a reservoir of the inter-pipe filling material. If the inter-pipe filling material is the same as the filling material 1909, then the pump may connect directly to the holding tank 120.

As mentioned earlier, in some implementations, a moderator material (e.g., zirconium hydride and others mentioned) may be incompatible with the fuel-salt mixture in the reactor core. In some implementations, a clad material can be used between the moderator material and the fuel-salt mixture. Graphite is compatible with some types of molten salt and is also a neutron moderator. The numerical simulations using zirconium hydride as a moderator material were modified and repeated with the faces on both sides of each zirconium hydride ring replaced with graphite. The numerical simulations used 1 cm graphite cladding on both sides of each zirconium hydride ring. As such, each ring was composed of 1 cm of graphite, 3 cm of zirconium hydride, and another 1 cm of graphite. The numerical simulation showed that this modification does not severely reduce reactivity. The multiplication factor for this modified system was 1.01, which is a reduction of 0.03 due to the addition of the graphite cladding.

In some cases, in which corrosion processes are slow, at least compared with some operational aspects of the nuclear reactor system 101, preventing contact between the fuel-salt mixture and a potentially incompatible moderator material can be accomplished with thin cladding (e.g., a few millimeters thick graphite cladding). In some implementations, materials such as silicon carbide crystals or SiC—SiC composites or combinations of them could be used.

In some implementations, cladding materials could have one or any combination of two or more of the following properties: resistance to corrosion in molten halide salts, low neutron cross sections, and ability to retain their mechanical and material integrity at the reactor's steady-state operating temperatures and pressures. It can be desirable to keep the cladding material as thin as possible, because a thinner layer of cladding material absorbs fewer neutrons. Depending on the material used, the cladding thickness will likely range from approximately one millimeter to one centimeter.

Molten salts can damage the mechanical and material integrity of many moderating materials, including metal hydrides, if they come into direct contact with these materials. It is therefore desirable to use a cladding to serve as a barrier between the moderator and the coolant. A satisfactory cladding material may possess the following properties: high thermal conductivity, resistance to cracking, yielding, bending, buckling, creep, wear, fretting, melting, dissolution, radiation damage (including radiation-induced volumetric changes), thermal or mechanical stress and/or shock, and any other processes that may affect its mechanical or material integrity.

Furthermore, such a cladding should be largely impenetrable to gases. In some scenarios, such as accident scenarios that result in a reactor temperature increase, the moderator material may release gaseous products. For example, a metal hydride moderator may release hydrogen via a dehydration process. A gas-impermeable cladding material could prevent these gasses from entering the reactor coolant. A gas-impermeable cladding material that additionally possessed good pressure vessel characteristics (such as a high yield stress and good resistance to hoop, radial, and axial stress) could be able to withstand pressure buildup due to gasses emitted by the moderator. The pressure maintained inside the cladding (a “back-pressure”) could serve to slow or limit further gas emission by the moderating material.

A gas-impermeable cladding material would further prevent gaseous fission products from diffusing into the moderating material. These gases, which include the fission product poison xenon-135, can adversely affect the reactor's neutronic spectrum. If these products diffuse into the moderator, they become significantly more difficult to remove from the reactor.

A range of ceramic composites satisfy all or most of the desirable characteristics for a moderator cladding material. In particular, some of the best-suited materials are layered ceramic composites that incorporate ceramic fibers to increase their yield strength. In this category, silicon carbide-silicon carbide fiber composites are well-characterized for their use in nuclear applications. They have been studied extensively for use as nuclear fuel cladding. For example, silicon carbide-silicon carbide composites are under investigation as a new fuel cladding and as a structural material in a variety of nuclear applications, including light water reactors (LWRs) and molten salt reactors (MSRs). The superior strength, radiation resistance, and neutron transparency of SiC, especially silicon carbide-silicon carbide composites (referred to herein as SiC triplex), may be the key to unlocking enhanced performance, higher safety margins, and lower corrosion of fuel cladding in LWRs. In addition, using SiC triplex to contain elements of MSRs, such as moderators, can help increase the maximum outlet temperature of these systems.

Silicon carbide exists in both alpha and beta crystalline phases, which undergo volumetric swelling at different rates when subjected to irradiation or temperature changes. Prior research has shown that a silicon carbide-silicon carbide fiber composite is more durable in a high-temperature radiation environment when the layers are made of the same phase of the material. Otherwise, the layers may separate as they expand at different rates, damaging the mechanical integrity of the cladding. In general, the beta phase of silicon carbide is more resistant to radiation damage than the alpha phase, and therefore the beta phase is preferred for cladding applications.

One long-term, materials-related issue that remains in using silicon carbide-silicon carbide composites is that of fission product attack, especially by noble metals such as palladium. In LWRs, this would occur from inside the fuel cladding, while in MSRs, this process would occur on the outside surfaces of any structures present in the MSR, as the fuel would be on the outside of such structures.

Zirconium carbide (ZrC) has been investigated as a possible replacement for SiC in high temperature gas reactor fuel kernels, referred to as Tristructural-Isotropic (TRISO) particles, which incorporate a thin SiC layer as the ultimate fission product barrier. However, studies have shown that noble metals produced during fission, especially palladium, react with SiC at high temperatures, forming Pd—Si intermetallic phases that melt at temperatures as low as 900° C. Parallel studies of Pd corrosion of SiC and ZrC have shown that SiC rapidly develops Pd—Si intermetallic phases, with increasing speed on grain boundaries, while ZrC forms no Pd—Zr intermetallic phases (as detected by x-ray diffraction, XRD).

Some reactor implementations are contemplated based on a new type of composite with the same superior mechanical and neutronic properties as SiC triplex.. A silicon carbide-silicon carbide-ZrC (SSZ) composite is proposed to replace the SiC triplex composites currently under development. In MSR implementations, the SSZ composites will incorporate ZrC on the outer surface. The SSZ system will therefore consist of a SiC monolithic inner diameter, surrounded by bound SiC fibers in an SiC matrix, all clad within a monolithic layer of ZrC. As zirconium is highly transparent to neutrons, the SSZ system represents a way to avoid the problem of corrosion of SiC triplex by noble metal fission products, while not noticeably affecting thermal transport or neutronic properties of the system.

Prototypical SSZ composites will be manufactured In the U.S. and in accordance with all appropriate safety regulations, in partnership with CTP Technologies, Inc, using their existing manufacturing process, alongside similar SiC triplex composites. The composites will be tested for corrosion with various noble metal fission products (Pd, Pt, Ag) known to interact with SiC. These metals will be sputtered on the surface of the composites to ensure a fully dense, sound microstructural bond. Analysis will consist of optical and backscattered electron microscopy (to determine corrosion depth and mechanisms), XRD (to detect the presence of any brittle or low melting point intermetallics), and post-corrosion four point compression tests (to test compressive strength).

The silicon carbide (or other cladding materials) should have a high enough purity to not adversely affect its mechanical or material properties, or the neutronics of the reactor. A variety of methods known to the art, such as neutron activation analysis or X-ray diffraction, may be used to determine the purity of the silicon carbide and/or other cladding materials.

FIG. 13 is a cross-sectional schematic showing the cladding 1301 surrounding the moderator 1307. In the illustrated implementation, the cladding 1301 is composed of three layers: a low-porosity inner layer 1304, a fiber-matrix layer 1303, and a low-porosity outer layer 1302. In other implementations, the cladding 1301 may consist of any combination of one or more of these layers (e.g., a fiber-matrix layer 1302 and low-porosity outer layer 1302, without inclusion of a low-porosity inner layer 1304). In some implementations, the inner layer 1304 is composed of stoichiometric beta-phase silicon carbide. The inner layer 1304 may be produced using the chemical vapor deposition method (CVD), or any other suitable technique (potentially including sintering, sputtering, electrolysis/electroplating, physical and physical-chemical vapor deposition, thermal decomposition or pyrolysis, or formed in situ during the silicon carbide production process) in some cases described in the references listed below. CVD is capable of generating low-porosity beta phase silicon carbide, however references to CVD below could alternately employ these other methods. A sintering process may be less desirable, because the sintering process can result in undesirably high levels in the material, and the sintering process tends to result in higher-porosity (and therefore less desirable) silicon carbide.

The inner layer 1304 may be deposited directly on a pre-formed section of ceramic fiber. Alternatively, the silicon carbide could be deposited directly (using CVD or some alternative technique) onto the moderator material. A gap 1305 may exist between the moderator 1307 and the cladding 1301. Gaps at the interfaces between different types of materials, for example, may be used to protect against damage caused by differential swelling or shrinkage. In some implementations, the gaps could be filled with an inert gas, e.g., helium, to reduce chemical interactions between the materials.

In some implementations, the backfill gas could be introduced at a certain pressure, and the cladding could incorporate a radiation-hardened pressure sensor or indicator. Damage to the moderator or cladding could be signaled by the pressure sensor or indicator if a significant change in the pressure inside the cladding occurs.

The fiber-matrix layer 1303 improves the cladding's ability to resist internal pressure. Specifically, the wrapped fibers in the fiber-matrix layer can withstand greater tension than a solid block of silicon carbide. In some implementations, silicon carbide fibers in the beta phase are wrapped around the low-porosity inner layer 1304 in such a way as to provide adequate resistance to radial, axial, and hoop stress. Such wrapping patterns are described in the references listed below.

Pre-stressing the ceramic fibers in the fiber-matrix layer makes them more resistant to internal pressure—it increases the likelihood that the fiber-matrix layer bears a greater share of the load as the system is being stressed, rather than having all the stress be borne by the more brittle low-porosity layers 1302 and 1304. The fiber layer may be coated with a layer of a material such as pyrolytic carbon (a thin layer, potentially tens to hundreds of nanometers in thickness) to facilitate pre-stressing the system by allowing the fibers to slip against one another during pre-loading. An additional layer of silicon carbon may then be applied to the layer to prevent damage to the carbon due to reduction-oxidation reactions. A thicker layer of silicon carbide may then be applied to the fiber-matrix layer 1303 using chemical vapor infiltration, polymer infiltration and pyrolysis, or a combination of these methods. Post-treatment analysis and processes as described in the references listed below can be used to ensure than a sufficient fraction of the layer is in the beta phase.

The low-porosity outer layer 1302 may be deposited using CVD or an alternative technique directly onto the fiber-matrix layer 1303. The low-porosity outer layer 1302 may be given whatever surface finish is desirable for a particular application. For example, it may be desirable to give it a surface treatment to promote either laminar or turbulent flow of the fluid interfacing with the surface of the low-porosity outer layer 1302.

The low-porosity inner and outer layers 1302 and 1304 can have a different stiffness from the fiber-matrix layer 1303. It is therefore desirable, in some implementations, to make the fiber-matrix layer thicker than the low-porosity inner and outer layers 1302 and 1304, such that the hoop stress is shared evenly across the layers and reduce the likelihood of cracking.

In alternative implementations, any combination of the low-porosity inner and outer layers 1302 and 1304 and the fiber matrix layer 1303 may be composed of a carbide other than silicon carbide, such as titanium carbide, zirconium carbide, or ternary titanium silicon carbide. Alternatively, this cladding could be made of graphite. Alternatively, combinations of these materials (such as silicon carbide and titanium carbide) may be applied either as a mixture or in alternating layers. Such materials may have better heat transfer properties following irradiation. Such improved heat transfer properties may be desirable based on the type of moderator 1307 contained within the cladding: some moderators may experience gamma heating or may produce heat via some other mechanism, and this heat must be transported out of the moderator, through the cladding, and into the coolant to prevent undesirable heating of the moderator.

It is also possible to use this cladding material in conjunction with pebble, plate, or prism fuel. Cross sections of two potential configurations of pebble fuel are shown in FIGS. 13b and 13c. FIG. 13b shows an implementation in which fuel kernels are embedded in a moderator matrix. In some implementations, this moderator matrix is zirconium hydride. FIG. 13c shows an implementation in which fuel kernels and moderator kernels are embedded in a matrix. In some implementations, the moderator kernels are made of zirconium hydride, and the matrix material is graphite. Both implementations described in FIGS. 13b and 13c have a number of available variations. The fuel kernels and moderator kernels themselves could be coated with a layer or multiple layers of graphite, silicon carbide, or other materials. The pebble itself could be coated with layers of graphite, silicon carbide, or other materials, as described in other sections of this document. The pebble and kernel coatings could be designed to decompose at a given temperature and/or pressure, as described in other sections of this document. The density of fuel, moderator, matrix material, or cladding thickness could be made to vary radially throughout the pebble. This radial variation could be used to achieve, for example, a flatter temperature profile within the pebble. In some implementations, a multi-stage heating and sintering process could be used to achieve variable kernel density throughout the pebble. Other processes may also be used. In some implementations, the relative densities of fuel, moderator, matrix, and cladding are selected to specify the pebbles' buoyancy with respect to the salt. For example, the buoyancy could be adjusted so that the pebbles do not float in the salt.

In an alternative implementation, the kernels and matrix could be in the form of plates. In some implementations, fuel kernels are embedded in a moderator matrix. In some implementations, this moderator matrix is zirconium hydride. In some implementations, fuel kernels and moderator kernels are embedded in a matrix. In some implementations, the moderator kernels are made of zirconium hydride, and the matrix material is graphite. Both implementations for plate fuel have a number of available variations. The fuel kernels and moderator kernels themselves could be coated with a layer or multiple layers of graphite, silicon carbide, or other materials. The plate itself could be coated with layers of graphite, silicon carbide, or other materials, as described in other sections of this document. The plate and kernel coatings could be designed to decompose at a given temperature and/or pressure, as described in other sections of this document. The density of fuel, moderator, matrix material, or cladding thickness could be made to vary throughout the plate—for example, the edges of the plate could have a higher fuel concentration than the center of the plate. This variation could be used to achieve, for example, a flatter temperature profile within the plate. In some implementations, a multi-stage heating and sintering process could be used to achieve variable kernel density throughout the plate. Other processes may also be used. In some implementations, the relative densities of fuel, moderator, matrix, and cladding are selected to specify the plates' buoyancy with respect to the salt. For example, the buoyancy could be adjusted so that the plates do not float in the salt.

In some implementations, shown in FIG. 13d, prismatic fuel could be implemented. In such an implementation, the kernels and matrix could be in the form of solid or annular cylinders. In some implementations, fuel kernels are embedded in a moderator matrix. In some implementations, this moderator matrix is zirconium hydride. In some implementations, fuel kernels and moderator kernels are embedded in a matrix. In some implementations, the moderator kernels are made of zirconium hydride, and the matrix material is graphite. Both implementations for prismatic fuel have a number of available variations. The fuel kernels and moderator kernels themselves could be coated with a layer or multiple layers of graphite, silicon carbide, or other materials. The cylinder itself could be coated with layers of graphite, silicon carbide, or other materials, as described in other sections of this document. The cylinder and kernel coatings could be designed to decompose at a given temperature and/or pressure, as described in other sections of this document. The density of fuel, moderator, matrix material, or cladding thickness could be made to vary throughout the cylinder—for example, the edges of the plate could have a higher fuel concentration than the center of the plate. Alternatively or in addition to this, cylinders at different locations within the prismatic block could have varying fuel, moderator, or matrix densities. These variations could be used to achieve, for example, a flatter temperature profile within the cylinder or prismatic block. In some implementations, a multi-stage heating and sintering process could be used to achieve variable kernel density throughout the cylinder. Other processes may also be used. In some implementations, the relative densities of fuel, moderator, matrix, and cladding are selected to specify the cylinders' buoyancy with respect to the salt. For example, the buoyancy could be adjusted so that the cylinders do not float in the salt.

The cylinders may be contained in prismatic blocks. These blocks may have holes drilled through them to form channels in which the cylinders may be inserted. Other channels may be used to contain additional moderating rods and/or coolant. The relative spacing of the moderator, coolant, and fuel rods may be adjusted. In some implementations, the moderating rods could be made out of pure zirconium hydride or zirconium hydride kernels embedded in a graphite matrix. These moderating rods could be clad with a solid material or a laminate, as describes elsewhere in this document. The prismatic block may be made of graphite, zirconium hydride, or zirconium hydride kernels embedded in graphite. The moderator kernels themselves could be coated with a layer or multiple layers of graphite, silicon carbide, or other materials. The prismatic block could be coated with layers of graphite, silicon carbide, or other materials, as described in other sections of this document. The prism and kernel coatings could be designed to decompose at a given temperature and/or pressure, as described in other sections of this document. The moderator density throughout the prism could be made to vary in order to, for example, achieve a more desirable neutronics or temperature spectrum. In some implementations, a multi-stage heating and sintering process could be used to achieve variable kernel density throughout the cylinder. Other processes may also be used. In some implementations, the relative densities of fuel, moderator, matrix, and cladding are selected to specify the prisms' buoyancy with respect to the salt. For example, the buoyancy could be adjusted so that the prisms do not float in the salt.

Any zirconium hydride, graphite, silicon carbide, or other material used in these applications could be post processed by a method such as sanding, sandblasting, milling, turning on a lathe, hot-pressing or cold-pressing could also be used to achieve desired surface effects. These effects could include varying the surface roughness to achieve either a laminar or a turbulent flow regime. The zirconium hydride could be post processed to remove, for example, surface flaking or other undesirable surface effects. It could be further annealed to, for example, vary its hydration.

The fuel, moderator, and/or cladding could be formed in an involute shape.

In some implementations, the cladding could be formed of a metallic material such as zirconium or an alloy like Hastelloy that contains a large amount of nickel. This metallic material may be a composite contain reinforcing fibers made out of a ceramic such as silicon carbide. The metallic material could be manufactured initially as rolls of thin foil, which could then be wrapped around the moderator material, and then sealed using end caps, plugs, melting or crimping the foil ends, or some other technique. The material used to form the end caps or plugs would not have adverse effects on the neutronics of the reactor (if they are located close to the edges of the reactor vessel) and therefore there is greater leeway in closing the material used in these caps or plugs. Alternatively, the metal or metal composite may be applied using a sputtering process. The cladding could consist of successive layers of ceramic and metal, or the cladding could have regions consisting entirely of metal and regions consisting entirely of ceramic.

Several design factors influence the choice of cladding thickness. The cladding should be thin enough to not absorb significant numbers of neutrons, but thick enough to withstand applied stresses (from, e.g., the pressure induced by the gas in the moderator, and other thermal or physical shocks) and corrosion. An appropriate range of thickness may be on the order of 2 millimeters to 2 centimeters.

The cladding can be formed in a variety of shapes. In some implementations, CVD may be used to produce small low-porosity units, which may then be joined together using a process such as microwave joining. The joined pieces may then be wrapped with ceramic fiber as described previously. Protrusions may be incorporated into the outer layer 102 to reduce fretting and wear of the cladding.

FIG. 14 is a flow chart describing a process for assembling and inspecting the cladding and moderator units. FIG. 15 shows a potential configuration for the different layers comprising the cladding and moderator units. Cladding layers may be formed in an additive and/or subtractive process. In some implementations, the moderator is provided as a base material and each subsequent layer is provided, assembled or formed sequentially from the base to the outer layer. In some implementations, the moderator and the cladding are produced separately and subsequently assembled. In a specific implementation, each layer of the moderator is produced as a tube of varying diameters and thicknesses. The tubes are then cut to length and assembled with the moderator in the center and inserted into progressively wider tubes providing the additional layers. The tubes are plugged (references to plugs herein should be considered to apply as well to caps and lids and may be wider, narrower, or the same inner or outer width as the tube to be sealed). The assembly process may comprise a pre- or post-annealing step, an inter-layer adhesive, a crimp step, and/or a gas-filling or pressurization step.

The tubes may or may not be circular in inner or outer dimension. The tubes may be colored, marked, bar-coded or labeled. For example, a permanent bar code may be provided on the tube by subtractive means.

The tubes may have inner or outer grooves or slots for physical reinforcement or to ensure assembly in a preferred orientation, or designed to aid in the placement and identification of tubes in the reactor.

The moderator-cladding assembly or subassemblies may also include means of positioning the elements and of aiding assembly. FIG. 16 shows one such implementation. In some implementations, the plug comprises physical grooves or raised regions meant to guide or arrange the internal layers. The moderator pin may be assembled by cutting an outermost or sacrificial tube, providing a plug at one end, and then inserting one or more inner layer tubes, which may be positioned in part through mechanical guiding means on the plug. The inserted tubes may be pre-cut or may be subsequently cut one at a time or in some combination. An outer sacrificial tube (such as a fiberglass or cardboard tube) may also comprise markings designed to aid assembly and may be used to protect the tube during production and/or shipment.

The various tubes and plugs may comprise narrowed, threaded, grooved, and/or slotted regions. Such regions could aid assembly, physically stabilize the layers, provide stabilization against thermal shock. Such features could be angled, notched, serrated or otherwise varied to provide varying levels of mechanical resistance. The plug may include means to facilitate insertion or to impeding extraction. The plug may be inflatable, elastomeric, or mechanically expandable. In one design, the plug comprises a slot or handle which expands the plug diameter when turned. Such an expander could be ratcheted so that it cannot later collapse. The tube receiving the plug may be grooved or have a raised portion on its inner or outer surface to receive or reinforce a portion of the cap or plug.

The plug may comprise a hook, ring, inner grooved post or other means suitable to allow an overhead crane to raise and lower the moderator assembly, facilitating insertion, removal and inspection. The plug and/or tubes may have mechanical features designed to allow installation into the reactor and/or to bracing or brackets provided within the reactor or as part of the reactor wall.

The plug may comprise a valve to facilitate gas-filling or pressurization of the moderator assembly.

A tube may have a narrowed end, the narrowing may be formed into the tube material or provided by an inner subtube.

The plug may comprise a material with a higher coefficient of thermal expansion that the tube. The plug may then be easily inserted while the tube cooled below ambient temperature.

In some implementations, on at least one end of the moderator assembly, a plug is inserted to a specified depth into a tube. The reactor is designed so that the depth of the plug in the moderator can be inspected. In some implementations, the depth of the plug may be inspected during operation. For example, the tube may be marked in centimeters and the depth of the tube readable by visual inspection, possibly through a side hole or slit in the tube. In a further example, a light, ultrasonic or electromagnetic source may be reflected from the end of the plug and its distance measured.

In some implementations, an outer tube is extended past the plug and the moderator assemblies are seated on pegs. The pegs position the tubes within the reactor. In a further implementation, the tube sits loosely on the peg and the plug is seated on or above the peg. In the event that the plug is pushed toward the end of the tube, it presses against the peg and causes the entire moderator assembly to lift. The moderator assembly could then be identified from above by its raised position and then lifted out and replaced if necessary prior to failure of the plug.

In some implementations, the moderator assembly is provided with a plug that moves in response to the expansion of the moderator, the release of gas by the moderator, or the expansion of a filler liquid, gas or solid material which is not a moderator but which is provided within the moderator assembly and moves responsive to the condition of the reactor or moderator. The motion of the plug is used to assess the status of the moderator.

In some implementations, the plug is formed at least in part from materials that yield or melt at temperatures higher than the operating temperature of the reactor, but lower than the danger temperature of the reactor. If the reactor grows hotter than a safe threshold, the plugs then fail and allow molten salt to enter the tube and affect the moderator material, thus reducing or stopping the action of the moderator. The plug may comprise a sacrificial means designed to break or melt above a certain temperature.

In some implementations, a material is provided between the plug and end of at least one layer of cladding and/or the end of the moderator. The material expands responsive to heat. The moderator assembly is calibrated so that an out-of-condition temperature which is high enough will push the plug out of the tube.

The plug may comprise a spring-based pop-up indicator system responsive to heat or pressure. However as springs are subject to radioactive embrittlement, in a preferred system the physical motion is provided by a metal or other material with a high coefficient of thermal expansion. Reference: http://home.howstuffworks.com/pop-up-timer1.htm

FIG. 17 shows an approach to crimping the tube. The tubes may be sealed by methods known in the art of canning An airtight seal may be provided by a double-seaming operation. The plugging process may comprise flanging, curling, counter-sinking or die-cutting. A rubber or elastomeric material or a post-sealing sealant may be used to enhance gas impermeability at higher temperatures and pressures. Reference: http://www.servinghistory.com/topics/canning::sub::Double Seams

Following production, the cladding and moderator may be inspected using a variety of techniques to ensure that they possess the desired properties (such as pressure of gas in the gap, hydrogen content, zirconium content, silicon content, carbon content, other ceramic content, trace element or impurity content, phases of the materials present, geometry, and presence of cracking or other damage). These techniques may include x-ray diffraction, neutron activation analysis, pressure sensors, ultrasound, measuring electrical resistance, or other methods.

When packaging and shipping the cladding and/or moderator, care should be taken to not subject the materials to extremes of temperature or pressure, or to subject them to corrosive environments. They should be packaged so as to reduce or minimize thermal and/or mechanical stress on the components. Additional inspection steps may be performed at the receiving site, to ensure that the materials possess the desired properties (such as pressure of gas in the gap, hydrogen content, zirconium content, silicon content, carbon content, other ceramic content, trace element or impurity content, phases of the materials present, geometry, and presence of cracking or other damage). These techniques may include x-ray diffraction, neutron activation analysis, pressure sensors, ultrasound, measuring electrical resistance, or other methods.

The cladding and/or moderator material may be doped with other isotopes that may be used to trace potentially diverted materials. Alternatively, the cladding or moderator may be doped with burnable poisons such as boron, or the cladding or moderator may be doped with other materials.

The low-porosity outer layers of the cladding serve to keep outgassed moderator products inside the cladding, and build up back-pressure to prevent further gas release during an accident scenario that results in increased moderator temperature.

It is desirable, in some implementations, to use thin cladding walls or to incorporate one or more sacrificial regions of the cladding that fail when the internal pressure in the cladding rises above a certain value. In some implementations, the moderator contained within such a cladding may be a metal hydride such as zirconium hydride, and the coolant surrounding the moderator may be a molten fluoride salt. In such as implementation, if the cladding fails, the zirconium hydride would decompose into the fluoride salt, and would therefore no longer provide moderation to the neutrons in the reactor. This would decrease the reactivity of the reactor, thereby decreasing the reactor temperature and potentially reducing the severity of the accident. The reactor system may be designed to have systems in place to remove the HF gas, metallic fluorides, or other products that are generated when the moderator decomposes into the coolant. The molten salt, cladding, moderator and reactor geometry may be selected and arranged so that an accident condition will accelerate the destruction or failure of the cladding and the impairment or decomposition of the moderator, thus enhancing safety. In an implementation, the clad moderator and the reactor are designed so that a physical collapse of the reactor would tend to break the cladding and enhance safety. The reactor may comprise a safety mechanism which causes destruction of the cladding by operator action through any suitable means, possible including crushing, piercing, slicing, explosive, optoelectronic or sonic means. For example, the reactor may provide ports through which a laser could strike the cladding and accelerate its failure.

FIG. 18 is a schematic showing a fiber wrapping pattern in the cladding 1301 that incorporates sacrificial regions. The sacrificial region may be produced by varying the position of the wrapping fibers 1802 to leave regions with a lower density of wrapping fibers. These low-density regions 1804 would fail at lower stress than the normal-density regions 1803. Alternatively, the wrapping at the sacrificial regions could be made of a weaker type of ceramic fiber.

In some implementations, the sacrificial region could have a thinner low-porosity inner layer 1302, fiber-matrix layer 1303, or outer layer 1304, or contain just one of these layers, or some combination of these and the previously described methods.

The sacrificial regions may be positioned such that the cladding 1301 fails by rupture either axially, radially, in a spiral pattern, via the previously-describes methods, some other method, or in a combination of these and other methods.

The reactor cores of some nuclear reactor systems use graphite as a moderator. A graphite moderator may also be clad with silicon carbide or a silicon carbide composite. In some implementations, the reactor core may use a moderator material that has a higher moderating effectiveness than does graphite alone.

In some implementations, a form of zirconium hydride (e.g., ZrH_{1.6}) can be used as a moderator in the reactor core instead of, or in some implementations in addition to, graphite. ZrH_{1.6} is a crystalline form of zirconium hydride, with face-centered cubic symmetry. There are other phases of zirconium hydride (ZrHₓ, where x can range from 1 to 4) and the physical properties of zirconium hydride vary among the other phases. In some implementations, the zirconium hydride moderator could be in the form of a solid single crystal. In some implementations, a powdered form of zirconium hydride, comprising smaller crystals could be used. In some implementations, smaller crystals could be formed into solid shapes (using, for example, one or any combination of the following processes: sintering the crystals, binding the crystals together using a binder such as coal tar, CVD, or other processes known to the art).

Zirconium hydride has a greater moderating ability than graphite because it has a high density of hydrogen nuclei. The hydrogen nuclei in zirconium hydride are approximately 12 times lighter than the carbon nuclei in graphite. A neutron typically requires fewer collisions with zirconium hydride to reach thermal energies than it does with graphite. In some implementations, using zirconium hydride rather than graphite alone in the reactor core 106 can increase the number of neutrons in the epithermal and thermal energy ranges.

The use of zirconium hydride as a moderator can also provide the benefit of increasing the rate at which U-238 is transmuted into Pu-239. This increase can allow the nuclear reactor system to operate as a so-called converter reactor by producing fissile Pu-239 at the same or substantially the same rate as fissile and fissionable actinides are consumed. Although minor actinides—e.g., actinide elements other than uranium or plutonium—are more easily fissioned with fast neutrons, they can still be fissioned in such implementations using the neutron spectrum that would be present in the reactor core.

Other types of moderators individually and in combination can be used as a moderator in the stationary reactor core, or in the movable moderating elements, or in both of them. For example, any suitable combinations of any two or more of graphite, zirconium hydride, zirconium deuteride, or other moderator materials can be used.

In some implementations, the moderator material has a high density of light atomic nuclei (e.g., hydrogen, deuterium, lithium, etc., individually or in any combinations of any two or more of them). The concentration of hydrogen in ZrH is, in some implementation, 1.6 hydrogen atoms per zirconium atom. Additional or other materials, or combinations of them, with similar or higher densities of hydrogen can be used as a moderator material. Other moderator materials may include any of the following individually or in any combination: other metal hydrides, metal deuterides, and low atomic mass materials in solid form (e.g. solid lithium). In some implementations, zirconium deuteride may be more effective than zirconium hydride because deuterium has a much smaller neutron absorption cross section than hydrogen. Specifically, our computer simulations show the following materials to be effective moderators in our reactor core design: zirconium hydride (ZrH_{1.6} and ZrH₂), yttrium(II) hydride (YH₂), yttrium(III) hydride (YH₃), and lithium hydride (LiH). Those materials could be used individually or in any combination of two or more of them.

In some implementations, the level of reactivity in the reactor core can be controlled using one or more movable moderating elements, for example moderator rods. The moderating elements can alter the thermal and epithermal neutron spectra by being inserted into and removed from the reactor core 106. In some implementations, these moderating materials may be in the form of rods, blocks, plates, or other configurations, used individually or in any combination. These are described below as rods for convenience but could be on any suitable form.

The moderating rods can be made of zirconium hydride, zirconium deuteride, graphite, used individually, or any other suitable material or combination of materials. The rods may be of a wide variety of shapes, sizes, and configurations, and can have a wide variety of approaches for their insertion into and removal from the reactor core.

In the context of reactivity control, in some implementations, a moderating rod can mean an element made of moderating material that can be inserted or withdrawn from the reactor core. In some implementations, the moderator rods can be movable relative to the reactor core vessel so that the moderator rods can be fully or partially withdrawn from the reactor core. In some examples, the nuclear reactor system is subcritical when the moderator rods are partially or fully withdrawn from the reactor core. Reactivity is increased by partially or fully inserting moderator rods until the reactor becomes critical. The reactor can be shut down by withdrawing the moderator rods.

In some implementations, the use of zirconium hydride (and possibly other hydrides and deuterides) as a moderator material can allow the nuclear reactor system to operate entirely on spent nuclear fuel. In some implementations, the use of such materials can allow the nuclear reactor system to operate partially on spent nuclear fuel. In some implementations, zirconium hydride could be used to make, for example, a more efficient thorium molten salt reactor. In some implementations, the use of zirconium hydride could make a thorium molten salt reactor more neutronically efficient because the moderating effectiveness of zirconium hydride is greater than that of graphite. The use of zirconium hydride in a thorium reactor—a reactor that transmutes thorium into fissile U-233—could reduce the required amount of fuel, could improve fuel utilization, could reduce the required size of the reactor core, or could achieve a combination of them.

Alternatively or in addition to movable moderating elements, movable control rods can be used in reactor core 106 in some instances. Control rods can remove neutrons from the system by capturing neutrons that are incident upon them. For example, control rods that are used on solid-fuel reactors, or other types of control rods, or combinations of them, can be used. Reactivity can be increased by withdrawing the control rods from the reactor core. Reactivity can be decreased by inserting the control rods in the reactor core. These control rods may also be protected by a ceramic or ceramic laminate cladding.

Additional changes may be made to the moderator material itself, to either promote or discourage the release of gasses at high temperatures. Zirconium hydride, for example, can be manufactured with a hydrogen-to-zirconium ratio from approximately 0 to 4. The type of zirconium hydride best-suited for use as a moderator is in the delta phase with a hydrogen-to-zirconium ratio ranging from approximately 1.5 to 1.7. A lower hydrogen-to-zirconium ratio decreases the rate of hydrogen outgassing, while a higher ratio increases the rate of hydrogen outgassing. The precise ratio of hydrogen to zirconium (which may be specified during the manufacturing process) can be chosen to either promote or discourage the dehydration of the material at a given combination of temperature and pressure.

The moderating material may take different forms within the reactor core, or within a given moderator pin. For example, the moderator located closer to the edge of the pin or the edge of the reactor core may have a higher hydrogen content than the moderator located in the center of the pin or the center of the core. The spatial variation of the different varieties of moderator could be chosen to vary the neutron profile within the reactor. Several processing steps (such as applying a hydrogen stream to zirconium under pressure and temperature) may be used to generate metal hydrides with varying hydrogen content. Moderating material may be shuffled throughout the reactor according to a fixed schedule. The timing of this schedule may vary according to the amount of hydrogen present in the moderating material.

In some implementations, damage to the cladding of moderator may be reduced or minimized by replacing the cladding and/or moderator according to a set schedule, in which the materials are not left inside the reactor long enough to be at a significant statistical risk of incurring damage. Alternatively or in addition to this technique, damage to the cladding or moderator could be detected by using a variety of instrumentation, such as measuring the resistivity of the materials or monitoring the salt for significant traces of cladding or moderator materials, to determine whether damage has occurred. In other implementations, a backfill gas present in the gap between the moderator and the cladding could be introduced at a certain pressure, and the cladding could incorporate a radiation-hardened pressure sensor. Damage to the moderator or cladding could be signaled by the pressure sensor if a significant change in the pressure inside the cladding occurs.

In some implementations, it may be possible to hold a section of cladding in place, and continuously (or near-continuously) feed moderator through the tube. Alternatively, small section of moderator encased in cladding may be continuously (or near-continuously) fed through the reactor.

Following removal from the reactor, the cladding and moderator materials may be stored or transported in any receptacle suitable for intermediate-level or high-level nuclear waste. When transporting the used cladding and/or moderator, care should be taken to not subject the materials to extremes of temperature or pressure, or to subject them to corrosive environments. They should be packaged so as to reduce or minimize thermal and/or mechanical stress on the components. If desired, the materials used in the moderators and cladding could be reclaimed by a variety of pyrochemical, aqueous, or electrorefining processes. Alternatively, if the cladding remains intact, the moderating material could be removed from the cladding, reprocessed, and put back into the previously-used cladding or new cladding. Suitable tooling (that is some combination of: radiation-hardened, controllable, and able to manipulate the pins without damaging them) may be used to insert and remove the cladding and moderator to and from the reactor.

To illustrate the differences in the neutron energy spectrum caused by using zirconium hydride as a moderator instead of graphite, the same numerical simulation was repeated using graphite rings instead of zirconium hydride rings. FIG. 4 is a diagram 400 showing plots of the simulated neutron energy spectra in the two different reactor cores. The plot labeled “ZrH1.6 Rings” 402 in the diagram 400 is based on numerical simulations of the reactor core configuration shown in FIG. 2, which includes zirconium hydride moderator material. The plot labeled “Graphite Rings” 404 in the diagram 400 is based on numerical simulations of the reactor core configuration shown in FIG. 2, with graphite moderator material substituted for the zirconium hydride moderator material shown in FIG. 2. The plots shown in the diagram 400 are the full-core neutron energy spectra for both numerical simulations. The total neutron flux was normalized to 1×10¹⁵ n/cm²-s in both numerical simulations.

A comparison of the plots shown in the diagram 400 illustrates, by way of example, some of the advantages of using zirconium hydride as a moderator. As shown in the diagram 400, the numerical simulations indicate that use of zirconium hydride moderator material resulted in approximately ten times more neutrons in the thermal range than in a graphite moderated system. According to the numerical simulations, the multiplication factor for the graphite moderated system was 0.358, which is significantly below criticality, whereas the multiplication factor for the zirconium hydride moderated system was 1.043, which is above criticality.

The reactor core design used in the numerical simulations illustrates, by way of example, some performance aspects of zirconium hydride as a moderator material. These performance aspects, or additional or different operational parameters, can be achieved by using other reactor core designs. In various implementations, there are almost limitless ways to arrange the materials (e.g., the hydride or deuteride moderator, fuel-salt mixture, and Hastelloy vessel).

One design parameter for achieving a critical reactor is the fuel-to-moderator ratio, expressed as a ratio of the volume of the fuel to the volume of the moderator, which is independent of the geometric arrangement of materials. An optimal, improved, or otherwise preferred fuel-to-moderator ratio value could potentially be identified, and such a value may guide the overall core design.

The six-factor formula (equation 1.3) describes the factors used to determine the reactivity (and therefore the criticality) of a nuclear reactor system.

k=ηfpεP_{FNL}P_{TNL} [1.3]

In equation 1.3, k is termed the “neutron multiplication factor” and may also be defined as the number of neutrons in one generation divided by the number of neutrons in the preceding generation. 11 is termed the “reproduction factor” and is defined as the number of neutrons produced by fission per absorption event in the fuel. f is termed the “thermal utilization factor” and is defined as the probability that, for a given neutron absorption event, the neutron absorption occurs in the actinide material. p is termed the “resonance escape probability” and is defined as the fraction of fission neutrons that make the energy transition from fast to thermal without being absorbed. 8 is termed the “fast fission factor” and is defined as the ratio of the total number of fission neutrons divided by the number of fission neutrons produced by thermal fissions. P_{FNL} is termed the “fast non-leakage probability” and is defined as the probability that a fast neutron will not leak out of the system. P_{TNL} is termed the “thermal non-leakage probability” and is defined as the probability that a thermal neutron will not leak out of the system. In general, systems with a high surface area to volume ratio have higher P_{FNL} and P_{TNL}.

If k is less than 1, the system is defined as subcritical. A subcritical system cannot sustain a nuclear reaction. If k equals 1, the system is defined as critical. A critical system is in a steady state, and the number of neutrons produced exactly equals the number of neutrons lost. If k is greater than 1, the system is defined as supercritical. In a supercritical system, the number of neutrons produced by fission events increases exponentially.

The reactivity, ρ, of a nuclear reactor is defined as the reactor's divergence from a critical state, and is given by equation 1.4.

ρ=(k−1)/k [1.4]

FIGS. 1, 2, 5, 6, 7, 8, and 9 show possible reactor core configurations and features for various implementations. A wide variety of these and other reactor core configurations and features, and combinations of them, can be used.

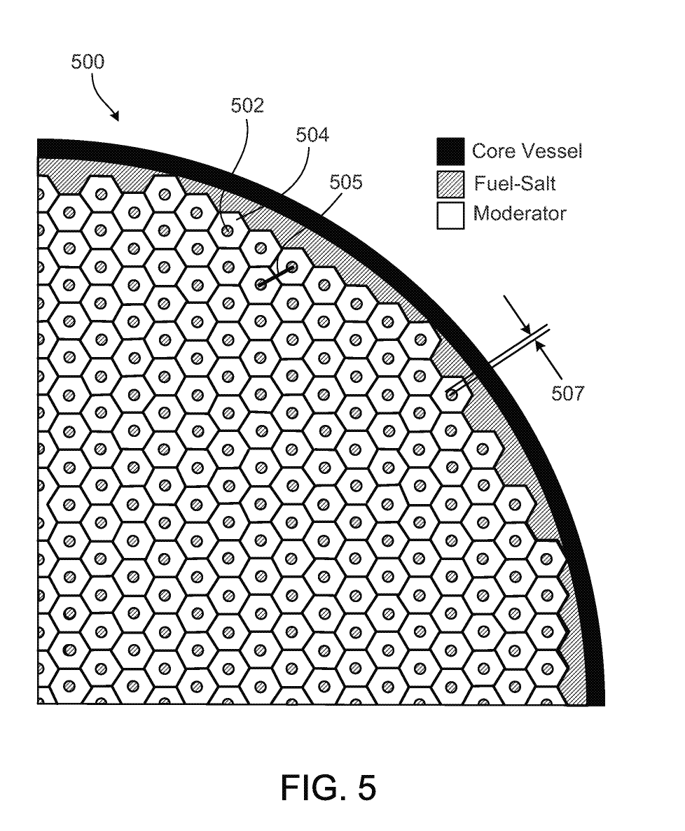

FIG. 5 is a cross-sectional view of an example prism configuration 500 for a reactor core. In some implementations of the prism configuration, the fuel-salt mixture flows (perpendicularly to the plane of the paper) through tubular channels 502 in either hexagonal blocks, square blocks, triangular blocks, or other-shaped blocks 504 (or combinations of any two of them) of moderating material.

An example of a prism core configuration 500 with a channel pitch 505—the distance between the center of one channel and the center of an adjacent channel—of 1.26 cm, a channel radius of 0.500 cm 507, and a length of 300 cm was modeled with SCALE. The multiplication factor, k, for this system was 1.0489.

In one instance of the reactor core, in which the diameter is 300 centimeters and the height is 300 centimeters, the volume is approximately 21.2 cubic meters. In this implementation, approximately 30,000 of these hexagonal channels are in the reactor core. In some useful implementations, the open volume of the reactor core (i.e., the volume not occupied by some combination of moderators, cladding, moderator rods, or control rods) is filled entirely with the fuel-salt mixture. The volume and surface area to volume ratio affects the P_{FNL} and P_{TNL} terms of the six-factor formula, as described in a preceding section, and in turn affects the criticality. In general, the varying of the core geometry changes the terms in the six-factor formula.

In the example illustrated in FIG. 5, each of the hexagonal blocks 504 contains one tubular channel 502. In some implementations, each hexagonal block 504 may contain more than one tubular channel 502. In some implementations, large blocks of moderating material may contain many tubular channels 502. In some implementations, combinations of two or more of such types of hexagonal blocks could be used.

The example reactor core configuration (FIG. 2) used in the numerical simulations described above uses a manifold configuration. In implementations that include the manifold configuration, the fuel-salt mixture flows through the reactor core from one end 111 (FIG. 1) to the other end 115 (FIG. 1) in the regions (gaps) 202 between plates 204 of moderating material. The plates 204 can include sections of moderating material in any suitable shape. A manifold configuration can incorporate curved plates (for example, as shown in FIG. 2), or flat plates, or a combination of these and any of a wide variety of other types of plate geometries.

In some implementations, the plates can be grouped together in moderator assemblies. In some implementations, multiple assemblies can be aggregated in a single reactor core. In some aspects, such moderator assemblies can be similar to the fuel assemblies used in solid-fueled reactors.

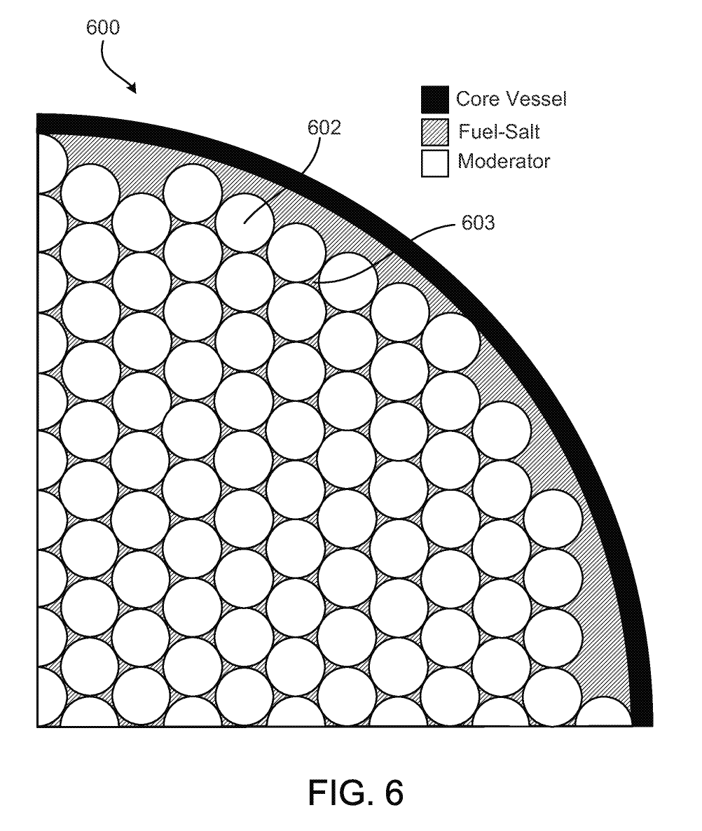

FIG. 6 shows a cross-sectional view of an example pebble configuration 600 for stationary (but not permanent) moderator elements of a reactor core. In some implementations of such a pebble configuration, the fuel-salt mixture flows through gaps 603 around pebbles 602 of moderating material as it traverses the reactor core from one end to the other. The pebbles 602 can be spherical (as shown in FIG. 6) or any other suitable (for example, non-regular) geometry, or a combination of spherical and non-spherical. One example of a pebble core configuration 600 was modeled using SCALE. In this simulation, spherical pebbles (packed such that their centers form a regular rectangular grid with spacing between the center points equal to the diameter of the spheres, unlike FIG. 6. This is known as a “square pitch.”) with radii of 4 cm resulted in a multiplication factor of 1.0327.

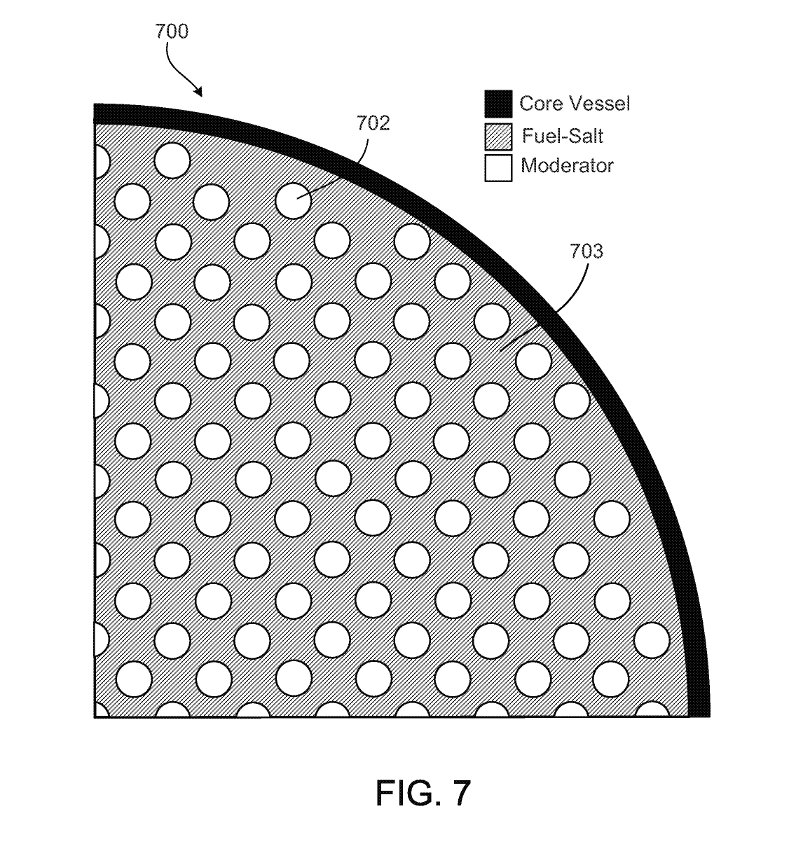

FIG. 7 shows a cross-section of an example rod configuration 700 for stationary moderator elements of a reactor core. In implementations of the rod configuration 700, the fuel-salt mixture flows through the gaps 703 around rods 702 of moderating material. The rods 702 can be simple cylinders, or the rods 702 can have another shape. In a single reactor core, sets of rods having different shapes can also be used. For example, the rods 702 can be any one of annular rods; or finned rods; or helical rods; or twisted helical rods; or annular helical rods; or annular twisted helical rods; or closely packed rods with wire-wrap spacers; or closely packed annular rods with wire-wrap spacers, or other types of rods; or can be any combination of two or more of such shapes. One example of a rod core configuration 700, in which the radius of a rod was 0.5075 cm and the rod pitch—the distance between the center of one rod and the center of an adjacent rod—was 1.26 cm, was modeled with SCALE. The multiplication factor for this system was 1.0223.

In some implementations, the rods can each include a hollow inner channel. These rods are called annular rods. The fuel-salt mixture, or possibly a coolant fluid to regulate the temperature of the moderator, can flow through the hollow inner channel of the rods. One instance of an annular rod core configuration, with fuel-salt flowing through a channel within each moderating rod as well as flowing through the spaces outside of the rods, was modeled with SCALE. The inner radius of each rod was 0.05 cm, the outer radius of each rod was 0.53 cm, and the rod pitch was 1.26 cm. The multiplication factor for this system was 1.0235. In the modeled case, the fuel-salt mixture flows both inside and outside the annular rod. In examples in which the fuel salt flows on the outside and a different, non-radioactive coolant on the inside of each rod, the purpose of the non-radioactive coolant would be to keep the annular rod from overheating. Such an approach could be used if the annular rod were made of a material that could not be allowed to get hotter than a certain maximum temperature.

In a given reactor core, it would also be possible to use any combination of two or more of plate elements, pebble elements, and rod elements, and even other kinds of elements and combinations of them. Among the principles that could govern the geometric configuration and selection of the elements would be that the reactor core has a low surface area to volume ratio, to keep the P_{TNL} and P_{FNL} terms of the six-factor formula as high as possible.

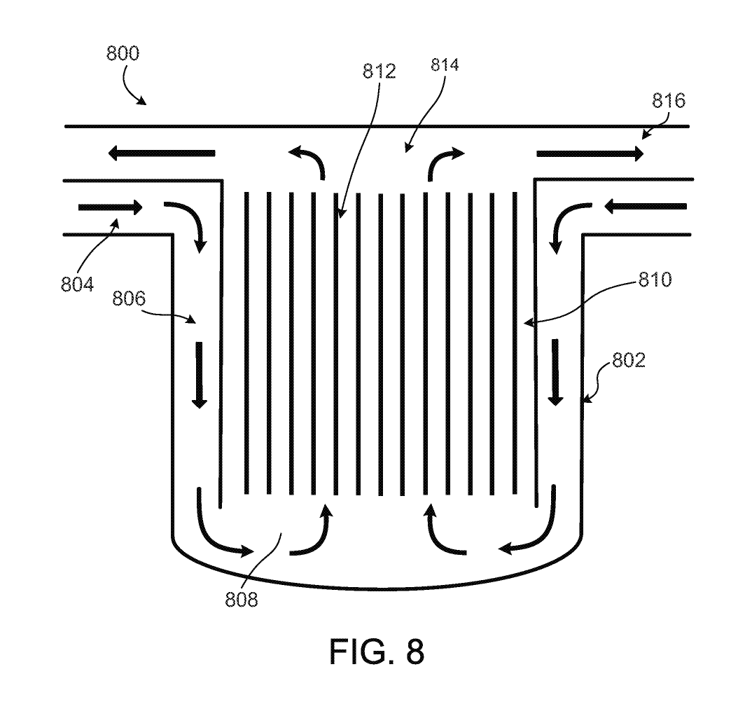

FIG. 8 is a side sectional view of an example reactor core 800 that includes an implementation of a downcomer 802. The downcomer 802 in this example forms a cylindrical channel or sleeve around the reactor core and allows the fuel-salt mixture to enter and flow through the reactor core. FIG. 8 shows the general direction of flow through the reactor core 800. The fuel-salt mixture enters the reactor core through an inlet region 804 and flows through a cylindrical flow passage 806 of the downcomer 802 into a lower plenum 808. From the lower plenum 808, the fuel-salt mixture flows through the driver region 810 into an upper region 814. From the upper region 814, the fuel-salt mixture flows out of the reactor core through the outlet region 816.

In some implementations, the driver region can be defined as the portion of the reactor core that is not the downcomer. In some configurations, instead of using a downcomer, the fuel-salt mixture directly enters the reactor core at the bottom of the reactor core and flows out of the top of the reactor core. In some configurations, instead of using a downcomer, the fuel-salt mixture directly enters the reactor core at the side of the reactor core and flows out of the other side of the reactor core.

In some implementations, the driver region 810 includes stationary moderator elements 812 comprising moderator material. The downcomer 802 can expose the fuel-salt mixture to neutrons that might otherwise leak out of the core. As such, use of a downcomer 802 can reduce leakage and thereby increase the rate of transmutation of fertile nuclei into fissile nuclei. The downcomer 802 can include moderating material. A downcomer 802 can be used with any of the example core configurations that we have described, and others.

FIG. 8 shows the downcomer 802 surrounding the driver region 810. In some implementations, a reactor core can include a downcomer having another configuration. For example, a reactor core can include a downcomer in the center of the reactor core. In such examples, the incoming fuel-salt mixture can flow through the downcomer in the center of the reactor core and then flow through the active region where most of the heat is generated. A wide variety of other configurations would be possible for the downcomer in order to trap neutrons that may leak out of the core (to increase the P_{TNL} and P_{FNL} terms of the six-factor formula). For example, the wider the downcomer is, the fewer neutrons that are lost, but the more salt that must be in the reactor.

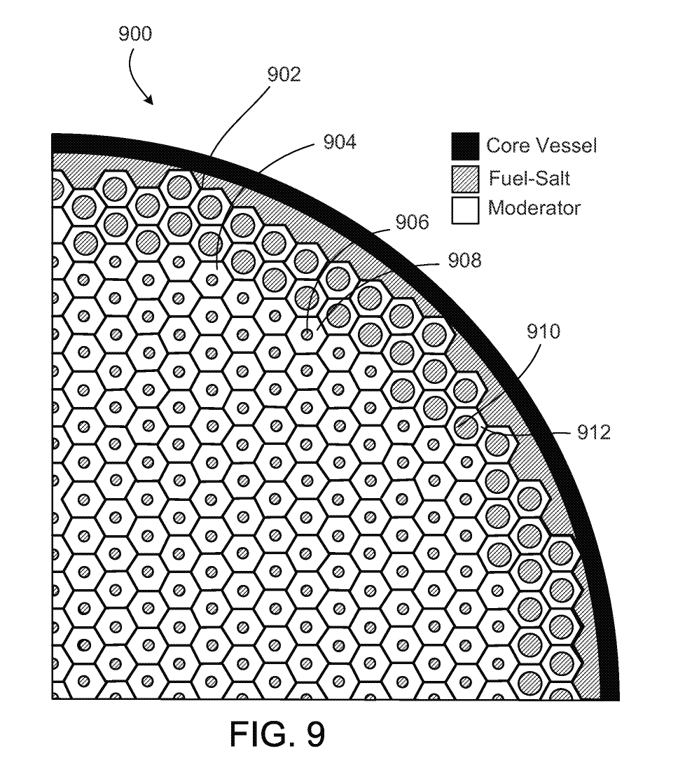

FIG. 9 is a diagram of an example reactor core 900 that includes an implementation of a blanket region 902. A blanket region 902 can be used with any of the reactor core configurations that we have described, and others. In some implementations, the blanket region 902 is generally cylindrical and surrounds an interior region 904 of the reactor core. In some implementations, the blanket region 902 and the interior region 904 have different fuel-to-moderator ratios. The fuel-to-moderator ratio in the different regions can be tuned, for example, to increase the fertile-to-fissile transmutation. In some implementations, there may be multiple zones, having different respective fuel-to-moderator ratios. One such example is a core with relatively low moderation in the central zone, an intermediate zone with somewhat higher moderation, and an outer zone with the highest moderation. This would allow the neutron spectrum to remain fast in the central region, and become more thermalized in the radial direction.

In the example shown in FIG. 9, the fuel-to-moderator ratio is higher in the blanket region 902 than in the interior region 904. In the interior region 904, the fuel-salt mixture flows through channels 906 in blocks 908 of moderator material. In the blanket region 902, the fuel-salt mixture flows through different size (in this case, larger) channels 910 in blocks 912 of moderator material. In some implementations, the interior region can have a higher fuel-to-moderator ratio than the blanket region.

A wide variety of configurations, sizes, and shapes of the plates, the assemblies of plates, and the aggregations of plate assemblies (which we broadly can call the geometry of the moderator plates) would be possible. As one simple example, plates or groups of plates can be twisted, for example, to improve thermal-hydraulic characteristics of the reactor core, or for other purposes. The relationships between criticality (and other figures of merit for the reactor core) and a wide variety of parameters associated with the geometry of the moderator plates (and temperature, etc.) are complex and typically not susceptible to being expressed in explicit formulas. Computer simulations can be used to identify feasible and advantageous geometries of the moderator plates.

Fluoride salts have a high volumetric heat capacity relative to some other reactor coolants, as shown in Table 3 below.

TABLE 3
Relative heat-transport capabilities of coolants to transport
1000 MWt with a 100 C. rise in coolant temperature

| | Water | Sodium | Helium | Liquid Salt |
|---|---|---|---|---|
| Pressure, MPa | 15.5 | 0.69 | 7.07 | 0.69 |
| Outlet Temperature, C. | 320 | 545 | 1000 | 1000 |
| Velocity, m/s (f/s) | 6 (20) | 6 (20) | 75 (250) | 6 (20) |
| Number of 1-m-diameter | 0.6 | 2.0 | 12.3 | 0.5 |
| pipes required to transport | | | | |
| 1000 MWt | | | | |

(Source: C. W. Forsberg, “Thermal- and Fast-Spectrum Molten Salt Reactors for Actinide burning and Fuel Production,” GenIV Whitepaper, United States Department of Energy, (2007)).

Because of this high heat capacity, the components of the primary loop 102 (e.g., the piping, the valves, and the heat exchanger, putting aside the reactor core) can have smaller internal diameters than those used in a system with other coolants, because the amount of heat that can be carried by the fuel-salt mixture from the reactor core to the heat exchanger is high per unit volume.

The nuclear reactor system 101 can provide safety advantages. The physics of designs such as those described in the previous sections give them many safety features that reduce the likelihood of certain accident scenarios. For example, reactivity in the reactor core 106 could potentially be increased by accidental moderator rod ejection or control rod ejection. If such a reactivity increase (whatever the cause) results in a supercritical system, the temperature in the reactor core and primary loop would rise rapidly. One or more features can be incorporated in the reactor core 106 to compensate for unintended reactivity increases.

For example, the fuel-salt mixture has a positive temperature expansion coefficient. Therefore, when the temperature of the fuel-salt mixture increases, the salt expands and the fuel density decreases, leading automatically to a drop in reactivity. This expansion can also force some of the fuel-salt mixture out of the reactor core 106, and the decreased amount of fuel in the core can lower reactivity.

In cases in which the reactor core 106 operates with a large fraction of U-238 in the fuel, the Doppler broadening effect also can cause a drop in reactivity. This effect can occur when the large thermal resonance of U-238 expands with increasing temperature. Neutron absorption rates increase in the wider U-238 resonance and neutron concentrations below the resonance decline, leading to lower thermal and total fission reaction rates and decreased reactivity. In addition to or in place of these passive safety features, control rods or shutdown rods can be inserted and moderator rod can be removed, or a combination of them can be controlled, to shut down the chain reaction, for example, within a few seconds.

The nuclear reactor system 101 can also provide additional safety advantages. Some nuclear reactors rely on operator action, external electric power, or active safety systems to prevent damage in accident scenarios. For example, some nuclear reactor systems continuously pump coolant over the reactor core to prevent a meltdown. In such conventional nuclear reactor systems, the pumps operate on an external power supply that is separate from the reactor itself. Backup power systems (e.g., large diesel generators and batteries) are used in such nuclear power systems to ensure a constant supply of electricity to the pumps. However, it is possible that all of the backup systems in such conventional nuclear reactors can fail at once (e.g., due to a common cause).

Although, in some implementations, the nuclear reactor system 101 can incorporate one or a combination of two or more of such active safety features, the nuclear reactor system 101 can also or instead provide safety without reliance on such features. For example, the nuclear reactor system 101 can provide passive safety without reliance on active safety measures. Passively safe nuclear reactors do not require operator action or electrical power to shut down safely, for example, in an emergency or under other conditions. The fuel-salt mixture in the nuclear reactor system 101 does not require additional coolant. If the nuclear reactor system 101 loses external power, the fuel-salt mixture flows out of the reactor core through freeze valves 118 into the auxiliary containment subsystem 120.

In some implementations, the nuclear reactor system 101 can provide environmental advantages. Spent nuclear fuel from some reactors includes two broad classes of materials: actinides and fission products. Many of the fission products in the waste produced by some reactors have short radioactive half-lives and have significant radioactivity for only a few hundred years. Many of the actinides in the waste produced by some reactors can be significantly radioactive for upwards of 100,000 years.

The nuclear reactor system 101 can use as fuel the actinides in the spent nuclear fuel from other reactors. By inducing fission in the actinides in the spent nuclear fuel from other reactors, the majority of the waste produced by the nuclear reactor system 101 is composed of fission products. The longer the spent nuclear fuel is held in the nuclear reactor primary loop, the greater the percentage of actinides that can be turned into fission products. As such, the nuclear reactor system 101 can reduce the levels of radioactive materials having longer half-lives that otherwise exist in spent nuclear fuel, and thereby reduce the radioactive lifetime of waste produced by other nuclear reactor systems (e.g., to hundreds of years), thereby decreasing the need for permanent nuclear waste repositories (e.g., Yucca Mountain). The fission products that have shorter half-lives can be safely stored above ground until their radioactivity has decayed to insignificant levels.

In some implementations, the nuclear reactor system 101 can provide advantages in power production. In some implementations, the nuclear reactor power plant system 100 can convert the high-level nuclear waste produced by conventional nuclear reactors into a substantial supply of electrical power. For example, while some nuclear reactor systems utilize only about 3% of the potential fission energy in a given amount of uranium, the nuclear reactor system 101 can utilize more of the remaining energy in some instances. The longer the spent nuclear fuel is held in the nuclear reactor, the greater the percentage of the remaining energy can be utilized. As an illustrative example, substantial deployment of the nuclear reactor system 101 could potentially use existing stockpiles of nuclear waste to satisfy the world's electricity needs for several decades.

As shown in FIG. 1, a fission product removal 114 component of the primary loop 102 can incorporate a wide variety of systems, components, and techniques. Fission products are produced continuously in the nuclear reactor system 101, as actinides are split. Such fission products can act as neutron poisons in the reactor core 106. Such fission products can be removed from the fuel-salt mixture by a halide slagging process. Halide slagging has been used at an industrial scale for decades as a batch process. The halide slagging process can ensure that the reactor remains critical in some cases.

In some implementations, the fission product removal component 114 comprises a port 123 in the primary loop piping that allows for the removal of a batch 119 of molten fuel-salt mixture. In some implementations, this fuel-salt mixture is then processed using halide slagging 131. In some cases, fresh fuel-salt mixture 121 is then added to the primary loop through, for example, the same port to make up the volume of the removed salt. In some implementations, the halide slagging process can be automated, for example, to make it an in-line unit in the nuclear reactor system 101. In such implementations, the molten fuel-salt mixture, as it flows through the piping of the primary loop, passes through the fission product removal component 114, where the halide slagging process occurs. Other arrangements would also be possible for removing the waste and recharging the primary loop.

In some implementations, one or more freeze valves can control fluid flow between the primary loop 102 and an auxiliary containment subsystem 120. In some examples, these freeze valves are made of a halide salt that is actively and continuously cooled so that the salt is in solid form, allowing them to remain closed during normal operation. In the event of an accident scenario that results in a loss of offsite or backup power supplies, the freeze valves will no longer be actively cooled. When the halide salt comprising the freeze valve is no longer actively cooled, the salt melts and the valve opens, allowing the fuel-salt mixture to flow out of the primary loop 102 into a passively cooled storage tank 117 of the auxiliary containment subsystem 120. A salt containing loop can have multiple stages of temperature-regulated freeze valves, each designed to open at different temperatures, thereby allowing finer control of the temperature of the fuel salt in the primary loop and reducing the risk of system overheating.

FIG. 12 is a schematic diagram of an example nuclear reactor primary loop 102 that includes a nuclear reactor core 106, a heat exchanger 112, and multiple stages of temperature-regulated freeze vales 1207, 1209, and 118. A molten fuel salt mixture 103 is continuously circulated 105 through the primary loop piping 1204 using pumps 108a. The primary loop 102 is charged with enough molten fuel salt 121 to fill the primary loop, including the reactor core 106 and the heat exchanger 112.

Each freeze valve 1207, 1209 and 118 contains a salt plug (1232, 1233, and 1234, respectively) that can be cooled using a cooling unit (1224, 1225, and 1226, respectively) to ensure that the salt remains in a solid, frozen state. When the salt plug is frozen, the valve is closed. The cooling unit may consist of an electrically-powered jet of gas, a heat exchanger, or some other cooling mechanism. If the cooling unit is turned off (either deliberately via operator action or during an accident scenario such as a loss of electric power), the salt plug loses its cooling and melts. When the salt plug melts, the valve is open, and fuel salt 103 may flow from the primary loop 102 into a containment tank 120. The fuel salt 103 may be allowed to cool and solidify in the tank (using, for example natural convection and conduction), or insulation 1213 and heating units 1214 could be used to keep the fuel salt 103 at a particular temperature. If the fuel salt is allowed to cool until it reaches a frozen state, the heating units may be used to remelt the fuel salt. When molten, the fuel salt 103 may be reintroduced into the primary loop using pump 1227, thereby recharging the primary loop with fuel salt, and allowing primary loop circulation to restart.

Valve 118 (either on its own or in combination with some combination of valves 1207 and 1209) can be used to enhance safety in accident scenarios. If offsite power is lost, the freeze valve 118 loses its electrical cooling 1224, and the salt plug 1232 melts, opening the valve 118 and allowing fuel salt 103 to flow into the auxiliary containment 120. The volume of auxiliary containment is sufficiently large to contain the entire volume of fuel salt 103 in the primary loop 102. The geometry of the auxiliary containment 120 is chosen such that, when it contains fuel salt, the fuel salt is not in a critical configuration—i.e., the fuel salt 103 is not capable of undergoing a self-sustaining nuclear reaction. In a non-critical configuration, the fuel salt 103 generates significantly less heat than it would if it were in a critical configuration. This lower heat production ensures that it is straightforward to cool the salt. Automatically removing the fuel salt 103 from the primary loop 102 prevents temperature in the primary loop 102 from increasing to undesirably high levels.

Similarly, the molten salt plug 1232 may also melt when the temperature of the fuel salt 103 in the primary loop 102 increases beyond a certain value. This value is a function of the amount of heat removed by the cooling apparatus 1224 and the thermal transport characteristics of the fuel salt 103, the salt plug 1232, the primary loop piping, and the valve 118.

In some scenarios, it is desirable to drain only a fraction of the fuel salt 103 from the primary loop 102. Such scenarios could include a situation in which the temperature of the fuel salt in the primary loop is only a small number of degrees or fractions of a degree above the desired temperature. This method would make it possible to decrease the temperature to the desired value, without having to shut down the reactor. In such an implementation, one may use a freeze valve 1207 connected to an auxiliary tank 1208, whose volume is not large enough to contain the entire volume of fuel salt 103. The flow into auxiliary tank 1208 therefore stops when the tank is full. One application of such a system would permit finer control of the temperature of the fuel salt 103 in primary loop 102. The cooling mechanism 1225 could be adjusted to remove heat from the valve at a specific rate, chosen such that the salt plug 1233 melts (thereby opening the valve 1207) when the temperature in the region of the primary loop 102 near valve 1207 increases above a certain value. The degree of cooling needed has an approximately linear relationship to the primary loop 102 temperature at which the valve will open, and can be determined via simulation or experimental means. When the valve 1207 opens, fuel salt 103 from the primary loop 102 drains into the auxiliary tank 1208 until the auxiliary tank 1208 is filled. The volume of fuel salt 103 lost from the primary loop 102 can be replenished by pumping make-up salt 1238 from auxiliary tank 1237. Make-up salt 1238 may be introduced to the primary loop 102 using either a pump 1239, or a gravity-feed mechanism coupled with a valve 1236, or some combination of those methods. In some implementations, the make-up salt may be free of fissile and/or fissionable material, which would serve to dilute the fissile and fissionable material content in primary loop 102, ultimately decreasing the temperature in the primary loop 102, and thereby serving as a control mechanism. Alternatively or in addition to this implementation, the make-up salt 1238 may be at a temperature lower than the temperature of the fuel salt 103 in the primary loop 102, and would therefore decrease the average temperature of the fuel salt in primary loop.

The drained fuel salt could be allowed to solidify in auxiliary tank 1208, or insulation 1219 and heating units 1220 could be used to keep the salt at a particular temperature. When the drained fuel salt 103 is in liquid form, it can be allowed to drain through valve 1215 into auxiliary tank 120, from which in can either be allowed to cool, or be kept molten, or pumped using pump 1227 back into the primary loop 102.

This method could be extended to include multiple temperature-sensitive freeze valves. For example, the primary loop 102 could also include a second temperature-sensitive freeze valve 1209, whose cooling system 1226 was calibrated to allow the salt plug 1234 to melt at when the temperature of primary loop 102 is at a temperature slightly higher than the temperature that induces salt plug 1207 to melt. For example, if the valve 1207 opens when the temperature of primary loop 102 is 3 degrees above the desired primary loop temperature, then valve 1209 could be set to open when the temperature of primary loop 102 is 5 degrees above the desired temperature. Having multiple temperature sensitive freeze valves, each set to melt as successively higher temperatures, allows for fine control of the temperature of the fuel salt 103 in the primary loop 102, without draining all the fuel salt from the reactor.

Freeze valve 1209 operates similarly to freeze valve 1207. When a sufficiently high temperature in the primary loop 102 is reached, the salt plug 1234 melts, opening the valve 1209 and allowing fuel salt 103 to flow from the primary loop 102 into the auxiliary tank 1210. The auxiliary tank 1210 is not large enough to contain the entire volume of fuel salt 103, and therefore the flow stops when the tank is full. The volume of fuel salt 103 lost from the primary loop 102 can be replenished by pumping make-up salt 1238 from auxiliary tank 1237. Make-up salt 1238 may be introduced to the primary loop 102 using either a pump 1239, or a gravity-feed mechanism coupled with a valve 1236, or some combination of those methods. The drained fuel salt 103 could be allowed to solidify in auxiliary tank 1210, or insulation 1221 and heating units 1222 could be used to keep the salt at a particular temperature. When the drained fuel salt 103 is in liquid form, it can be allowed to drain through valve 1217 into auxiliary tank 120, from which in can either be allowed to cool, or be kept molten, or pumped using pump 1227 back into the primary loop.

In some implementations, valve 1209 could have a larger cross-sectional area than valve 1207, to permit more rapid flow into tank 1210. It is possible to include more than two stages of temperature-controlled freeze valves, to allow further control of the temperature of the fuel salt 103 in primary loop 102.

In all of these implementations, it is possible to directly trigger the opening of valves 1207, 1209, and 113 by turning off their cooling units (1225, 1226, and 1224, respectively), regardless of system temperature. Direct opening of the valves could be used, for example, during a reactor shutdown scenario.

Freeze valve control and safety systems as described can be used in combination with the other reactor systems and features described in this disclosure.

In some implementations, the freeze valves 118 and the passively cooled storage tank 117 can use a wide variety of components, materials, and techniques to provide auxiliary containment of the fuel-salt mixture from the primary loop 102. In some implementations, the auxiliary containment subsystem 120 itself includes a containment vessel 117 that can safely store the fuel-salt mixture from primary loop 120. The geometry of the containment vessel 117 is such that the fuel-salt mixture contained in the containment vessel cannot achieve criticality. For example, the containment vessel 117 could be constructed such that the fuel-salt mixture flowing into it has a large surface area to volume ratio. The fuel-salt mixture in a non-critical configuration can remain cool due to, e.g., natural convection and conduction, without requiring further active cooling.

Any suitable piping can be used for primary loop 102. The piping of primary loop 102 carries the molten fuel-salt mixture. In the primary loop 102, heat is produced in the reactor core 106 when actinides undergo fission following neutron bombardment. The photons, neutrons, and smaller nuclei produced in the nuclear reaction can deposit energy in the fuel-salt mixture 103, heating it. The fuel-salt mixture carries the heat out of the reactor core 106. For example, the pumps 108a move the fuel-salt mixture through the piping of primary loop 102 through the reactor core 106 to the heat exchanger 112.

In some implementations, the piping of the primary loop 102 can be resistant to both corrosion damage from molten halide salts and radiation damage from nuclear reactions. In some cases, corrosion can be reduced or minimized in alloys that have a high nickel content, such as Hastelloy-N or Hastelloy-X. These alloys can operate at temperatures up to 704° C. For systems using higher system temperatures, SiC—SiC composites or carbon-carbon composites or a combination of them can be used for the piping, valves, and heat exchangers of the primary loop. In some implementations, it is possible to hold the fuel-salt mixture contained in the primary loop 102 at approximately atmospheric pressure. Holding the system at approximately atmospheric pressure reduces the mechanical stress to which the system is subjected.

In some implementations, the heat exchanger 112 can include a wide variety of structures, components or subsystems to transfer heat energy between the primary loop 102 and the secondary loop 104. In some implementations, the heat exchanger 112 transfers heat energy from the primary loop 102 to the secondary loop 104, and the secondary loop 104 runs helium gas through a regular gas turbine system in a Brayton cycle. Some types of heat exchangers (e.g., those developed by the aircraft industry) contain buffer gas zones 83 to better separate gases that may diffuse across the heat exchanger. Such a buffer gas zone can be used in the nuclear reactor system 101 to reduce tritium migration from the primary loop 102 to the secondary loop 104.

In some implementations, noble metals can be collected in the primary loop 102 by replaceable high surface area metal sponges 85. The use of such materials can reduce the degree to which noble metals plate on surfaces in contact with the molten fuel-salt mixture. It is desirable to reduce such plating because noble metals' plating onto the heat exchanger 112 can change its heat transfer properties.

In some implementations, the nuclear reactor system 101 can include an intermediate loop that contains a non-radioactive molten salt or any other suitable working fluid. The intermediate loop can be held at a pressure slightly higher than that of primary loop 102. As such, if there were a leak between the intermediate loop and the primary loop, the pressure difference can prevent the radioactive fuel-salt mixture from entering the intermediate loop.

In some implementations, the secondary loop will contain a suitable working fluid, such as helium, carbon dioxide, or steam, or a combination of two or more of them, that will not be corrosive, as a molten halide salt would be, nor contain radioactive materials. Because the secondary loop will not be subjected to significant corrosion or radiation damage, there is more leeway in choosing materials for the secondary loop piping than for the primary loop piping. The secondary loop piping may be constructed of a suitable material such as stainless steel.

The Brayton cycle can use helium, carbon dioxide, or another suitable fluid. In some implementations, the secondary loop 104 can use a steam cycle such as a Rankine cycle, or a combined cycle, which incorporates an assembly of heat engines that use the same source of heat. A Rankine cycle is a method of converting heat into mechanical work that is commonly used in coal, natural gas, oil, and nuclear power plants. A Brayton cycle is an alternative method of a method of converting heat into mechanical work, which also relies on a hot, compressed working fluid such as helium or carbon dioxide. The helium Brayton cycle has the advantage that, in some instances, tritium can be scrubbed (removed) from helium more easily than it can be scrubbed from water. The Brayton cycle may also operate at higher temperatures, which allows for greater thermodynamic efficiency when converting heat to mechanical work. Additional or different factors may be considered in selecting a thermodynamic cycle for the secondary loop 104. Use of open-cycle Brayton turbines is well-established in aircraft and in natural gas power plants. Closed-cycle helium Brayton turbines have been demonstrated at the lab scale.

In some implementations, it would be possible to use the high-temperature process heat produced by the reactor directly. This high-temperature process heat could be used, for example, in hydrogen production, or water desalinization, or district heating, or any combination of two or more of them.

In some implementations, a tritium scrubber component 116 of the secondary loop 104 can incorporate a wide variety of systems, components, and techniques. In a molten salt reactor, tritium can be mobile. For example, the tritium can diffuse readily through the fuel-salt mixture and across the heat exchanger 112 into the secondary loop 104. Such tritium can be scrubbed (e.g., continually, periodically, or otherwise) from the secondary loop 104, for example, to prevent the release of tritium into the environment.

In some implementations, the nuclear reactor system 101 receives spent nuclear fuel 139 from another nuclear reactor system 143. For example, spent nuclear fuel pellets 147 from another nuclear reactor system can be separated from the metal cladding. The pellets can then be dissolved in a molten halide salt 145 for charging the primary loop. In some cases, the spent nuclear fuel can be manipulated in a variety of ways before being combined with the molten fluoride salt. For example, the fuel assembly can be mechanically chopped and shaken to separate the bulk of the spent fuel from the metal cladding. After the bulk of the metal cladding is separated from the spent fuel, some residual metal cladding may remain on the separated fuel. Then, a suitable solvent can be applied to dissolve either the fuel, the cladding, or both. The fuel and cladding materials may be separated more easily when they are in a dissolved state.

In some implementations, the molten fuel-salt mixture is formed using a halide salt 149 (e.g., LiF) that does not yet contain any radioactive material. The halide salt is placed in a mixing vessel and heated until molten in a furnace 151. When the salt is molten, the spent nuclear fuel pellets 147 are added to the molten salt, and the components are mixed until the actinides from the spent fuel pellets are dissolved in the salt to form the fuel-salt mixture. The fuel-salt mixture is then added to the primary loop through the port on the side of the primary loop. In some implementations, computer simulations can determine the actinide and fission product concentrations in the fuel-salt mixture following the fuel-salt mixture's addition to the primary loop. These computer simulations can, in turn, be used to predict the neutron energy spectrum in the reactor core 106. In some cases, following these computer simulations, the loading and unloading cycles of fuel in the reactor can be regulated to ensure an optimal neutron spectrum in the reactor core 106.

In some implementations, the fuel used in the fuel salt mixture can include spent nuclear fuel from other reactors, as we have mentioned. The spent nuclear fuel is typically available in assemblies, which have been removed from an existing reactor 143, and include hollow casings (cladding) of another material that are filled with the spent nuclear fuel in the form of pellets. In some implementations, the assemblies would be altered by removing the cladding to expose the spent fuel pellets. When we speak of unprocessed spent nuclear fuel, however, we do not consider the removal of the cladding to be processing of the spent nuclear fuel. When we say that the spent nuclear fuel is unprocessed we mean that nothing has been done (for example, chemically or reactively, or by way of separation) to change the composition of the spent nuclear fuel that was inside the casing. In some implementations this entire unprocessed spent nuclear fuel vector is used in the reactor. In some implementations, chemical, reactive, or separation processing can be applied to the spent nuclear fuel before it is used in the reactor. For example, we may remove the fission products from the spent nuclear fuel. Removing fission products from the spent nuclear fuel does not change the actinide vector of the spent nuclear fuel. In some cases, either the entire unprocessed spent nuclear fuel vector, or the entire actinide vector, or the actinide vector following additional such processing (such as removal of U-238) can be mixed with other sources of actinides as we discuss elsewhere, in a variety of proportions or mixtures. Thus, the spent nuclear fuel that comes out of the reactor has a small fraction of fission products and a large fraction of actinides. “Unprocessed” spent nuclear fuel has none of these fission products or actinides removed. If the fission products (but not the actinides) are removed, what remains is an “entire spent fuel actinide vector.” If some of the actinides (for example, U-238) are removed, what remains can be called processed fuel that contains at least portions of the spent nuclear fuel from a reactor. You can then take any one of these three (unprocessed fuel, the entire spent fuel actinide vector, or processed fuel), or combinations of any two or more them) and also can mix them with other sources of actinides.

FIG. 10 is a flow diagram showing an example process 1000 for processing nuclear materials. The example process 1000 includes operations performed by multiple entities. In particular, as shown in FIG. 10, aspects of the example process 1000 can be performed by the operators of a light water reactor system 1002, a molten salt reactor system 1004, an electrical utility 1006, and a waste facility 1008. In some implementations, the process 1000 can include additional or different operations that are performed by the entities shown or by different types of entities.

In some implementations, the light water reactor system 1002 can include a typical light water nuclear reactor or a different type of nuclear reactor system. The light water reactor system 1002 receives nuclear fuel 1003 and generates power by a reaction of the nuclear fuel. The output power 1022 from the reaction of the nuclear fuel can be converted and delivered to the electrical utility 1006. The electrical utility 1006 can distribute the output power 1022 to consumption sites 1007 as electricity. For example, the electrical utility 1006 may use a power grid to distribute electrical power. In some cases, the electrical utility 1006 can convert, condition, or otherwise modify the output power 1022 to an appropriate format for distribution to the grid.

The light water reactor system 1002 produces spent nuclear fuel 1020 as a byproduct of the nuclear reaction that generates the output power 1022. In some implementations, the spent nuclear fuel 1020 from the light water reactor system 1002 can be transferred to the molten salt reactor system 1004. In some implementations, as explained earlier, the molten salt reactor system 1004 operates entirely on the spent nuclear fuel 1020 without further manipulation except removal from any cladding. For example, the molten salt reactor system 1004 can use spent nuclear fuel having substantially the material composition of the waste material produced by the light water nuclear reactor system 1002. In some implementations, the molten salt reactor system 1004 can receive additional or different types of materials, including additional or different types of fuel. For example, the molten salt reactor system 1004 can receive fuel materials from nuclear weapon stockpiles, or nuclear waste storage facilities, or a combination of these and other sources, as mentioned earlier. In some implementations, fresh nuclear fuel can be combined in various proportions with spent nuclear fuel.

In some implementations, the molten salt reactor system 1004 can include the nuclear reactor system 101 of FIG. 1 or another type of nuclear reactor system configured to burn the spent nuclear fuel 1020. The molten salt reactor system 1004 can be co-located with the light water reactor system 1002, or with the waste facility 1008, or with a combination of any two or more of these and other types of systems and facilities. The molten salt reactor system 1004 generates power by a reaction of the spent nuclear fuel material mixed with a molten salt material. The output power 1024 from the reaction of the fuel-salt mixture can be converted and output to the electrical utility 1006. The electrical utility 1006 can distribute the output power 1024 to consumption sites 1007 in the form of electricity. In some cases, the electrical utility 1006 can convert, condition, or otherwise modify the output power 1024 to an appropriate format for distribution to the grid.

The molten salt reactor system 1004 produces waste material 1026 as a byproduct of the nuclear reaction that generates the output power 1024. In some implementations, the waste material 1026 from the molten salt reactor system 1004 can be transferred to the waste facility 1008. The waste facility 1008 can process, store, or otherwise manage the waste material 1026 produced by the molten salt reactor 1004. In some implementations, the waste material 1026 includes a significantly lower level of long-radioactive-half-life materials than the spent nuclear fuel 1020. For example, the molten salt reactor system 1004 may produce waste materials that primarily include fission products that have short half-lives, as compared to actinides.

Other implementations are within the scope of the following claims.

For example, in some cases, the actions recited in the claims can be performed in a different order and still achieve desirable results. In addition, the processes depicted in the accompanying figures do not necessarily require the particular order shown, or sequential order, to achieve desirable results. In some cases we have described individual or multiple devices for elements for systems for performing various functions. In many cases, references to the singular should be interpreted as references to the plural and conversely.

In some implementations of the system and techniques that we have described here, the operators of the molten salt reactors will be electric utility companies. An electric utility that operates a molten salt reactor may own the molten salt reactor or may lease it from another entity. If a utility owns and operates the molten salt reactor, it will likely finance the construction of the molten salt reactor. If the molten salt reactor is leased to the operator, the manufacturer of the molten salt reactor will likely finance the construction.

In some implementations, an electric utility company may operate light water reactors, which produce spent nuclear fuel that could then be used as fuel for the molten salt reactors, or the utility may be paid to take spent nuclear fuel from another entity and use that spent nuclear fuel as fuel for the molten salt reactors. In some implementations, it is envisioned that spent nuclear fuel will be processed (e.g., removed from its cladding) at the molten salt reactor site and it is likely that the utility that operates the molten salt reactors will also process the spent nuclear fuel. In this case, the utility company would purchase halide salt from a salt producer and then mix the halide salt with processed spent nuclear fuel to create the fuel-salt mixture for use in a molten salt reactor. Alternatively, a separate company may be paid by a utility or government agency to take spent nuclear fuel, mix this spent nuclear fuel with a halide salt purchased from a salt producer, and then sell the fuel-salt mixture to molten salt reactor operators.

In some examples, the waste produced by the molten salt reactors will be taken, for a fee, by a governmental agency that oversees permanent waste disposal. This waste would be processed (e.g. vitrified) into a waste-form suitable for placement in a long-term disposal facility. If immediate disposal is unavailable (as is presently the case in all countries), the waste may be stored on site until long-term storage becomes available, or it may be taken, for a fee, by a government agency or third party for short-term storage until long-term storage becomes available.

The same concepts of using hydrides or deuterides, such as metal hydrides, as moderating material, which we described in the context of a molten salt reactor, may be applied, for example, in molten salt cooled reactors or in accelerator driven systems. Molten salt cooled reactors use distinct fuel and coolants, whereas molten salt reactors use fuel that is mixed with the coolant. Molten salt cooled reactors can have fuel elements that are of essentially any shape; likely shapes are rods or pebbles. The salt coolant, which contains no fuel material, flows around these fuel elements. Previous molten salt cooled reactor designs have proposed using graphite as a moderator. These designs could be altered to use hydride or deuteride moderators, for example, metal hydride moderators, in place of, or in addition to, graphite moderators. Metal hydride moderators for use in molten salt cooled reactors may take any of the forms described above for use in molten salt reactors.

Another potential application of hydride or deuteride moderators is in an accelerator driven systems (ADS). In ADS, neutrons are produced through a process known as spallation when a proton beam from a high energy accelerator is directed at a heavy metal target. When the heavy metal target is surrounded by nuclear fuel, the spallation neutrons can induce fission in the nuclear fuel, which in turn produces even more neutrons. Because the nuclear fuel is in a subcritical configuration, a nuclear chain reaction cannot be sustained without the spallation neutrons produced by the accelerator. This means the reactor may be shut down by simply turning off the accelerator. Such a system is called an accelerator driven system.

ADSs can be used to destroy actinide waste (e.g. spent nuclear fuel from conventional reactors, depleted uranium, excess weapons material). A hydride or deuteride (e.g., metal hydride) moderator may be useful, as it would slow down the high energy spallation neutrons to energies that are more efficient for transmuting or fissioning the surrounding actinide fuel. Thorium fuelled ADSs have also been proposed. Such systems use spallation neutrons and subsequent fission neutrons to convert thorium-232 into protactinium-233, which quickly decays to fissile uranium-233. The transmutation of thorium-232 into uranium-233 is most efficient with thermal neutrons. Hydride or deuteride moderators could be used in such a thorium fuelled ADS to soften the neutron energy spectrum to allow more efficient breeding of U-233 from thorium.

For both types of ADSs, it may be advantageous to place hydride or deuteride moderators around the heavy metal target to reduce the energy of the spallation neutrons. Especially in the thorium fuelled ADS, it may be advantageous to include such moderators not just around the target, but also in the surrounding nuclear fuel zone, as the entire system requires a soft neutron spectrum for optimal U-233 production.

In another implementation, the reactor vessel may have an integral design. FIG. 24 shows a cross-sectional schematic of a reactor vessel comprising an integrated system of moderator rods, reflector, steam generator, control rod drive mechanisms, pumps, cover gas, fuel salt and other components. In one implementation, all of the fuel salt is contained within the reactor pressure vessel. This fuel salt circulates within the reactor pressure vessel. The fuel salt circulates through the moderator bundle, in which it is locally in a critical configuration and increases in temperature. The fuel salt then moves through the control rod drive mechanism towards the top of the vessel. The fuel salt then approaches the top of the reactor vessel and begins to flow downward. In some implementations, this flow may be annular—the fuel salt's upward flow is near the center of the vessel, and the downward flow is closer to the sides of the vessel. Internal structures may guide the flow. As it flows downward, the fuel salt flows past heat exchangers, and transfers some of its thermal energy to the fluid on the other side of the heat exchanger. This secondary fluid may be liquid water, steam, molten salt, air, carbon dioxide, helium, or any other liquid or gas. If the secondary fluid is a combination of liquid water and steam, the heat exchanger may be termed a “steam generator.” Here, the terms “heat exchanger” and “steam generator” are used interchangeably. The heat exchangers may be double-walled.

The reactor may operate at low pressure, near atmospheric pressure, or at any other pressure. The reactor vessel may be made of metal, such as stainless steel or an alloy from the Hastelloy family, ceramic, or any combination of these and other materials.

The heat exchangers may be plate-fin heat exchangers, printed circuit heat exchangers, cassette-type heat exchangers, tube and shell heat exchangers, or any other type of heat exchanger or steam generator. The heat exchangers form a heat exchanger assembly, which may be removed as a unit during refueling and maintenance. This assembly may be connected to the top of the reactor vessel. A sealing flange may separate the top section of the reactor from the bottom section of the reactor. The secondary fluid may flow in opposite direction from the molten fuel salt, in a counterflow configuration. In another implementation, the fluids in the heat exchanger will have a crossflow or parallel flow configuration. The heat exchangers may have independent inlet and outlet flanges, combined inlet and outlet flanges, or any combination of these. In addition to or instead of being located in the downflow portion of the vessel, heat exchangers may also be located in the upflow portion of the vessel.

The heat exchangers may have a circular cross section, kidney-shaped cross section, or any other cross section. The heat exchangers may be arranged diagonally above the core.

Circulation may be driven by pumps or by natural circulation. In some accident scenarios, the fuel salt flow may be driven entirely by natural circulation. In normal operation, the flow may be driven by one or more pumps. In one implementation, the pumps are located within the reactor vessel, and the salt exiting the heat exchangers enters the suction side of the pump. In some implementations, the pumps will not drive a large pressure differential. In other implementations, the pumps will drive a larger pressure differential and correspondingly higher flow rate. In some implementations, the pumps are positioned downstream of the heat exchangers. In other implementations the pumps are positioned upstream of the heat exchangers. In some implementations, penetrations through the reactor vessel are necessary to carry the pumps' wiring. In other implementations, such as when using canned pumps, penetrations through the vessel wall are not necessary. The pumps may be located next to and form an independent assembly with a sealing flange that connects upper and lower sections of the vessel. In such an implementation, necessary penetrations could enter through the sealing flange, rather than through the vessel wall. The sealing flange may also provide structural support for the reactor vessel.

Electrical power leads that extend through the vessel or sealing flange may be hardened against radiation or corrosion damage. The pumps' motor winding, bearings, or other components may require external cooling. Additional penetrations to the sealing flange or reactor vessel may be required for the pump cooling, piping, and pump coolant pumping. The penetrations to the sealing flange or reactor vessel may be similar in design to those used to route electric wiring to the heaters for PWR pressurizers.

The control rod drive mechanisms are located within the reactor vessel. The control rods may use electromagnetic drive mechanisms. The electrical penetrations for the control rod drivers may cross the reactor boundary. The control rod drive mechanisms may also be manipulated hydraulically. An electrical system may use snap fittings that would allow for rapid disconnection and removal of the control rod drive mechanism in the case of emergencies.

The pumps drive the fuel salt to the bottom of the reactor, where it may enter a lower plenum. After reaching the bottom of the vessel, the salt flows upwards into the moderator bundle. Internal structures in the vessel may guide the salt in this flow pattern. In some implementations, the vessel may contain eight pumps. The pumps may be spool type pumps.

The reactor may also include a comb element to direct gas bubbles, entrained gas, and slag to the cover gas region. In the preferred implementation, the teeth of this comb are spaced more narrowly than the distance between the moderator pins. In the preferred implementation, the teeth for an angle of between 25 degrees and 80 degrees with respect to the downward flow direction. This comb element may be used to remove gas or vapor from the molten fuel salt in the event of a break in the primary heat exchanger.

The reactor vessel may also contain a grid element at the entrance to the downflow region or elsewhere in the reactor. This grid element may have openings smaller than the distance between moderator pins in the reactor moderator bundle, and may be positioned to prevent large pieces of contaminants such as slag and precipitates from reaching the downflow region.

The moderator may be zirconium hydride. The moderator may be in rod, plate, or any other solid form.

A cover gas system may be included in the vessel. This cover gas could be used to adjust the system pressure, act as a pressure relief valve in accident scenarios or other scenarios, be connected to a fission gas processing system, be used to modify the redox potential of the fuel salt (for example, by varying the partial pressure of fluorine or fluoride within the gas), or other applications. The cover gas may contain nitrogen, argon, air, or other gasses in any combination. A demister may separate the cover gas region from the molten salt. This demister may consist of a pipe or set of pipes packed with a dense metal mesh, wire, or other configuration. The metal forming the mesh, wire, or other configuration may be a steel alloy with a high nickel content. The cover gas system may be located outside the reactor pressure vessel. A demister may connect the reactor vessel to the reactor cover gas system. The cover gas region may also include portals or other equipment used to remove bubbles or slag from the reactor vessel.

In the preferred implementation, entire primary loop, including the heat exchangers, pumps, moderator bundle, and other components are located entirely within the reactor vessel boundary. In other implementations, a subset of these components may be located outside the reactor vessel. Implementations such as these would require piping for external hot and cold legs, external coolant pumps, external cover gas systems, and other components.

The steam generator and reactor coolant pumps may be directly flanged to the reactor vessel.

The reactor may also contain a reflector.

Additional radiation shielding may also be included on the outside of the reactor vessel.

The reactor vessel may incorporate heat tracing, strain gauges, inductive heating, or any combination thereof.

A catch basin may be positioned underneath the reactor vessel—this catch basin is designed to collect any molten fuel salt or other materials that may leak out of the reactor vessel in an accident or during regular operation. The catch basin may be connected via piping to an auxiliary containment, sized to be able to contain the entire molten salt inventory from the primary vessel. This auxiliary containment may incorporate active cooling, passive cooling, or a combination of the two. The catch basin may also incorporate active cooling, passive cooling, or a combination of the two. The reactor vessel may be connected to the catch basin via a freeze valve.

The system may incorporate active safety systems, passive safety systems, or a combination of the two. Active safety systems may include electrically driven pumps to circulate fuel salt. Passive safety systems may include natural circulation of the fuel salt within the reactor vessel. The salt composition may be selected to enhance natural circulation. For example, the selected fuel salt may have a density variation of greater than 5% over a 100 degree Celsius temperature change.

The center (upflow) passage may contain one or more non-return valve to prevent downward flow of fuel salt through the center passage. This non-return valve may include a passive flap that, in normal operation, is held in the open position by the fuel salt flowing upwards through the center channel. A pressure increase above the flap, due to flow reversal, a break in a heat exchanger located upstream of the flap, or any other cause, would cause the flap to close, thereby blocking the flow. The upflow region may contain one or more than one riser, each of which may contain one or more heat exchangers or pumps.

The reactor vessel may be located within a containment structure. This containment structure may be positioned wither above or below grade. The reactor vessel may contain external structures to support itself within the containment. The containment may be cylindrical, with a flat top or a domed top. In another implementation, the containment may be spherical. The containment may be made out of welded steel plates, concrete, or any combination of these and other materials. The moderator assemblies may be lifted from the reactor vessel into a spent moderator handling area located either inside or outside the containment, depending on the implementation.

The reactor may be capable of load following. The load following may be enabled by varying the flow rate through the circulation pumps, varying the position of the control rods, varying the position of the reflector, varying the position of the moderator rods, either singly or in any combination.

The containment may be filled with gas, including air, nitrogen, carbon dioxide, or any combination of these; water; solid or liquid salt, or any other fluid, solid, or gas. The material filling the containment may serve to remove decay heat in an accident scenario. In addition to or instead of this, the heat exchangers may thermally couple the primary coolant circuit with a fluid or gas in the containment vessel.

Multiple integral reactor units may be installed together, and may operate independently or as a unit. The units may share their turbines and generators. In other cases, each unit may have its own turbine and generator. Multiple units may be controlled from the same control room.

### REFERENCES

[1] J. Ackerman, T. Johnson, L. Chow, E. Carls, W. Hannum, J. Laidler, Treatment of wastes in the IFR fuel cycle, Prog. Nuclear Energy. 31 (1997) 141-154.
[2] G. J. Auwerda, Computational modeling of a molten salt reactor, Skripsi.TU Delft, Delft (2007).
[3] C. Forsberg, P. P. SNL, P. Peterson, Molten Salt Coolants (2003).
[4] C. W. Forsberg, Molten-salt-reactor technology gaps (2006) 4-8.
[5] C. W. Forsberg, P. F. Peterson, H. H. Zhao, An Advanced Molten Salt Reactor using high-temperature reactor technology. 4 (2004).
[6] F. H. Shu, U.S. patent application Ser. No. 13/290,711, TWO-FLUID MOLTEN-SALT REACTOR (2012).
[7] M. P. Hnilicka, U.S. Pat. No. 2,847,205, Production of Metals (1958).
[8] D. E. Holcomb, S. M. Cetiner, An Overview of Liquid-Fluoride-Salt Heat Transport Systems, ORNL/TM-2010/156, Oak Ridge National Laboratory, Oak Ridge, Tenn. (2010).

[9] D. Holcomb, G. Flanagan, B. Patton, J. Gehin, R. Howard, T. Harrison, Fast Spectrum Molten Salt Reactor Options (2011).
[10] R. S. Hood, U.S. Pat. No. 2,830,940, Production of metals (1958).
[11] R. Ked, ORNL-TM-3884, THE MIGRATION OF A CLASS OF FISSION PRODUCTS (NOBLE METALS) IN THE MOLTEN-SALT REACTOR EXPERIMENT (1972).
[12] L. Luzzi, M. Aufiero, A. Cammi, C. Fiorina, Thermo-Hydrodynamics of Internally Heated Molten Salts for Innovative Nuclear Reactors.
[13] R. Milford, S. Mann, J. Ruch, W. Carr, Recovering Uranium Submarine Reactor Fuels, Industrial & Engineering Chemistry. 53 (1961) 357-362.
[14] C. L. Schmidt, U.S. Pat. No. 2,882,143, Continuous process for the production of titanium metal (1959).
[15] Z. Alkan, K. Kugeler, R. Kaulbarsch, C. Manter, Silicon carbide encapsulated fuel pellets for light water reactors, Prog. Nuclear Energy. 38 (2001) 411-414.
[16] T. Allen, H. Burlet, R. Nanstad, M. Samaras, S. Ukai, Advanced Structural, MRS Bull. 34 (2009).
[17] J. S. Armijo, L. F. Coffin Jr, U.S. Pat. No. 4,200,492, Nuclear fuel element (1980).
[18] C. Azevedo, Selection of fuel cladding material for nuclear fission reactors, Eng. Failure Anal. (2011).
[19] M. Bennett, G. Chaffey, The effect of fission fragment irradiation upon the passive oxidation of silicon-bonded silicon carbide by oxygen at 950° C., J. Nucl. Mater. 48 (1973) 131-138.
[20] A. Benyagoub, A. Audren, Study of the damage produced in silicon carbide by high energy heavy ions, Nuclear Instruments and Methods in Physics Research Section B: Beam Interactions with Materials and Atoms. 267 (2009) 1255-1258.
[21] J. Cabrero, R. Pailler, F. Audubert, U.S. patent application Ser. No. 13/119,469, NUCLEAR FUEL CLADDING WITH HIGH HEAT CONDUCTIVITY AND METHOD FOR MAKING SAME (2009).
[22] L. Charpentier, M. Balat-Pichelin, H. Glénat, E. B [symbol] che, E. Laborde, F. Audubert, High temperature oxidation of SiC under helium with low-pressure oxygen. Part 2: CVD [beta]-SiC, Journal of the European Ceramic Society. 30 (2010) 2661-2670.
[23] V. Chaumat, C. Pagano, U.S. Pat. No. 7,222,775, Process for the metallization and/or brazing with a silicon alloy of parts made of an oxide ceramic unable to be wetted by the said alloy (2007).
[24] A. Debelle, L. Thome, D. Dompoint, A. Boulle, F. Garrido, J. Jagielski, D. Chaussende, Characterization and modelling of the ion-irradiation induced disorder in 6H—SiC and 3C—SiC single crystals, J. Phys. D. 43 (2010) 455408.
[25] K. M. Durow, S. T. Kennedy, U.S. Pat. No. 4,849,156, Nuclear fuel pin fabrication (1989).
[26] J. Dutta Majumdar, B. Ramesh Chandra, A. Nath, I. Manna, Studies on compositionally graded silicon carbide dispersed composite surface on mild steel developed by laser surface cladding, J. Mater. Process. Technol. 203 (2008) 505-512.
[27] T. E. Easler, A. Szweda, E. Stein, SILICON CARBIDE MATERIAL FOR NUCLEAR APPLICATIONS, PRECURSOR AND METHOD FOR FORMING SAME, AND STRUCTURES INCLUDING THE MATERIAL (2009).
[28] J. C. Farmer, M. S. de Caro, J. Marian, P. P. Demange, A. Arsenlis, J. H. Satcher, J. F. Latkowski, R. P. Abbott, T. D. de la Rubia, E. I. Moses, U.S. patent application Ser. No. 12/642,100, TRISO FUEL FOR HIGH BURN-UP NUCLEAR ENGINE (2008).
[29] L. L. Fehrenbacher, M. Patterson, D. McQuiston, U.S. Pat. No. 6,506,483, Ceramic fiber debond coatings (2003).
[30] H. Feinroth, U.S. patent application Ser. No. 12/229,299, Multi-layered ceramic tube for fuel containment barrier and other applications in nuclear and fossil power plants (2008).
[31] H. Feinroth, U.S. Pat. No. 5,182,077, Water cooled nuclear reactor and fuel elements therefor (1993).
[32] H. Feinroth, B. R. Hao, U.S. patent application Ser. No. 11/144,786, MULTI-LAYERED CERAMIC TUBE FOR FUEL CONTAINMENT BARRIER AND OTHER APPLICATIONS IN NUCLEAR AND FOSSIL POWER PLANTS (2005).
[33] H. M. Ferrari, U.S. Pat. No. 4,707,330, Zirconium metal matrix-silicon carbide composite nuclear reactor components (1987).
[34] A. Ferro, B. Derby, Liquid phase bonding of siliconized silicon carbide, J. Mater. Sci. 30 (1995) 6119-6135.
[35] G. Filippov, E. Grishanin, M. Konditerov, V. Mastyukin, V. Melkin, V. Trubachev, L. Falkovskii, B. Fonarev, G. Momot, Investigation of the corrosion resistance of fuel micropellet cladding made of silicon carbide and pyrolytic carbon for the operating conditions of light-water reactors in nuclear power plants, Atomic Energy. 101 (2006) 722-729.
[36] E. Friedland, N. Van Der Berg, J. Malherbe, J. J. Hancke, J. Barry, E. Wendler, W. Wesch, Investigation of silver and iodine transport through silicon carbide layers prepared for nuclear fuel element cladding, J. Nucl. Mater. (2011).
[37] F. Gao, W. J. Weber, R. Devanathan, Atomic-scale simulation of displacement cascades and amorphization in β-SiC, Nuclear Instruments and Methods in Physics Research Section B: Beam Interactions with Materials and Atoms. 180 (2001) 176-186.
[38] J. E. Gamier, G. W. Griffith, U.S. patent application Ser. No. 12/901,326, CLADDING MATERIAL, TUBE INCLUDING SUCH CLADDING MATERIAL AND METHODS OF FORMING THE SAME (2010).
[39] G. M. Gordon, R. L. Cowan, U.S. Pat. No. 4,029,545, Nuclear fuel elements having a composite cladding (1977).
[40] G. M. Gordon, R. L. Cowan, U.S. Pat. No. 4,022,662, Nuclear fuel element having a metal liner and a diffusion barrier (1977).
[41] G. M. Gordon, R. L. Cowan, J. H. Davies, Nuclear fuel elements having a composite cladding (1983).
[42] N. B. Heubeck, U.S. Pat. No. 4,406,012, Nuclear fuel elements made from nanophase materials (1998).
[43] W. Jiang, W. J. Weber, S. Thevuthasan, V. Shutthanandan, Accumulation and recovery of disorder on silicon and carbon sublattices in ion-irradiated 6H—SiC, J. Nucl. Mater. 289 (2001) 96-101.
[44] Y. Katoh, L. L. Snead, C. H. Henager, A. Hasegawa, A. Kohyama, B. Riccardi, H. Hegeman, Current status and critical issues for development of SiC composites for fusion applications, J. Nucl. Mater. 367 (2007) 659-671.
[45] Y. Katoh, L. L. Snead, T. Nozawa, N. Morley, W. E. Windes, Advanced Radiation-Resistant Ceramic Composites, Advances in Science and Technology. 45 (2006) 1915-1924.
[46] P. Kennedy, J. Shennan, Engineering applications of REFEL silicon carbide, Silicon carbide—1973 (1973) 359-366.
[47] N. Kishan Reddy, V. Mulay, M. Jaleel, Corrosion behaviour of infiltrated reaction sintered silicon carbide, J. Mater. Sci. Lett. 13 (1994) 1516-1517.
[48] J. Klett, N. Gallego, T. Burchell, J. Bailey, Irradiation studies of graphite foams and effects on properties for use in a solid state self-regulating nuclear heat source for small modular power units. 13 (2001) 18.
[49] H. Kleykamp, Selection of materials as diluents for burning of plutonium fuels in nuclear reactors, J. Nucl. Mater. 275 (1999) 1-11.
[50] W. Konig, D. Dauw, G. Levy, U. Panten, EDM-future steps towards the machining of ceramics, CIRP Annals-Manufacturing Technology. 37 (1988) 623-631.
[51] D. R. J. M. Konings, T. R. Allen, R. E. Stoller, P. S. Yamanaka, Nuclear Materials (2012).
[52] W. Lippmann, J. Knorr, R. Noring, M. Umbreit, Investigation of the use of ceramic materials in innovative light water reactor—fuel rod concepts, Nucl. Eng. Des. 205 (2001) 13-22.
[53] T. Maruyama, S. Onose, S. Mitsuno, U.S. Pat. No. 6,246,740, SIC-composite material sleeve and process for producing the same (2001).
[54] T. Morita, U.S. Pat. No. 4,717,534, Nuclear fuel cladding containing a burnable absorber (1988).
[55] H. Murata, M. Shioda, T. Nakamura, U.S. Pat. No. 6,723,381, Method and apparatus for manufacturing ceramic-based composite member (2004).
[56] J. C. Nappé, P. Grosseau, F. Audubert, B. Guilhot, M. Beauvy, M. Benabdesselam, I. Monnet, Damages induced by heavy ions in titanium silicon carbide: Effects of nuclear and electronic interactions at room temperature, J. Nucl. Mater. 385 (2009) 304-307.
[57] D. Petti, D. Crawford, N. Chauvin, Fuels for advanced nuclear energy systems, MRS Bull. 34 (2009) 40-45.
[58] R. Price, Thermal conductivity of neutron-irradiated pyrolytic β-silicon carbide, J. Nucl. Mater. 46 (1973) 268-272.
[59] D. W. D. River, U.S. Pat. No. 3,571,907, METHOD OF CLADDING A METAL SURFACE (1971).
[60] G. Sawyer, T. Page, Microstructural characterization of “REFEL” (reaction-bonded) silicon carbides, J. Mater. Sci. 13 (1978) 885-904.
[61] Y. Shimazu, H. T. EDC, Y. A. MHI, K. I. NDC, PWRs using HTGR fuel concept with cladding for ultimate safety (2002) 235.
[62] F. Southworth, P. Macdonald, D. Harrell, C. Park, E. Shaber, M. Holbrook, D. Petti, The Next Generation Nuclear Plant (NGNP) Project, Idaho National Laboratory, 2003.
[63] K. M. Taylor, U.S. Pat. No. 3,166,614, FUEL ELEMENT (1965).
[64] F. Thevenot, Sintering of boron carbide and boron carbide-silicon carbide two-phase materials and their properties, J. Nucl. Mater. 152 (1988) 154-162.
[65] J. Tulenko, G. Schoessow, Nuclear fuel concept for the 21st century, Transactions of the American Nuclear Society. 75 (1996).
[66] Y. Wang, S. Tan, D. Jiang, The effect of porous carbon preform and the infiltration process on the properties of reaction-formed SiC, Carbon. 42 (2004) 1833-1839.
[67] Y. Wu, Design status and development strategy of China liquid lithium-lead blankets and related material technology, J. Nucl. Mater. 367 (2007) 1410-1415.
[68] X. Yuan, L. W. Hobbs, Modeling chemical and topological disorder in irradiation-amorphized silicon carbide, Nuclear Instruments and Methods in Physics Research Section B: Beam Interactions with Materials and Atoms. 191 (2002) 74-82.
[69] Bakin, Andrey S. (2006). SiC materials and devices, vol. 1, edited by M. Shur, S. Rumyantsev, M. Levinshtein—Chap.:“SiC Homoepitaxy and Heteroepitaxy”. World Scientific. pp. 43-76. ISBN 981-256-835-2. http://www.worldscibooks.com/engineering/6134.html.
[70] Pitcher, M. W.; Joray, S. J.; Bianconi, P. A. (2004). “Smooth Continuous Films of Stoichiometric Silicon Carbide from Poly(methylsilyne)”. Advanced Materials 16 (8): 706. DOI:10.1002/adma.200306467.
[71] Bunsell, A. R.; Piant, A. (2006). “A review of the development of three generations of small diameter silicon carbide fibres”. Journal of Materials Science 41 (3): 823. Bibcode 2006JMatS . . . 41 . . . 823B. DOI:10.1007/s10853-006-6566-z.
[72] Laine, Richard M.; Babonneau, Florence (1993). “Preceramic polymer routes to silicon carbide”. Chemistry of Materials 5 (3): 260. DOI:10.1021/cm00027a007.
[73] L. E. Anderson, U.S. Pat. No. 3,776,660, PUMP FOR MOLTEN SALTS AND METALS (1973).
[74] R. C. Briant, A. M. Weinberg, Molten fluorides as power reactor fuels, Nucl. Sci. Eng. 2 (1957) 797-303.
[75] E. H. Canfield, U.S. Pat. No. 4,005,915, Plain bearing (1977).
[76] K. Clarno, C. Forsberg, J. Gehin, C. Slater, J. Carbajo, D. Williams, T. Taiwo, J. Cahalan, T. Kim, J. Sienicki, Trade Studies for the Liquid-Salt-Cooled Very High-Temperature Reactor: Fiscal Year 2006 Progress Report (2007).
[77] R. Gabbrielli, C. Zamparelli, Optimal design of a molten salt thermal storage tank for parabolic trough solar power plants, Journal of Solar Energy Engineering. 131 (2009) 041001.
[78] P. A. House, HYLIFE-II reactor chamber design refinements, Fusion Technol. 26 (1994) 1178-1195.
[79] A. Lipski, M. Ruschman, Friction and wear of radiation resistant composites, coatings and ceramics in vacuum and low temperature environment, Advances in cryogenic engineering. 38 (1993) 405-405.
[80] I. Minami, Ionic liquids in tribology, Molecules. 14 (2009) 2286-2305.
[81] L. J. Mullins, D. C. Christensen, U.S. Pat. No. 4,459,153, Pyrochemical process for extracting plutonium from an electrolyte salt (1984).
[82] M. S. Najjar, T. G. Dorawala, U. Koturk, U.S. Pat. No. 5,358,553, Membrane and separation process (1994).
[83] H. E. Sliney, U.S. Pat. No. 4,214,905, Method of making bearing material (1980).
[84] P. Smith, High-Temperature Molten-Salt Lubricated Hydrodynamic Journal Bearings, ASLE TRANSACTIONS. 4 (1961) 263-274.
[85] H. Zhao, P. F. Peterson, A Reference 2400 MW (t) Power Conversion System Point Design for Molten-Salt-Cooled Fission and Fusion Energy Systems, UC Berkeley Department of Nuclear Engineering Report UCBTH-03-002 (2004).
[86] S R Sherman, T M Adams. “Tritium Barrier Materials and Separation systems for the NGNP.” Savannah River National Laboratory, November 2008.
[87] Q. Bai, D. Kohlstedt, Effects of chemical environment on the solubility and incorporation mechanism for hydrogen in olivine, Physics and Chemistry of Minerals. 19 (1993) 460-471.
[88] C. J. Bergh, P. J. McKee, G. H. Alexander, U.S. Pat. No. 6,244,333, Corrugated folded plate heat exchanger (2001).
[89] C. A. Bonvillian, U.S. Pat. No. 2,707,493, Conduits (1955).
[90] W. Erickson, D. Hardie, The influence of alloying elements on the terminal solubility of hydrogen in [alpha]-zirconium, J. Nucl. Mater. 13 (1964) 254-262.
[91] G. W. Evans, U.S. Pat. No. 2,658,728, METHOD OF DETECTING LEAKAGE BE (1953).
[92] L. Kestemont, U.S. Pat. No. 3,438,430, DOUBLE WALL HEAT EXCHANGER UTILIZING FLEXIBLE CONDUCTOR PLATES BETWEEN THE WALLS (1969).
[93] S. C. Kim, M. P. Schwartz, U.S. Pat. No. 423,735, Double-walled finned heat transfer tube (1980).
[94] H. Kumpf, G. Molz, U.S. Pat. No. 4,011,132, Nuclear reactor pressure vessel for nuclear reactors with plastically deformable spacers (1977).
[95] X. Rayfield, U.S. Pat. No. 2,949,283, Apparatus for heat transfer (1960).
[96] J. Zuo, U.S. Pat. No. 6,408,941, Folded fin plate heat-exchanger (2002).
[97] J. Carlsson, H. Wider, EP1622168 Bl, Integral Nuclear Reactor (2004)
[98] S. Rigg, U.S. Pat. No. 3,442,760, Integral Nuclear Reactor (1969)
[99] J. D. Malloy, M. J. Edwards, US20120263270 A1, Compact integral pressurized water nuclear reactor (2011)
[100] R. Hawkins, U.S. Pat. No. 3,385,760, Integral nuclear reactor heat exchanger system (1966)
[101] B. McDonald, D. Schluderberg, U.S. Pat. No. 4,072,563 A, Industrial technique for an integral compact reactor (1976)
[102] P. N. Haubenreich, Molten Salt Reactor Experiment, ORNL-4449 (1970)
[103] L. Dewan, Molecular Dynamics Simulation and Topological Analysis of the Network Structure of Actinide-Bearing Materials, MIT Doctoral Dissertation, Department of Nuclear Science and Engineering (2013).
[104] O. Benes, R. J. M. Konings, Molten Salt Reactor Fuel and Coolant, Comprehensive Nuclear Materials. 3 (2012) 359-389.
[105] J. Buongiorno, J. W. Sterbentz, P. E. MacDonald, Study of solid moderators for the thermal-spectrum supercritical water-cooled reactor, Nucl Technol. 153 (2006) 282-303.
[106] M. S. El-Genk, Deployment history and design considerations for space reactor power systems, Acta Astronaut. 64 (2009) 833-849.
[107] M. Simnad, The UZrHx alloy: Its properties and use in TRIGA fuel, Nucl. Eng. Des. 64 (1981) 403-422.
[108] K. Moore, Phase relationships in the α+δ region of the Zr—H system, J. Nucl. Mater. 32 (1969) 46-56.
[109] J. Huangs, B. Tsuchiya, K. Konashi, M. Yamawaki, Estimation of hydrogen redistribution in zirconium hydride under temperature gradient, J Nucl Sci Technol. 37 (2000) 887-892.
[110] N. Ponomarev-Stepnoi, V. Bubelev, E. Glushkov, V. Garin, N. Kukharkin, G. Kompaniets, V. Nosov, E. Chunyaev, Estimation of the hydrogen emission from a hydride moderator by measuring the reactivity and using mathematical statistics, Atomic Energy. 102 (2007) 87-93.
[111] R. C. Robertson, Conceptual Design Study of a Single-Fluid Molten Salt Breeder Reactor, ORNL-4541 (1971).
[112] D. Holcomb, G. Flanagan, B. Patton, J. Gehin, R. Howard, T. Harrison, Fast Spectrum Molten Salt Reactor Options (2011).
[113] D. Powers, M. Leonard, R. Gauntt, R. Lee, M. Salay, Accident Source Terms for Light-Water Nuclear Power Plants Using High-Burnup or MOX Fuel, SAND2011-0128.Albuquerque: Sandia National Laboratories (2011).
[114] Terrani, K. A., Balooch, M., Wongsawaeng, D., Jaiyen, S., & Olander, D. R. (2010). The kinetics of hydrogen desorption from and adsorption on zirconium hydride. Journal of Nuclear Materials, 397(1), 61-68.

1. An apparatus comprising:
a neutron moderator, and
a cladding material which has gas permeability less than 10̂-6 square meters per second.

2-212. (canceled)
